(19) United States
(12) Patent Application Publication
(10) Pub. No.: US 2008/0092149 A1
(43) Pub. Date: Apr. 17, 2008

(54) Modular architecture for a device interface component

(76) Inventors: Graham D. Rowbotham, Vancouver (CA); William D. Gordon, Vancouver (CA); Daragh P. Lavin, Churchtown (IE); Robert M. Han, Burnaby (CA)

Correspondence Address: LAW OFFICES OF CHARLES W. BETHARDS, LLP, P.O. BOX 1622, COLLEYVILLE, TX, 76034, US

(21) Appl. No.: 11/973,197

(22) Filed: Oct. 5, 2007

Related U.S. Application Data
(60) Provisional application No. 60/849,790, filed on Oct. 5, 2006.
(60) Provisional application No. 60/875,893, filed on Dec. 19, 2006.
(60) Provisional application No. 60/922,078, filed on Apr. 6, 2007.

(51) Int. Cl. G06F 3/00

(52) U.S. Cl. 719/321

(57) ABSTRACT

An interface component, which is operable to allow one or more application programs to interact with device functions and corresponding method, that is stored in computer readable medium includes three distinct layers. The component includes a device (telephony) client operable to provide a plurality of interfaces to an application program, a device (phone) abstraction layer operable to interact with the device client and to provide access to device functions, the device functions being device independent and a device (phone) driver module operable to interact with the device abstraction layer and with hardware that is device dependent. One or more of the device client, the device abstraction layer, and the device driver module further comprises a plurality of components with each such component operable to support a corresponding grouping of the device functions.

### CROSS REFERENCE TO RELATED APPLICATIONS

This application claims the benefit under 35 U.S.C. Section 119(e) of the following U.S. provisional patent applications: Ser. No. 60/849,790 filed on Oct. 5, 2006 by Kath et al., entitled “Telephony Architecture for Mobile Devices”; Ser. No. 60/875,893 filed on Dec. 19, 2006 by G. Rowbotham, entitled “Modularized Telephony Architecture Supporting Plug-in-Play Hardware Components”; and Ser. No. 60/922,078 filed on Apr. 6, 2007 by G. Rowbotham, entitled “Modular Telephony Architecture for 3GPP Devices”, which applications are hereby incorporated herein by reference.

### FIELD OF THE INVENTION

This invention relates in general to electronic devices, and more specifically to a modularized architecture supporting plug-in-play hardware and software components, and techniques and apparatus for defining and specifying application programming interfaces (APIs), and software tool kits in support thereof.

### BACKGROUND OF THE INVENTION

Electronic devices, e.g., communications and entertainment devices are commonplace in today's world. For example, communications devices can be sophisticated, multi-functional devices which provide features such as: voice communications; multi-party conference calling; email services; short message service (SMS) and text messaging; internet access; still and video camera capabilities; real time video streaming; MP3 music download and playback; highly customizable user interfaces, backgrounds and wall papers; word processing, database and spreadsheet capabilities; multi-lingual support, to name a few such features, all of which are contained within a small device which fits within the palm of a user's hand. Users are demanding more and more such features.

Implementing such features in a wireless communications device requires the integration of multiple separate sophisticated hardware components, typically each having their own unique embedded applications software and associated applications programming interfaces (APIs) in support of its specific functionality. Typically these APIs are vendor specific, and implementing a multi-featured wireless device requires application developers to develop custom programs and interfaces specifically for each hardware vendor's components.

Fortunately, hardware components must also adhere to industry standards and specifications to facilitate device operations, such as, for example, the GSM AT interface defined in GSM specifications 3GPP TS 27.005 and 3GPP TS 27.007. Standardization does not, however, necessarily guarantee that software developed for one particular combination of hardware components will function automatically without any customization. This is particularly evident with respect to the radio modem interface.

Although the different radio modem manufacturers will ensure their modems meet the GSM AT command set specifications, software application developers spend significant effort customizing their software applications specifically for each manufacturers modem. Typically, this customization requires highly skilled embedded software programmers specializing in Radio Interface Layer (RIL) programming to customize a software application for a specific modem make and model. Porting a software application to a new radio modem is very time consuming and costly, and often reluctantly entertained by device manufacturers. Other hardware components within devices can have similar problems, with each component interface requiring custom embedded software development to integrate into the device. Furthermore, wireless device manufacturers may desire the ability to rapidly develop and deploy wireless devices with minimal time, cost and changes to embedded radio and applications software.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, a high level diagram of a modular architecture for an interface component in accordance with one or more embodiments;

FIG. 2A, 2B shows a more detailed diagram of the FIG. 1 modular component in accordance with one or more embodiments;

FIG. 3 illustrates methods and interfaces used by client applications to subscribe to telephony events in accordance with one or more embodiments;

FIG. 4A illustrates a dial request from a client application to PAL, which is portion of dial request sequence in accordance with one or more embodiments;

FIG. 4B illustrates a dial request from the PAL to PDM, which is portion of dial request sequence in accordance with one or more embodiments;

FIG. 4C illustrates a dial request from PDM to command handler (CH), which is portion of dial request sequence in accordance with one or more embodiments;

FIG. 4D illustrates a dial result from the PAL to the Client application, which is a portion of dial request sequence in accordance with one or more embodiments;

FIG. 4E illustrates a call event busy sequence from the CH to the PDM in accordance with one or more embodiments;

FIG. 4F illustrates the call event busy sequence from the PDM to the PAL in accordance with one or more embodiments;

FIG. 4G illustrates the call event busy sequence from the PAL to the client application in accordance with one or more embodiments;

FIG. 5A depicts a first portion of telephony service startup in accordance with one or more embodiments;

FIG. 5B depicts a second portion of telephony service startup in accordance with one or more embodiments;

FIG. 5C depicts a third portion of telephony service startup in accordance with one or more embodiments;

FIG. 5D depicts a fourth portion of telephony service startup in accordance with one or more embodiments;

FIG. 5E depicts a fifth portion of telephony service startup in accordance with one or more embodiments;

FIG. 5F depicts a sixth portion of telephony service startup in accordance with one or more embodiments;

FIG. 5G depicts a seventh portion of telephony service startup in accordance with one or more embodiments;

FIG. 6 illustrates command handler components in accordance with one or more embodiments;

FIG. 7A illustrates data networking interactions in accordance with one or more embodiments;

FIG. 7B illustrates the interface from a client application to the telephony API for a Phonebook and connection setup in accordance with one or more embodiments;

FIG. 7C illustrates the a Data call setup and teardown in accordance with one or more embodiments;

FIG. 7D illustrate a Data call teardown in accordance with one or more embodiments;

FIG. 8 illustrates components of a multiplexer and command handler interface in accordance with one or more embodiments;

FIG. 9 shows a TSP class diagram in accordance with one or more embodiments;

FIG. 10 illustrates Client API to Telephony Client sequence diagram in accordance with one or more embodiments;

FIGS. 11A, 11B, 11C and FIG. 12 illustrate interfaces exposed by a Telephony Client 102 in accordance with one or more embodiments;

FIG. 13 illustrates interfaces exposed by Telephony.Phonenumber in accordance with one or more embodiments;

FIG. 14 illustrates an event services class diagram in accordance with one or more embodiments;

FIG. 15 shows a sequence diagram that illustrates event service subscription and notification processes in accordance with one or more embodiments;

FIG. 16 shows an audio API diagram in accordance with one or more embodiments;

FIGS. 17A, 17B, and 17C illustrates a call API in accordance with one or more embodiments;

FIG. 18 shows data services common elements in accordance with one or more embodiments;

FIG. 19 shows interfaces associated with a high speed circuit switched data (HSCSD) API in accordance with one or more embodiments;

FIGS. 20A and 20B shows interfaces associated with a packet Data API in accordance with one or more embodiments;

FIG. 21 shows interfaces associated with a Device API in accordance with one or more embodiments;

FIG. 22 shows interfaces associated with an event notification API in accordance with one or more embodiments;

FIG. 23 illustrates interfaces associated with a lid API in accordance with one or more embodiments;

FIG. 24 illustrates interfaces associated with a log API in accordance with one or more embodiments;

FIG. 25 illustrates interfaces associated with a network API in accordance with one or more embodiments;

FIG. 26 illustrates interfaces associated with a notification API in accordance with one or more embodiments;

FIG. 27 illustrates interfaces associated with a phonebook API in accordance with one or more embodiments;

FIG. 28 illustrates interfaces associated with a Device/radio API in accordance with one or more embodiments;

FIG. 29 illustrates interfaces associated with a SIM API in accordance with one or more embodiments;

FIGS. 30A and 30B illustrates interfaces associated with a SMS/CBS API in accordance with one or more embodiments;

FIG. 31 illustrates interfaces associated with Service Interfaces in accordance with one or more embodiments;

FIG. 32 illustrates interfaces associated with an advice of charge API in accordance with one or more embodiments;

FIG. 33 illustrates interfaces associated with a call deflection API in accordance with one or more embodiments;

FIG. 34 illustrates interfaces associated with a call forwarding API in accordance with one or more embodiments;

FIG. 35 illustrates interfaces associated with a call waiting API in accordance with one or more embodiments;

FIG. 36 illustrates interfaces associated with a closed user group API in accordance with one or more embodiments;

FIG. 37 illustrates interfaces associated with a connected line ID API in accordance with one or more embodiments;

FIG. 38 illustrates interfaces associated with a facilities API in accordance with one or more embodiments;

FIG. 39 illustrates interfaces associated with an incoming caller ID API in accordance with one or more embodiments;

FIG. 40 illustrates interfaces associated with an outgoing caller ID API in accordance with one or more embodiments;

FIG. 41 illustrates interfaces associated with a USSD API in accordance with one or more embodiments;

FIG. 42 illustrates interfaces associated with a eMLPP API in accordance with one or more embodiments;

FIG. 43 illustrates interfaces associated with a Vibrator API in accordance with one or more embodiments;

FIG. 44 illustrates interfaces associated with a phone number utility API in accordance with one or more embodiments;

FIG. 45 illustrates SMS utility API COM objects in accordance with one or more embodiments;

FIGS. 46A and 46B illustrates interfaces associated with an SMS/CBS Utility API in accordance with one or more embodiments;

FIG. 47 illustrates USSD utility COM objects in accordance with one or more embodiments;

FIG. 48 illustrates interfaces associated with a USSD Utility API in accordance with one or more embodiments;

FIG. 49 illustrates a Telephony service class diagram in accordance with one or more embodiments;

FIG. 50 shows a PAL class diagram in accordance with one or more embodiments;

FIG. 51 illustrates a call manager and call state model class diagram in accordance with one or more embodiments;

FIGS. 52A and 52B illustrates a PDM class diagram in accordance with one or more embodiments;

FIGS. 53A and 53B illustrates PDM call management requests and results in accordance with one or more embodiments;

FIG. 54 illustrates additional PDM call requests and results in accordance with one or more embodiments;

FIG. 55 illustrates PDM call events in accordance with one or more embodiments;

FIGS. 56A and 56B illustrates PDM HSCSD requests and results in accordance with one or more embodiments;

FIGS. 57A, and 57B illustrates PDM Device requests and results in accordance with one or more embodiments;

FIGS. 58A and 58B illustrates PDM Device requests and results in accordance with one or more embodiments;

FIG. 59 illustrates PDM network registration events in accordance with one or more embodiments;

FIG. 60 illustrates PDM Radio requests and results in accordance with one or more embodiments;

FIG. 61 illustrates PDM Phonebook requests and results in accordance with one or more embodiments;

FIGS. 62A and 62B illustrates PDM SMS requests and results in accordance with one or more embodiments;

FIG. 63 illustrates PDM SMS events in accordance with one or more embodiments;

FIG. 64 illustrates PDM advice of charge requests and results in accordance with one or more embodiments;

FIG. 65 illustrates PDM advice of charge events in accordance with one or more embodiments;

FIG. 66 illustrates PDM Call forwarding requests and results in accordance with one or more embodiments;

FIG. 67 illustrates PDM Call waiting requests and results in accordance with one or more embodiments;

FIG. 68 illustrates PDM incoming caller ID requests and results in accordance with one or more embodiments;

FIG. 69 illustrates PDM outgoing caller ID requests and results in accordance with one or more embodiments;

FIG. 70 illustrates PDM USSD requests and results in accordance with one or more embodiments;

FIG. 71 illustrates PDM USSD events in accordance with one or more embodiments;

FIG. 72 illustrates a Dial sequence in accordance with one or more embodiments;

FIG. 73 illustrates an incoming call sequence in accordance with one or more embodiments; and

FIG. 74 illustrates a PAL initiation sequence in accordance with one or more embodiments.

### DETAILED DESCRIPTION

In overview, the present disclosure concerns a modular architecture for a device interface component, and more specifically to techniques and apparatus for providing device services to a client application via a set of common application programming interfaces in a manner which is independent of an underlying device hardware, e.g., radio modem hardware, environment. More particularly, various inventive concepts and principles embodied in methods and apparatus, e.g. software products that may include routines, programs, components, data structures, etc. that perform particular tasks or implement particular abstract data types, will be discussed and disclosed.

Moreover, those skilled in the art will appreciate that the invention may be practiced with various computer configurations, including cellular telephones, hand-held devices, personal digital assistants (PDAs), microprocessor based devices including embedded devices, personal computers, minicomputers and the like. The invention may be practiced on in conjunction with a variety of operating systems, such as Microsoft Windows CE, Linux, Symbian OS, as well as proprietary/closed operating systems and desktop operating systems, to name a few. The invention may be practiced in accordance a variety of telephony encoding standards, such as GSM, GPRS, WCDMA, etc., and such methods can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs running on computers, e.g., workstations, personal computers, etc. or within embedded software or firmware running on or executed by processors, such as microprocessors within integrated circuits (ICs) including possibly application specific ICs. It is expected that one of ordinary skill, notwithstanding possibly significant effort and many design choices motivated by, for example, available time, current technology, and economic considerations, when guided by the concepts and principles disclosed herein will be readily capable of generating such software programs and instructions without undue experimentation. Therefore, in the interest of brevity and minimization of any risk of obscuring the principles and concepts according to the present invention, further discussion of such software and ICs, if any, will be limited to the essentials with respect to the principles and concepts of the various embodiments.

To create a device, e.g., a wireless communication device that is adaptable to multiple different cellular systems and radios, a modularized architecture that supports plug-in-play components via a single application programming interface (API) to the radio modem hardware is appropriate. Such a modularized architecture can enable applications to run unchanged on multiple hardware platforms (i.e. radio modems) and operating systems (i.e. Windows CE, Linux, etc.) and can provide a common framework, e.g., telephony framework, to support GSM, GPRS/EDGE (2.5G) and UMTS (3G) or other cellular communications.

The architecture should be modular, and portable to different devices, e.g., radio systems with potentially dramatically different radio interfaces such as the AT command set (e.g. Siemens MC55/75, Multitech Wavecom, TI OMAP, etc.), the C API (e.g. Agere), etc. The architecture can have a small footprint (compiled code size) by using a lightweight IPC mechanism and without the need for a more complex technology, such as DCOM (Distributed Component Object Model). For telephony applications, the architecture can be modular, configurable and provide client applications access to various radio modem functionality and services, e.g.: network selection (e.g. registration, band selection, preferred operator list, etc); call management (e.g. voice, packet data, CSD, etc.); short message service (SMS); SIM phonebook access; SIM application toolkit (SAT); call history logging; supplementary services (e.g. Call Forwarding, Call Waiting, Conference Call, Call Hold, Multiparty, LineID Services, Facility Locks, Advice of Charge, USSD, Fixed Number Dialing, Explicit Call Transfer, Closed User Group, eMLPP (enhanced multiple level precedence and pre-emption), etc); operation modes; radio equipment power management, etc. The architecture can be easy to extend and add new functionality without modifying existing software components, e.g., radio interface software components, and facilitate the exclusion of unneeded components to optimize footprint and minimize CPU overhead. It can provide customizable support of a variety of “plug-in” hardware components. The modularized architecture, e.g. telephony architecture can provide efficient support for multiple, concurrent telephony clients, and remain domain independent of a particular cellular or other radio access infrastructure.

The present disclosure and description shows a modularized architecture including a modularized telephony architecture which supports plug-in-play hardware components, via software application programming interfaces, software tool kits and apparatus. More specifically, a multi-layered telephony architecture is introduced, where some embodiments comprises horizontal layers, e.g.: a Device/Telephony Client application programming interface layer (Device/Telephony Client API); a Device/Phone Abstraction Layer (DAL/PAL); a Device/Phone Driver Module (DDM/PDM); etc. One or more of the horizontal layers can be further compartmentalized vertically in order to establish a particular service requirement by functional grouping. The advantages and improvements provided will become apparent from the following detailed description of exemplary embodiments.

### Modular Device/Telephone Architecture

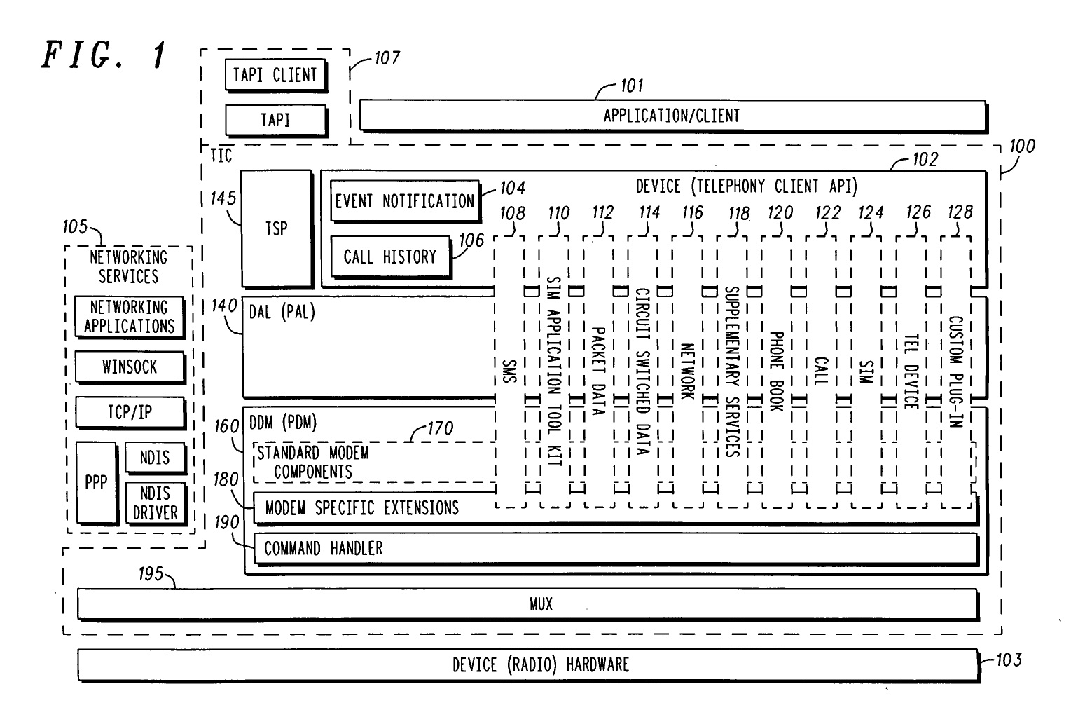

Referring to FIG. 1, a simplified and representative high level diagram of a modular architecture for an interface component in accordance with one or more embodiments will be briefly discussed and described. In FIG. 1, a Device (Telephony) Interface Component (TIC) 100 is a software component or program which provides services, e.g., telephony services to an Application or Client (the Application or alternatively Client) 101 running on a microprocessor based device (e.g. a cellular phone, Personal Digital Assistant, Personal Entertainment Device, etc.) having an operating system (OS), such as Microsoft Windows CE 5.0, etc. In various embodiments, the modular architecture, e.g., modular telephony architecture, is suitable to abstract the similarities between different devices, e.g., radio modem equipment to provide a common, easy to use application programming interface which will enable applications to run unchanged on multiple platforms employing different devices, e.g., radio devices using varying communications protocols, such as GSM, GPRS/EDGE, and UMTS, without extensive software modifications.

Thus, FIG. 1 in overview illustrates one or more embodiments of an interface component (TIC) 100 which is operable to allow one or more application programs or clients 101 (herein applications or clients) to interact with device functions, e.g., functions of a radio modem or other functions of other devices. The interface component in varying embodiments includes a device (telephony) client 102 (alternatively referred to as telephone API or device API) which is operable to provide a plurality of interfaces to one or more application programs, where each interface is typically in the form of an API(s) (Application Program Interface(s)). Further included in the interface component is a device abstraction layer (DAL) (alternatively referred to as a PAL) 140 operable to interact with the device client and to provide access to device functions, where the device functions from the perspective of the device client and application are or appear to be device independent as a result of the DAL. Additionally included is a device (phone) driver module (DDM) (alternatively PDM) operable to interact with the device abstraction layer and with hardware or device (radio) hardware, which is typically device dependent or specific. In varying embodiments, at least one of the device client, the device (phone) abstraction layer (DAL or PAL), and the device (phone) driver module further comprises a plurality of components with each such component operable to support a corresponding grouping of the device functions.

The device client 102 in one or more embodiments includes or is further configured with a first Application Programming Interface (API) to facilitate communication with an application program or client (alternatively referred to as client application) 101 and with a second API to facilitate communication with internal portions, e.g. PAL 140, etc., of the interface component. In varying embodiments, the interface component is configured to include an event notification module and service for communications with the application programs and with internal portions of the interface component. The interface component may also be configured with an event history service, etc.

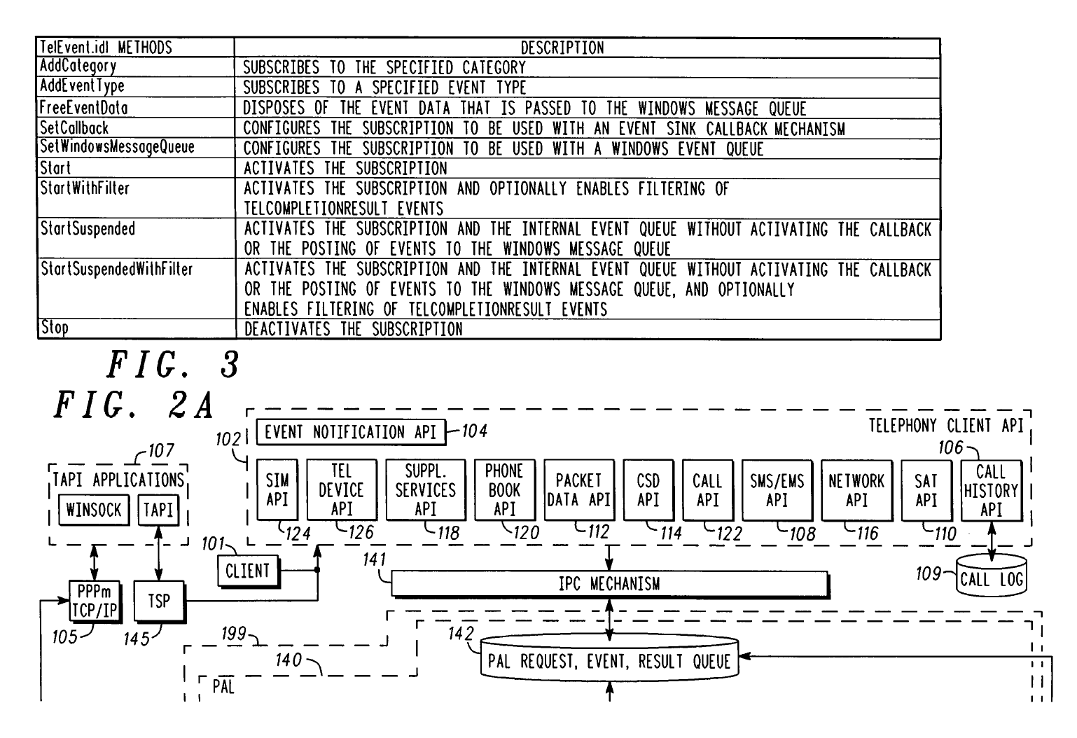

As will be discussed further below with reference to, e.g., FIG. 2, some embodiments of the interface component are configured such that the device client is further configured with a first client API associated with a first grouping of the device functions; the DAL is further configured with a first DAL component associated with the first grouping of the device functions; and the DDM is further configured with a first DDM component associated with the first grouping of the device functions, wherein the first client API, the first DAL component, and the first DDM component correspond one to one with each other and allow the one or more applications programs to interact with one or more device functions which are members of the first grouping of the device functions. The first client API, the first DAL component, and the first DDM component can be first plug-in entities that are enabled in the interface component to allow the applications programs to interact with the first grouping of the device functions.

The interface component in one or more embodiments is further operable to allow the one or more applications programs to interact with a second, third, etc. grouping of the device functions by enabling, respectively, without changing the first client API, the first DAL component, and the first DDM component, a second, third, etc. client API, a second, third, etc. DAL component, and a second, third, etc. DDM component, which are second, third, etc. plug-in entities. This is reflected, e.g., in the vertical structures 108-128 in FIG. 1. The DAL and the DDM can be further configured with a queue that is operable to queue events associated with communications between the device client, the DAL, the DDM, etc. Additionally in some instances, the interface component is further configured with a service provider interface to facilitate interactions between legacy applications and the interface component. Much of the following discussions will focus on the specifics of the interface component in the context of implementing an interface to a radio, e.g., cellular telephone, and thus will be explained, by way of example, in the context of a telephony interface component or software program. It will be appreciated that the architecture is readily extendable to other functionality of underlying devices.

Architecturally, the TIC 100 is partitioned horizontally into three main layers: the Telephony Client 102; the Phone Abstraction Layer (PAL) 140; the Phone Driver Module (PDM) 160; and in various embodiments a fourth layer, i.e., the Multiplexer (MUX) 195. The Telephony Client 102 provides an application programming interface (i.e. the Telephony.ClientAPI) through which upper level software applications (i.e. the Client 101) access the telephony functionality of the underlying radio modem hardware (Radio Hardware) 103 via the MUX 195. The TIC 100 may be used in situations including a variety of telephony or air interface standards, such as GSM, GPRS and WCDMA, Bluetooth, WIFI, etc. and as such is designed to support new standards as they arise with ease and minimal engineering effort.

The Telephony Client 102 provides telephony functionality to the Client 101 in a manner which is in many instances independent of the underlying radio modem hardware 103. This hardware independence enables the Client 101 to run unchanged on a variety of hardware platforms with dramatically different radio interfaces, such as GSM 27.007 and 27.005 AT command set interface, such as provided by the Siemens model MC55/75 or Multitech Wavecom, versus the substantially different C API as found in Agere modems, for instance. Additionally, the modular structure of the TIC 100 is designed so as to interface to and run on a variety of operating systems, such as Microsoft Windows CE 5.0, Linux, or Symbian OS, as well as other, possibly proprietary, operating systems. The following discussions will present, by way of example, one such description of a representative embodiment with respect to the Microsoft Windows CE 5.0 operating system.

One advantage of the modular telephony architecture of the TIC 100 lies in the abstraction of common telephony functionality as implemented by the numerous suppliers of radio modem hardware in compliance with specific telecommunications protocol specifications, such as GSM 27.007 and 27.005, in order to provide a common set of device independent telephony components or software code sets (i.e. “plug ins”) for the purpose of application portability and platform independence. As a result, the TIC 100 is highly modular, configurable and customizable which permits the exclusion of unneeded component functionality in order to optimize the software footprint, minimize CPU overhead, while facilitating the addition of new functionality without modification of existing software components. The abstraction of telephony services to a common set of fully componentized domain independent plug-in APIs is discussed further below with reference to FIGS. 1 and 2, where FIG. 1 presents the telephony architectural components at the highest level, and FIG. 2 presents further detail pertaining to the components of FIG. 1.

As the discussion so far as well as further discussions below will indicate, the present disclosure concerns a telephony interface component operable to allow one or more application programs to interact with phone functions and the telephony interface component may be stored on computer readable medium. In various embodiments, the telephony component comprises a telephony client API operable to provide a plurality of interfaces to allow the one or more application programs to interact with the phone functions; a phone abstraction layer (PAL) operable to interact with the telephony client and to provide access to phone functions, the phone functions being phone hardware independent from the application program and telephony client perspective, and a phone driver module (PDM) operable to interact with the phone abstraction layer and with hardware that is device dependent. In some embodiments, the telephony client API, the PAL, and the PDM further comprise a plurality of respective telephony client components, PAL components, and PDM components (see e.g., FIG. 2) that are plug-in components organized in a corresponding plurality of one to one relationships to support a corresponding plurality of groupings of the phone functions, e.g., Tel Device, Phone book, call, etc.

The telephony client API in various embodiments is further operable to handle any timing issues for commands and responses associated with interactions between the one or more application programs and the phone functions or hide/conceal details of communications with the PAL from the one or more application programs.

The interface component can include an Inter-process Communications (IPC) mechanism that is configured to support interaction between the telephony client API and the PAL and an event notification service to propagate relevant events to the, respective, one or more application programs.

In varying embodiments, the PAL further comprises a PAL plug-in framework and event service mechanism supporting sufficient plug-in PAL components to provide an implementation of all functionality that will be invoked by the telephony client API. The PAL can further include PAL event services which are configured to, e.g., queue requests, events or results for interaction between the PAL and the telephony client API.

In other embodiments, the PDM is configured to translate commands from the PAL to commands for the hardware that is device dependent and translate responses from the hardware to responses to the PAL. The PDM can further include PDM event services configured to, e.g., queue requests, events, or results for interaction between the PDM and PAL. The PDM can further include a PDM plug-in framework and event service mechanism supporting sufficient plug-in PDM components to provide an implementation of all functionality that will be requested by the PAL.

The PDM can also include a command handler that facilitates interaction between the PDM and the phone functions and the command handler may comprises one or more queues for queuing commands and results for interaction with the phone functions. In some embodiments, the interface component further comprises a multiplexer for interfacing to the command handler and multiplexing commands to and results from the phone functions for the command handler.

TIC Subsystems Overview

Telephony Client

Referring to FIGS. 1 and 2, the Telephony Client 102 provides the interface through which client applications 101 interact with the telephony system (TIC 100 and Device or radio hardware 103). The Telephony Client 102 or telephone client layer is defined in terms of a set of interfaces grouped or logically grouped according to functional telephone components and services. This application programming interface (interface between applications and TIC) is called the Telephony.ClientAPI. Some of the major interfaces that can be exposed within this API are shown as the vertical blocks: SMS 108, SIM Application Toolkit 110, Packet Data 112, Circuit Switched Data 114, Network 116, Supplementary Services 118, Phonebook 120, Call 122, SIM 124, and TelDevice 126 which extend from the client 102 down through the PAL 140 and into the PDM 160 layers. For example, when implemented for the Windows CE OS, the Telephony Client 102 is defined in terms of a set of Microsoft's component object model (i.e. COM) interfaces. The use of COM allows the Client application 101 to be written in any language supported by Microsoft's COM and NET technologies. Similar such operating specific interfaces are provided when employed in conjunction with alternate operating systems such as Linux or Symbian OS.

More specifically, the Telephony Client 102 provides the interface through which a client application 101 interacts with radio modem hardware (i.e. 103), and comprises a set of libraries of classes that provide COM wrappers for invoking telephony functionality via a service IOCTL (Input Output ConTroL) interface (see IPC below) to the PAL 140. The Telephony Client 102 simplifies access to the PAL telephony services provided by hiding the IOCTL interface details from the client application 101 and by making telephony command invocation synchronous for the client application, i.e., any timing issues for commands and any responses issues are handled for the client applications 101 by the Telephone client 102. The Telephony Client 102 is a thin layer that wraps requests to Telephony Services 199 to enable client applications to be notified of telephony events.

In particular, the Telephony Client 102 layer is deliberately made as thin as possible. It essentially comprises a set of plug-in proxy objects or components that allow the Client 101 to send requests to the low level telephony services of the Radio Hardware 103 via the PAL 140, PDM 160 and MUX 195 respectively, and to receive responses as well as unsolicited telephony events. More specifically, the Telephony Client components, (i.e. 108, 110, 112, 114, 116, 118, 120, 122, 124 and 126) are typically compiled into a dynamic link library (DLL) which runs within the Client application 101 process space on the operating system. The Telephony Client 102 layer hides all details of the inter-process communications (IPC) Mechanisms 141 that are used to interact with the lower level telephony services (i.e. PAL 140, PDM 160 and MUX 195) that is running as a device driver in a separate process. Further details pertaining to the Telephony Client are presented below at TIC Subsystem Details.

Device/Phone Abstraction Layer (PAL)

The PAL 140 provides an abstract, device independent implementation of the telephony functionality. Support for specific radio hardware is achieved through use of the appropriately corresponding PDM 160 components.

As shown in FIGS. 1 and 2, the PAL 140 has a plug-in architecture for componentization and extensibility (permits independent development of features). Differing ranges of functionality are supported by configuring in or enabling and including the appropriate set of plug-ins. Any one set of plug-ins can be added without impacting already existing or included plug-ins. Additional DAL Custom Plug-ins 128 can be added to support new functionality without impacting existing components (i.e. 108, 110, 112, 14, 116, 118, 120, 122, 124 and 126). In general, PAL plug-ins are implemented as COM components that are instantiated when the PAL 140 starts up. Through its plug-in architecture, the PAL provides an implementation of all telephony functionality that can be invoked via the Telephony Client 102 and/or via the TSP 145 through the Telephone Client.

Referring to FIG. 2, when implemented for Windows CE OS, the PAL 140 runs as WinCE device driver and supports multi-client application access to telephony functionality through an IOCTL based interface which is shown as IPC (Inter Process Communication) Mechanism 141. When a telephony command is received from the Telephony Client 102, it is queued via the PAL Request, Event, Result Queue (PAL Event Services) 142 and dispatched via the PAL Plug-in Framework and Event Service 143 to the appropriate PAL plug-in (i.e. 150, 151, 152, 153, 154, 155, 156, 157, 158, or 159) for processing. The appropriate PAL plug-in (i.e. 150 through 159 as previously listed) is responsible for validating the command and either responding to it directly (i.e., by returning cached data), or further forwarding the request to the PDM 160 via the PDM's corresponding plug-in.

In general, it should be noted that in various embodiments there is a mapping between the specific Telephony Client 102 to a corresponding PAL plug-in and similarly between a specific PAL plug-in to a PDM plug-in. Such a one-to-one correspondence (i.e. Telephony Client to PAL to PDM) facilitates the modularization of telephony functionality which gives rise to the plug-in nature of telephony services provided by the modular architecture of the disclosed invention. Further details pertaining to the plug-in correspondences are provided in subsequent sections.

The PAL 140 also provides a multi-client application event notification mechanism for notifying client applications of telephony related events, enabling the development of multiple cooperating client applications. PAL plug-ins subscribe, via the PDM Event Services 161 queue to events generated by the PDM, and use the Event Notification Service 104 to propagate these to registered client applications 101. For more details on the PAL, refer to the Phone Abstraction Layer section below.

Referring to FIG. 2, Telephony Services 199 as provided by the TIC 100, comprises the PAL 140 and PDM 160 layers. Infrastructure is domain independent and telephony specific functionality is provided via plug-ins. Software models, methods and objects which facilitate the provision of Telephony Services, include: an Event Service for managing various asynchronous messaging queues; a plug-in manager framework for loading, initializing and unloading plug-ins; a TelService device driver which provides IOCTL to allow API clients to subscribe for events and send requests; a TelService Proxy (CTelIntService) which encapsulates the IOCTL inter-process control mechanism which client API objects use to interact with the telephony service; and a utility toolkit of generic base Event Classes for requests, results and unsolicited events.

Telephony Services are provided by the interaction of the device independent PAL 140 layer and the PDM 160 (itself consisting of both Standard Modem Component Plug-ins 170 and Modem Specific Extension Plug-ins 180) which are customized for use with a particular modem/radio hardware platform. When implemented on a Windows CE operating system the telephony service runs as a WinCE device driver and implements standard Windows stream driver functions corresponding to the Win32 file operations CreateFile, DeviceIOControl etc. In general, this functionality can be any standard inter-process control (IPC) mechanism 141, as is suggested by FIG. 2. The PAL 140 at least implements functionality and logic that is common to many radio devices. It processes the requests from the Telephony Client 102, manages state information and publishes the telephony events to which clients can subscribe.

In particular, the Telephony Client 102 in one or more embodiments is a thin client which includes an API (i.e. Telphony.ClientAPI) which wraps requests to Telephony Services 199. All Telephony Client plug-in components (i.e. 108, 110, 112, 114, 116, 118, 120, 122, 124, 126 and 128) use the CTelIntService object which provides proxy services to Telephony Services 199, and hides the details of the inter-process control mechanism via DeviceIOControl. In FIG. 2, DeviceIOControl is generally shown as IPC Mechanism 141. Telephony Service 199 handles all requests asynchronously, but the API thread blocks until a result is signaled, making the request appear synchronous to the client application. TelEvent API (P/O 104) is used by client applications to subscribe to events of interest and receive notification either via callback or message queue (e.g. Windows Message Queue). Clients may also subscribe to event categories (e.g. EVENTCATEGORY CALL) and/or specific event types (e.g. CALLEVENT_NEWUNANSWEREDCALL, CALLEVENT_BUSY, etc.).

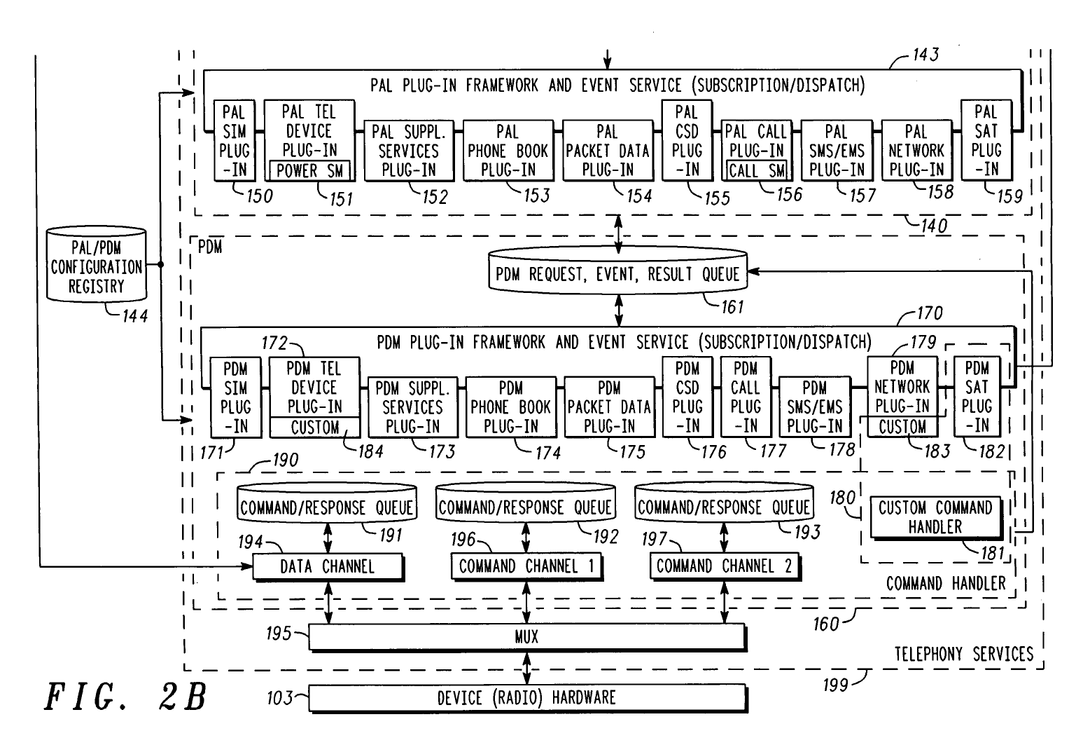

More specifically, the TelEvent.idl defines interfaces that are used by clients to subscribe for telephony events of interest. Clients may subscribe to event categories, e.g., EVENTCATEGORY_CALL, EVENTCATEGORY_NETWORK; in this case they receive events of all the specific types within the subscribed to category. Additionally, clients may subscribe to specific event types within a category e.g., CALLEVENT_BUSY, CALLEVENT_NEWUNANSWEREDCALL, NETWORKEVENT_REGISTRATIONSTATUSCHANGE. Clients may also choose an event notification mechanism via the Callback interface method ITelEventSink::OnEvent, or via the Windows Message Queue (WM_SOLEUS_TEL_EVENT). For events associated with asynchronous completion results, clients can optionally set up a filter in order to only receive completion result events for requests that they initiated. Clients may also create multiple subscriptions to events and event categories. FIG. 3 defines the methods and interfaces used to subscribe for telephony events of interest via the TelEvent API.

In addition to the horizontal layering, the TIC 100 is partitioned into vertical slices of functionality through an extensible, componentized plug-in architecture. Underlying this architecture is a domain independent asynchronous message engine and plug-in infrastructure. All plug-ins fit in to this framework. Each plug-in implements a specific set of related functionality corresponding to one or more interfaces in the Telephony Client 102. New plug-in components can be authored and added without the need to modify the infrastructure or other existing plug-ins. For example, there are different plug-ins for Call Management, SMS (Short Message Service), Packet Data, Network related functionality (operator selection, network registration etc), SIM Application Toolkit and so on. Typically a plug-in will have corresponding components at each level: API, PAL and PDM. However, in some cases the plug-in only needs an API component (such as the TelEvent and the CallHistory plug-ins). In the case of the Command Handler 190, there is only a PDM level plug-in component (shown as 181 of FIG. 2).

While some plug-ins can operate completely independently of the others, some may need to interact/collaborate. However, the coupling between plug-ins is deliberately loose, as is the coupling between corresponding plug-in components at the API, PAL and PDM levels. All plug-ins interact via a domain independent asynchronous messaging engine, known as the Telephony Event Service. There are separate instances of the Telephony Event Service at the PAL and PDM levels, as shown in FIG. 2 as the PAL Event Services 142 and the PDM Event Services 161 respectively. Plug-in components do not need to be aware of or communicate directly with other plug-ins. They only need to know what kinds of requests and unsolicited events they are capable of responding to.

At start up, each plug-in registers with the Event Service and subscribes to the requests and events of interest. When a request or event of that type is received by the Event Service (for example, as a result of an application invoking a method of the Telephony Client, or a URC being received from the modem), the Event Service will dispatch that request/event to the plug-in or plug-ins that have subscribed for it. The plug-in may respond to the request by sending back a result to the Event Service, which will then route it to the original requestor. Or the plug-in may translate the request into another one, which is forwarded to the Event Service for dispatching to the plug-in component that has subscribed for it. There is one generic PAL component and one generic PDM component. These are essentially just container objects that at start-up load the appropriate set of PAL/PDM plug-in components based on configuration data. Once the plug-in components have been loaded and the Event Service has been started, all subsequent interaction is event driven.

All processing within the Telephony Service 199 is handled in an asynchronous manner. To simplify application development, however, the Telephony Client 102 makes the request invocation appear synchronous to the client application (i.e. Client 101). To achieve this, the thread within the Telephony Client 102 that issues the request blocks until it receives notification from the Telephony Service (i.e. 199) that the request has been processed and the result is ready. At this point the Client 101 thread unblocks, fetches the result from the telephony service and returns this as one or more output parameters to the original client method call.

As shown in more detail with reference to FIG. 2, the Telephony Service 199 subsequently publishes asynchronous events via the Event Notification API 104, e.g., as the state of a call changes during call processing. Different types of events will be generated when, for example, the call is connected because the called party answered it, or the call is terminated for various reasons, such as the number was busy or the called party hung up. To enable client applications to subscribe to telephony events of interest and specify a callback sink or a message queue through which they will receive notification when those events occur, the TIC 100, via the Event Notification API 104 provides a generic interface call ITelEventSubscription which will be discussed in more detail in subsequent sections.

Similar notification mechanisms are also employed for requests which take longer to process, such as those for activating/deactivating supplementary services like call forwarding for example. For requests which take longer to process, an initial response is returned synchronously and a completion result is sent as an asynchronous event when processing of the request has been completed, again all via the Event Notification API 104.

Device/Phone Driver Module (PDM)

The Phone Driver Module (PDM) 160 is responsible for interfacing with the Device/Radio Hardware 103, for sending telephony commands, and for receiving responses and unsolicited telephony events. The PDM 160 is responsible for translating commands and responses to/from the appropriate radio equipment specific format (e.g. GSM 27.005 and 27.007 command sets or the like). The PDM is a thin layer which translates logical PDM requests to the appropriate protocol specific commands and function calls. In order to minimize porting effort to different radio devices, the PDM layer is deliberately as simple and stateless as possible and whenever feasible its' functionality is implemented in a device independent manner.

More specifically as shown with reference to FIG. 2, the PDM 140 is responsible for interfacing with the Radio Hardware 103 via Command Handler 190 and the MUX 195. The PDM 140 can translate commands and responses to/from the radio equipment 103 in the vendor specified format. Like the PAL, the PDM also uses a plug-in architecture for componentization and extensibility. When a new plug-in is added to the PAL 140, a corresponding PDM plug-in is created to implement the radio equipment specific portion of the functionality. However, a one-to-one mapping between PAL and PDM components is not always needed since there can be, in general, many functional components that are very similar, if not identical between different radio hardware manufacturers. Thus, the PAL and PDM are only loosely coupled in terms of the messages (requests, results and unsolicited events) that are exchanged.

More specifically as indicated in FIGS. 1 and 2, the PDM 160 itself is further partitioned into components those being: Standard Modem Component Plug-ins 170 (i.e. for functionality which is largely standardized across modem manufacturers and which is typically a result of being compliant with specific communication protocols, such as the ETSI 3GPP standards TS GSM 27.007 and GSM 27.005 specifications); Modem Specific Extension Plug-ins 180 which are specific to a particular device/radio vendor; the Command Handler 190; and the Multiplexer (MUX) 195.

Typically, the majority of the PDM's functionality is implemented using Standard Modem Component Plug-ins 170, as this plug-in contains functionality for industry standards such as GSM 27.007/005. The Modem Specific Extension Plug-ins 180 are custom plug-ins which are authored for additional functionality which is not included in these specifications for which the modem vendor uses custom commands. Hence the work of porting the modularized telephony interface component to a new radio modem is confined to authoring a few device specific PDM components (i.e. 180), as the vast majority of the telephony software is reusable without modification. Further details on the PDM are presented in the Phone Driver Module section below.

Typical cellular radio hardware has a single serial port connected to a mobile terminal. The Multiplexer (MUX) 195, is used to implement multiple virtual serial channels over this single port via a multiplexer protocol such as GSM 27.010. The Command Handler 190 component is a PDM plug-in which communicates with the radio hardware (i.e. 103) via the MUX 195. The MUX allows multiple virtual channels to be used concurrently. For example, one port can be used as a data channel by an application browsing the Internet, while other channels are used to interject control commands and to receive URCs (Unsolicited Result Codes) from the modem, e.g., for notification of changes in signal strength, incoming calls or SMS messages etc. The multiplexer framework implements a WinCE stream device driver. The standard Win32 file operations CreateFile( ), WriteFile( ), ReadFile( ), DeviceIOControl are implemented in terms of the underlying multiplexing protocol, such as GSM 27.010. The user of the virtual serial ports is unaware that multiplexing is being performed.

To facilitate the authoring of custom PDM plug-ins a PDM Toolkit is provided. The PDM Toolkit contains abstract data structures, classes and super classes, as well as sample code, for families of similar devices from which custom PDM plug-in specializations are authored or modified for particular manufacturer equipment. For example, a set of generic GSM AT command PDM plug-in components provide base support for standard GSM 27.007/0.005 AT commands, from which specializations for specific devices, such as the TI Omap 850 modem or others can be created. For example, a specialized modem specific PDM plug-in component can override the standard GSM 27.007 PDM plug-in OnEvent sink method in order to intercept command requests that require special processing, while all standard commands to the GSM 27.007/005 PDM plug-in can be handled in the standard way. In general, the goal is to make the PDM as simple and stateless as possible, and try to implement as much functionality as is feasible in a device independent manner within the PAL, rather than in the PDM.

Unit Abstraction Layer (UAL)

The Unit Abstraction Layer (UAL) provides an abstraction for elements of the device/phone hardware besides the radio equipment itself. This can include, e.g., audio components (microphone, speaker, and headset), vibrator, display and keypad backlight, lid position, docked state, camera, Bluetooth and other device I/O, etc. The UAL may also include functionality for rendering melodies, etc. The UAL generates notification events associated with changes to the headset insertion state, docked state, lid position, and the like.

The UAL is implemented as a custom plug-in. Specific implementations of the UAL plug-in can be created to support particular manufacturer's equipment. The customizations will typically affect one or more of the Telephony Client 102, PAL 140 and PDM 160 layers. Referring to FIG. 1, the UAL is part of the component Custom Plug-ins 128. Details pertaining to customizations will be presented within the context of the specific TIC layer or can be ascertained with reference to discussions of the other plug-ins and device specific information.

Telephony Service Provider (TSP)

As shown in FIGS. 1 and 2, a Telephony Service Provider (TSP) 145 component is provided to support legacy client applications, such as applications using Microsoft's Telephony Application Programming Interface (TAPI). The TSP 145 is an instance of a custom telephony client which is defined to enable legacy applications, such as those written to use Microsoft's TAPI, to run without alteration and to directly utilize the telephony services of the TIC 100. The TSP 145 component performs the translation between TAPI calls from a TAPI service provider interface (which is an interface to TAPI and it's' TAPI Client (shown together as 107) and the Telephony.ClientAPI 102. It is a library of telephony services that supports communications device control through a set of exported service functions called by TAPI. The TSP 145 may be used to set up GPRS Packet Data, as well as Circuit Switched Data, calls via the WinCE functional components grouped together as 105. Additionally, the TSP 145 may also be used to set up or terminate TAPI voice calls using TelTSP line device driver.

More specifically, the TSP 145 is a DLL (Dynamically Linked Library) provided as part of the TIC's Telephony Services 199. Once TAPI is initialized and told to do so, TSP is loaded into the TAPI Server process space (shown as the TAPI Application 107), and is used by TAPI via the TAPI telephony service interface to invoke the TIC's telephony services.

The TSP is a relatively thin layer, with the bulk of the underlying implementation provided by the PAL 140. TSP supports TAPI's Line Device functions and implements/exposes two line drivers for access to Telephony Services (one line for data and one for voice calls). It exports a standard TSP interface consisting of a single C function (TSP_lineGetProcTable) for Windows CE platforms. TSP_lineGetProcTable provides a table of the TSP functions.

The TSP is largely a translation layer converting TAPI function calls to the corresponding Telephony Client API call and converting the result to the appropriate TAPI return parameters. It also converts events received via the Event Notification API 104 to the corresponding TAPI event and invokes the TAPI event callback procedure. The TSP performs an equivalent role for TAPI based applications as does the Telephony Client API 102 for custom TIC applications. The TSP 145 also utilizes the Telephony Client 102 in order to interact with the PAL.

TSP Implementation Classes

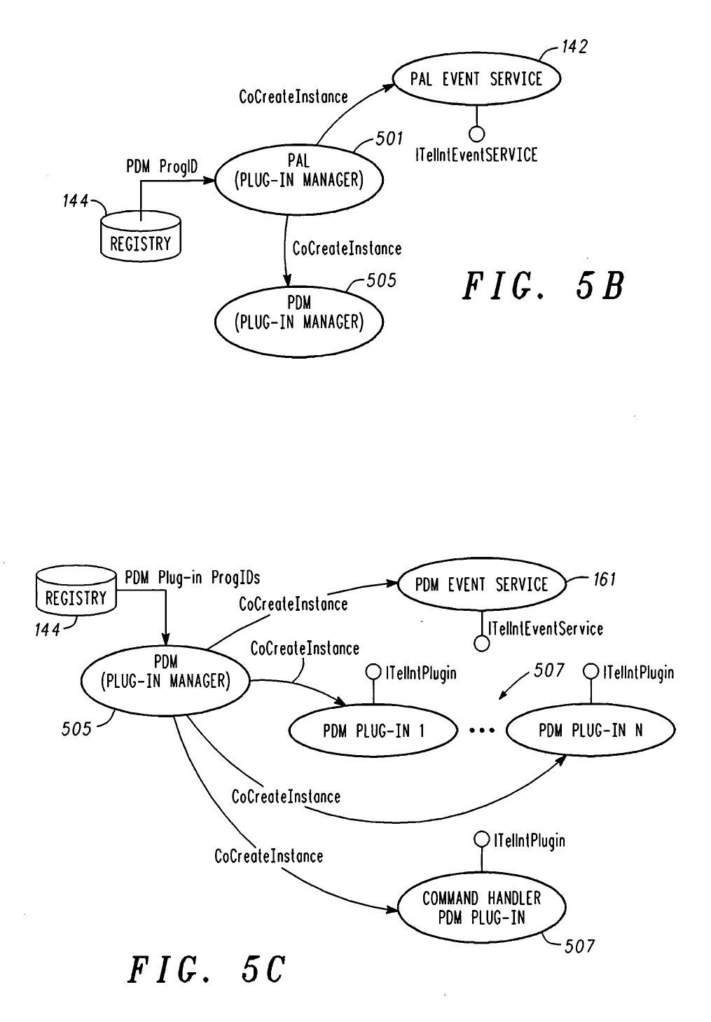

The TSP interface to TAPI is implemented by PhoneTsp 901, (which contains the DllMain function and the TSP_lineGetProcTable function entry point), along with the classes CTspDevice 903, CTspLine 905 and CTspCall 907. The TSP objects, events and requests are presented in the FIG. 9, TSP class diagram.

The CTspDevice object provides an abstraction of the phone device for TAPI 107. It is responsible for: reporting device capabilities and information to PhoneTsp to return to TAPI; initializing the connection to the PAL; and creating the CTspLine object in response to a TSP-lineOpen( ) function and calling methods on this object.

The CTspLine object provides an abstraction of the phone line. It is responsible for: storing and retrieving information about the line; monitoring PAL events and passing events to TAPI via TAPI's Event Proc; and creating CTspCall objects in response to the TSP_lineMakeCall( ) and keeping a list of current phone calls, to allow delegation of PAL events to these calls.

The CTspCall object represents a single phone call. It is responsible for: making, dropping and controlling the actual phone call; storing and retrieving information about the phone call; and handling PAL events for the phone call.

CTspCall uses the PAL 140 to dial and later drop the call, to set parameters in the call, and to get information on the call. PAL events that relate to an individual phone call are routed to the appropriate CTspCall object by its CTspLine. When a PAL event shows that the call's state has changed, the CTspCall uses CTspLine to notify TAPI 107 of the state change.

Call Log

Referring to FIG. 2, the Call Log 109 provides functionality for logging call history to persistent storage. This can include information about incoming and outgoing voice calls, missed calls, GPRS and CSD data calls, as well as SMS PDUs sent and received.

When call logging is enabled, the PAL will invoke the Call Log 109 via the telephony API 102 (call history API 106) to create the appropriate log entries. Access to the Call Log is thus provided through the Telephony Client 102 via the Call History API 106. This enables applications such as a Log Viewer to retrieve call log information for display, or call log configuration settings to be changed via the Phone Settings UI. Call Log configuration settings include, e.g., whether call logging is enabled or disabled, and the maximum number of log entries to keep before rolling over. For more details on the Call Log, see the description below at Log API.

Device Information Store

Referring to FIG. 2, the Device Information Store is shown as the PAL-PDM Device Configuration Registry 144. It is persistent storage and is used to store telephony platform configuration and modem specific settings. This includes the ProgIDs of PAL and PDM plug-in components to be loaded. Plug-ins also use the PAL-PDM Device Configuration Registry 144 for plug-in specific configuration settings.

TIC Inter-Subsystem Interfaces

All interaction between TIC components in one or more embodiments can be via IOCTL-based API interfaces. Referring to FIG. 2, the component API interfaces are presented in detail as follows.

Client API 101<-> PAL 140

To obtain telephony services, a client interacts via its own Client API (not specifically shown) with the PAL 140 through Telephony Client's API's and IOCTL-based interfaces. There is no direct interaction between the Client API and PAL's interfaces. Rather the Telephony Client 102 manages this interaction by invoking PAL telephony functionality by calling the DeviceIoControl function with custom IOCTL codes.

To simplify access to the PAL 140, the Telephony Client 102 provides an interface ITelService and implementation class CTelService which encapsulates all calls to DeviceIoControl. The Client 101 uses this interface to:
Subscribe to event categories/types of interest,
Send Telephony requests, and
Get data associated with results and unsolicited events.

The PAL 140 processes all requests via the PAL API of the PAL Event Service 143. The PAL Event Services 143 comprises these basic ITelService functions together with the set of messages (event types) associated with telephony requests, results and unsolicited events. There is an event type corresponding to each function within the Client API (GetActiveCalls, Dial, Answer, etc), as well as each distinct result type (e.g., GetActiveCalls result) and each unsolicited event (NewMTCall etc). For each event type there is a simple class that knows how to serialize and deserialize itself. Sending a command to the PAL involves constructing the appropriate request object and invoking the ITelService::SendRequest or SendRequestAndGetResult methods.

Since all telephony command requests are queued and handled asynchronously, when the client subscribes, the CTelService object creates a Win32 Event object and passes its handle to the Telephony Service. The Telephony Service sets this event to notify the CTelService object that the result is ready. It can then make a synchronous DeviceIoControl call to get the data associated with the result. The same mechanism is used to notify the client of unsolicited events. The CTelEventMonitor helper class wraps the creation of a listening thread for receiving notification of events.

The ITelService interface shown in Table 1 has the following methods:

TABLE 1-1
ITelService Overview

| Function Name | Purpose |
|---|---|
| Open | Wraps call to CreateFile for the Telephony Service |
| Close | Wraps call to CloseHandle for the Telephony Service |
| Subscribe | Wraps call to DeviceIoControl with IOCTL_TEL_SUBCRIBE |
| | control code to subscribe to events of interest and register a |
| | Windows Event to be used for notification when an event of |
| | that type occurs. |
| Unsubscribe | Wraps call to DeviceIoControl with |
| | IOCTL_TEL_UNSUBCRIBE control code to unsubscribe |
| | from events of interest and deregister a Windows message |
| | queue. |
| SendRequest | Wraps call to DeviceIoControl with |
| | IOCTL_TEL_SEND_REQUEST control code to send a |
| | request event to the PAL Event Service. |
| SendRequestAndGetResult | Blocking version of SendRequest which wraps call to |
| | DeviceIoControl to send a request event to the PAL Event |
| | Service then waits for up to timeout period for the result, and |
| | calls GetEvent to get the result data to return to the caller. |
| GetEvent | Wraps call to DeviceIoControl with IOCTL_TEL_GET_EVENT |
| | control code to retrieve data associated with an |
| | unsolicited event or response. |

All data passed to DeviceIoControl needs to be serialized. The contents of the SEND REQUEST input data buffer for and the GET EVENT output data buffer are dependent on the event type. In all cases, the data includes a common section containing parameters such as the Event Type identifier, followed by event type specific parameters. To facilitate the serialization and de-serialization of event data, this is encapsulated within functions of the event type classes.

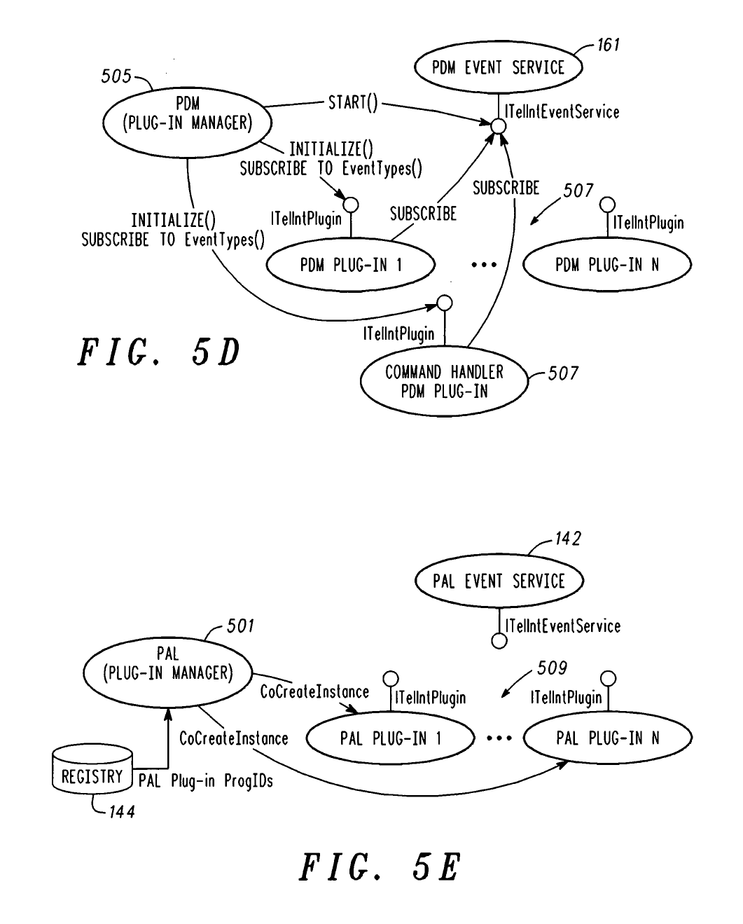

Interactions between the Client 101 (or TSP 145) and the Telephony Client 102 are illustrated in FIG. 10, Client API<-> Telephony Client sequence diagram.

An abstract class CTelEventMonitor is used for monitoring unsolicited events from the telephony service. This class starts a thread to wait for telephony events to be signaled, then calls the CTelService::GetEvent method to retrieve the event data and invokes the virtual OnEvent method to handle it. Classes can be derived from CTelEventMonitor which implement the OnEvent handler to perform specific event handling (e.g., to pass the event to a client specific callback).

For more details of the specific PAL requests, results and unsolicited event types, see Plug-ins description below.

TSP <-> PAL

The TSP 145 interacts with the PAL 140 in the same way as the Client 101. It uses the same CTelService, CTelEventMonitor and message/event classes to encapsulate use of the PAL's IOCTL interface and the serialization and de-serialization of messages passed through this interface. For more details of the specific PAL requests, results and unsolicited event types, see Plug-ins description below.

PAL <-> PDM

The PAL 140 and PDM 160 interact via messages sent through the PAL-PDM Event Services 161. The PDM exports an IPDM interface which enables the PAL to send command requests to the PDM. It encapsulates use of the PDMs Event Service. The IPDM interface methods are shown in Table 2-2.

TABLE 2-2
IPDM Interface

| Method | Purpose |
|---|---|
| Initialize | Initialize the PDM - load and initialize PDM plug-ins and |
| | invoke their IPDMPlugIn::SubscribeToPDMEventTypes |
| | method. |
| SendRequest | Send request e.g., (CPDMDial) to the PDM. Invokes the |
| | PDM Event Service PublishEvent method to dispatch the |
| | request to the appropriate PDM plug-in that has subscribed |
| | for the CPDMDial event type. |

On initialization, the PAL provides the PDM with a pointer to its IPALPDMInterface. This interface has methods that allow the PDM to send the results of command requests and unsolicited events to the PAL. It encapsulates use of the PAL Event Service. The PAL <-> PDM API essentially comprises (as reflected in part in Table 2-3): the IPALPDMInterface and IPDM interfaces which enable the PAL to send requests to the PDM and enable the PDM to send results and unsolicited events to the PAL; and

the set of PDM request, result and unsolicited event messages that are exchanged.

TABLE 2-3
IPALPDMInterface

| Method | Purpose |
|---|---|
| SendResult | Send result of PDM request (e.g., CPDMDialResult) to the |
| | PAL. |
| SendEvent | Send unsolicited event (e.g., CPDMConnected) to the PAL |

For more details of the specific PDM requests, results and unsolicited event types, refer to the PDM Plug-Ins section below.

PAL <-> UAL

As shown in FIG. 1 the UAL (part of 128) is a custom plug-in and like all plug-ins implements the ITelPlugin interface. It also implements the ITelEventSink interface and responds to requests associated with various Client API interfaces, e.g., IHeadset, IAudioConfiguration, IVibrator, IMelody, ILid, ICradle, etc. It generates events of category IAudioEventCategory (headset inserted/removed etc). For internal use by the PAL, the UAL also exports COM interfaces equivalent to the Client API IHeadset, IAudioConfiguration, IVibrator, IMelody, ILid, ICradle, and the like interfaces.

### TIC Subsystem Details

Client APIs

Overview

From the client application perspective, clients interact with the Telephony Interface Component 100 via their specific Client API, and the TIC interacts via the Telphony.ClientAPI of the Telephony Client 102. In particular, the client APIs consist of a fairly synchronous COM based API. An overview of the COM API is provided below in Synchronous COM API Overview with more detailed information provided in SMS Utility Com Objects. An event notification mechanism that is used to notify applications of asynchronous events is described in Event Service Framework.

Synchronous COM API Overview

Overview

The COM based API is accessed primarily through the following COM objects:

Telephony. ClientAPI. Telephony.ClientAPI implements a large number of interfaces and is the main programmatic interface to telephony services provided by the TIC 100. It can expose nearly the entire Telephony API, including but not limited to call management, phonebook services and packet data service management APIs.

Telephony.PhoneNumber. A utility COM object used to construct, parse and manipulate phone numbers.

Various SMS and USSD utility COM objects, including:
Telephony.SMSAddress
Telephony.SMSDeliver
Telephony.SMSDeliverReportRPAck
Telephony.SMSDeliverReportRPError
Telephony.SMSSubmit
Telephony.SMSSubmitReportRPAck
Telephony.SMSSubmitReportRPError
Telephony.SMSCommand
Telephony.SMSStatusReport
Telephony.CBMessage
Telephony.USSDString

Telephony.Client API

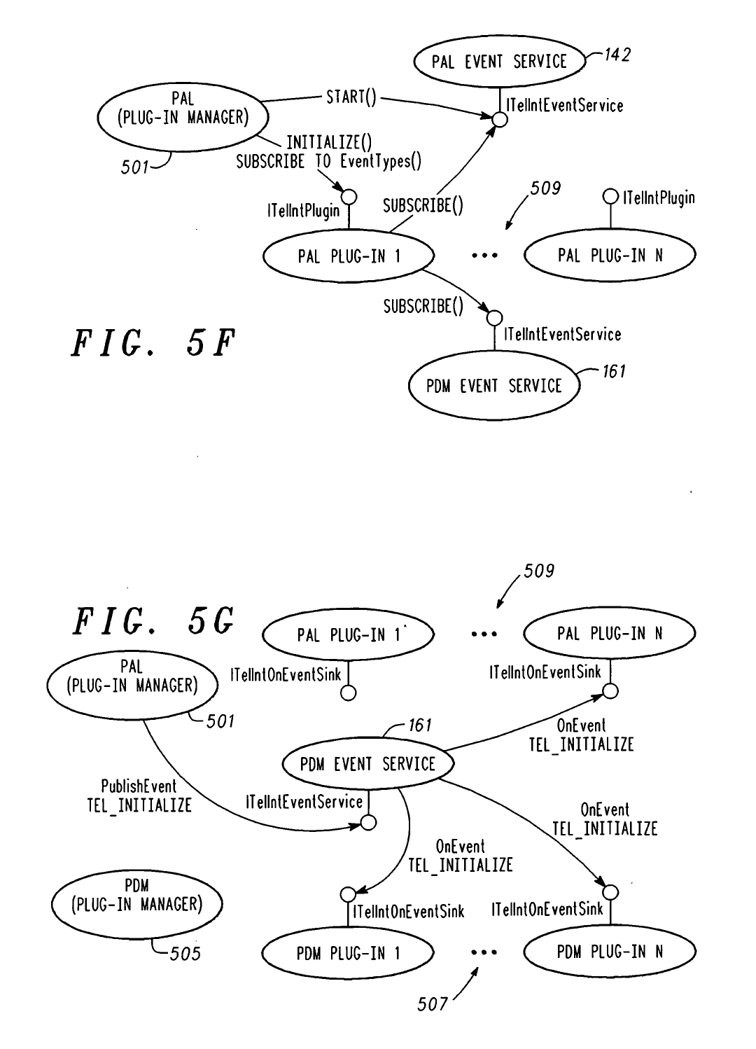

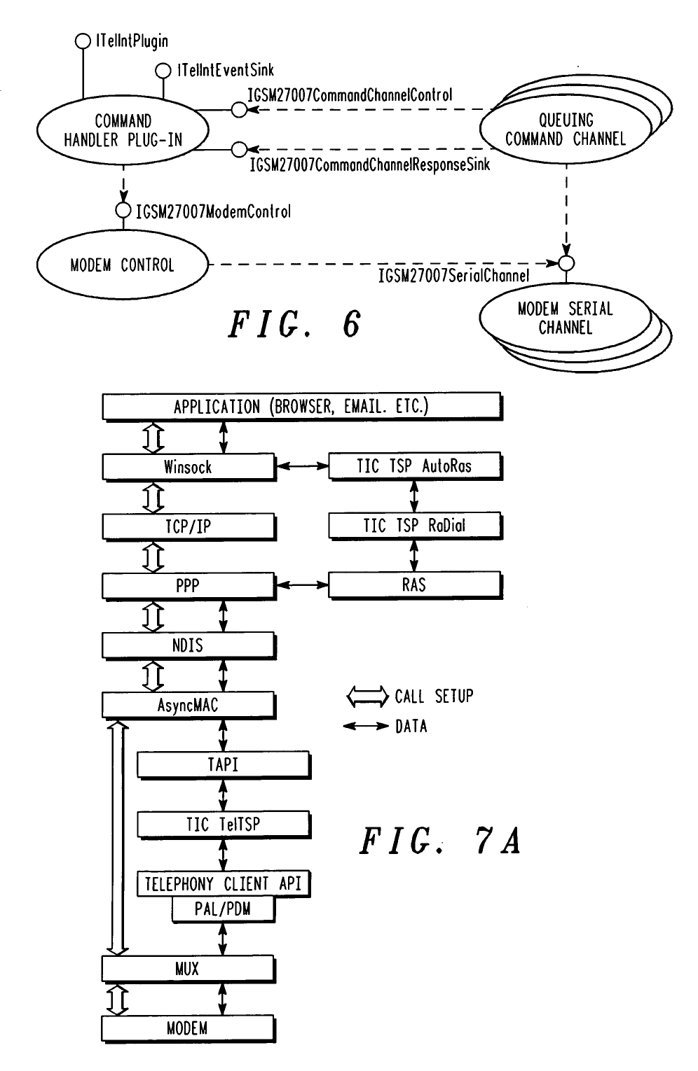

The Telephony Interface Component 100 provides access to all telephony services via the Telephony Client 102 and its associated application programming interface called the Telephony.Client API. It is the main programmatic interface to all services provided by the TIC 100. The major interfaces exposed by the Telephony Client 102 via the Telephony.ClientAPI are illustrated in FIG. 11 and FIG. 12. A brief description of these interfaces is provided in Table 3-1 and Table 3-2. Telephony.ClientAPI implements these interfaces largely through aggregation. This is done to componentize the implementation and to facilitate the extension of the API without modification of the baseline services.

Depending on the specifics and characteristics pertaining to the hardware platform on/for which the telephony interface component is being deployed, many of the interfaces exposed by Telephony.ClientAPI may or may not be available. If QueryInterface on Telephony.ClientAPI does not provide the requested interface and returns E_NOT_IMPL, then that feature is either: Not yet implemented or not supported on the given platform.

For example, if the phone is uniquely a GERAN device, QueryInterface on Telephony.ClientAPI for IUTRANDevice will fail. If, however, it is both a GERAN and UTRAN device QueryInterface for both interfaces will succeed. The expected availability of the interfaces is indicated in Table 3-1. It will be appreciated that Table 3-1 as well as other tables below is exemplary in nature and the contents are not necessarily comprehensive and may evolve with services and over time.

TABLE 3-1
Interfaces Exposed Directly by Telephony.ClientAPI

| | | Interface Exposed by | | |
|---|---|---|---|---|
| API | | Telephony.ClientAPI | Required | Description |
| Audio | | IAudioManager | Yes | Audio control, including |
| | | | | volume and mic gain. Audio |
| | | | | mode control, including |
| | | | | mute. Audio mode |
| | | | | configuration. |
| | | IHeadset | No. Available if the handset | Headset related audio |
| | | | supports a headset. | control, including volume |
| | | | | and mic gain. Permits |
| | | | | detection of the presence of |
| | | | | the headset. Question: Do we |
| | | | | have to worry about multiple |
| | | | | headsets? |
| Call | | ICallManager | Yes | Call management functions, |
| | | | | including making MO calls |
| | | | | and answering MT calls. |
| Data | | IPacketDataService | No. Available if the handset | Packet data service |
| | | | supports packet data services. | management functions. |
| | | IHSCSDService | No. Available if the handset | HSCSD configuration |
| | | | supports HSCSD services. Only | management. HSCSD calls |
| | | | available on GERAN devices. | are made through the call |
| | | | | manager. |
| | | IGERANDevice | Yes, if the device supports the | Basic device management |
| | | | GSM/GPRS access technology. | functions, including, methods |
| | | | At least one of IGERANDevice | to determine the |
| | | | or IUTRANDevice must be | attributes/capabilities of the |
| | | | supported. | device (e.g. GPRS class) and |
| | | | | the SIM lock state. |
| | | IUTRANDevice | Yes if the device supports the | Basic device management |
| | | | UTRAN access technology. At | functions, including, methods |
| | | | least one of IGERANDevice or | to determine the |
| | | | IUTRANDevice must be | attributes/capabilities of the |
| | | | supported. | device and the SIM lock |
| | | | | state. |
| | | ILid | No. Available only if the device | Permits determination of the |
| | | | has a lid. | state of the lid. |
| Event | | IEventService | Yes | Permits the subscription to |
| | | | | events. A core Telephony |
| | | | | API. |
| Log | | ILog | Yes | Permits viewing/purging of |
| | | | | the log. MT calls, MO calls, |
| | | | | sent and received SMS |
| | | | | messages are logged here. |
| Network | | INetworkManager | Yes | Permits determination of |
| | | | | information about the |
| | | | | network. Also permits |
| | | | | modification of the preferred |
| | | | | operator lists, if the platform |
| | | | | supports it. |
| Notification | | INotificationManager | Yes | Controls the notification to |
| | | | | the user of phone related |
| | | | | events (e.g. incoming call), |
| | | | | including melody selection, |
| | | | | vibrator. Supports various |
| | | | | notification modes. |
| Phonebook | | IPhonebookManager | Yes | Provides access to the |
| | | | | various phonebooks on the |
| | | | | platform. |
| Radio | | IRadio | Yes | Used to set various aspects of |
| | | | | the radio subsystem, |
| | | | | including radio power and |
| | | | | audio sample gains. |
| | | IRadioSubsystemTime | No. Only available if the radio | Used to get/set the radio |
| | | | subsystem has an independent | subsystem's independent |
| | | | clock. | clock. |
| SAT | | ISATManager | No. Only available if the | Used by the SAT UI |
| | | | platform supports some version | application to interact with |
| | | | of a SIM application toolkit. | the SAT implementation |
| | | | | within Telephony. |
| SIM | | ISIM | Yes | Used to provide access to |
| | | | | data on the SIM/USIM. |
| | | IEAPSession | No. Only available if the | Used by applications to open |
| | | | platform supports EAP | and manage EAP sessions |
| | | | sessions. | with SIM applications. |
| | | ISIMCommand | No. Only available if the | Used by applications to send |
| | | | platform supports SIM | commands to the SIM. |
| | | | commands. | |
| | | IUICCSession | No. Only available if the | Used by applications to open |
| | | | platform supports UICC | and manage UICC sessions |
| | | | sessions. | with SIM applications. |
| SMS/CBS | | ISMSService | No, but highly unlikely that it | Used to send and receive |
| | | | would not be available. | SMs. A basic service used by |
| | | | Possibly only unavailable if | messaging. Message |
| | | | TIC is deployed on, say, a non- | concatenation for example is |
| | | | phone device that only needs | handled by messaging. |
| | | | packet data services. | |
| Services | Advice of | | No. Only if the advice of | Used to determine the current |
| | Charge | | charge is supported on the | accumulated charge and to |
| | | | platform. | reset the counter. |
| | Call | | No, but highly unlikely that it | Used to manage the call |
| | Forwarding | | would not be available. | forwarding settings. |
| | | | Possibly only unavailable if | |
| | | | TIC is deployed on, say, a non- | |
| | | | phone device. | |
| | Call Waiting | | No, but highly unlikely that it | Used to manage the call |
| | | | would not be available. | waiting settings. |
| | | | Possibly only unavailable if | |
| | | | TIC is deployed on, say, a non- | |
| | | | phone device. | |
| | Closed User | | No. Only if the closed user | Used to manage the closed |
| | Group | | group services are supported on | user group settings. |
| | | | the platform. | |
| | Connected Line | | No. Only if the connected line | Used to manage the |
| | ID | | ID is supported on the platform. | connected line ID settings. |
| | Facilities | | No. Only if the facility | Used to configure various |
| | | | management is supported on | facilities, including call |
| | | | the platform. | barring and fixed number |
| | | | | dialing. |
| | Incoming Caller | | No, but highly unlikely that it | Used to set the incoming |
| | ID | | would not be available. | caller ID settings. |
| | | | Possibly only unavailable if | |
| | | | TIC is deployed on, say, a non- | |
| | | | phone device. | |
| | Outgoing Caller | | No. Only if outgoing caller id | Used to set the outgoing |
| | ID Restriction | | restriction is supported on the | caller ID restriction settings. |
| | | | platform. | |
| | USSD | | No. Only if USSD support is | Used to send USSD strings. |
| | | | available on the platform. | Note that network originated |
| | | | | USSD strings are detected |
| | | | | via an event. |
| | VBS | | No. Only if VBS support is | Used to control voice |
| | | | available on the platform. | broadcast services. |
| | eMLPP | | No. Only if eMLPP support is | Used to configure eMLPP |
| | | | available on the platform. | services. |

| | | | |
|---|---|---|---|
| Vibrator | IVibrator | Available if the platform has a | Used to turn the vibrator on |
| | | vibrator. | or off and to determine its |
| | | | state. |

TABLE 3-2
Other Interfaces Accessed through those Exposed by Telephony.ClientAPI

| | Additional Interfaces | |
|---|---|---|
| Interface Exposed by | Accessed/Created through | |
| Telephony.ClientAPI | Interface | Description |
| IAudioManager | IAudioMode | An interface to a data container object that represents |
| | | an audio mode, e.g. “Normal” or “Handset”. Has an |
| | | audio configuration associated with it. |
| | IAudioConfiguration | An interface to a data container object that holds the |
| | | speaker volume, mic gain and mute state. |
| | IAudioConfigurationWithHeadset | An interface to a data container object that extends |
| | | IAudioConfiguration to include the volume, mic gain |
| | | and mute state associated with a headset. |
| ICallManager | IVoiceCall | Represents a voice call. |
| | IPacketDataCall | Represents a packet data call. (Does an activated |
| | | packet data context show up as a call? Probably |
| | | should.) |
| | IHSCSDCall | Represents a CSD call. |
| IHeadset | N/a. | As in Table 3-1. |
| IPacketDataService | IPacketDataSettings | An interface to a data container object that holds the |
| | | settings for the packet data service. Has multiple packet |
| | | data contexts. |
| | IPacketDataContext | An interface to a data container object that holds the |
| | | settings for a single packet data context for the packet |
| | | data service. Has, possibly, a traffic flow template, |
| | | quality of service profile and 3G quality of service |
| | | profile. |
| | ITrafficFlowTemplate | An interface to a data container object that holds a |
| | | single traffic flow template. |
| | IQualityOfSerivceProfile | An interface to a data container object that holds a |
| | | single quality of service profile. |
| | I3GQualityOfServiceProfile | An interface to a data container object that holds a |
| | | single 3G quality of service profile. |
| IHSCSDService | IHSCSDSettings | An interface to a data container object that holds the |
| | | HSCSD settings for the device. |
| IEventService | IEventSink | An interface implemented by a client wishing to |
| | | receive notification of events. |
| | IEvent | An interface to an event data container object. Permits |
| | | accessing the fields of the event, including the |
| | | category, type and payload. |
| ILog | IMTVoiceCallLogEntry | An interface to a data container object that holds the |
| | | attributes of a log entry that holds information |
| | | regarding an MT voice call. |
| | IMOVoiceCallLogEntry | An interface to a data container object that holds the |
| | | attributes of a log entry that holds information |
| | | regarding an MO voice call. |
| | IPacketDataCallLogEntry | An interface to a data container object that holds the |
| | | attributes of a log entry that holds information |
| | | regarding a packet data call. |
| | ISMReceivedLogEntry | An interface to a data container object that holds the |
| | | attributes of a log entry that holds information |
| | | regarding a received SM. |
| | ISMSentLogCallEntry | An interface to a data container object that holds the |
| | | attributes of a log entry that holds information |
| | | regarding sent SM. Also holds that status of that SM. |
| | IErrorLogEntry | An interface to a data container object that holds the |
| | | attributes of a log entry that holds information |
| | | regarding an error in Telephony. |
| INetworkManager | IPreferredOperatorList | An interface to list of preferred operators. |
| | IOperator | An interface to a specific operator. |
| IPhonebookManager | IPhonebook | An interface to a phonebook. A phonebook contains |
| | | multiple phonebook entries. |
| | IPhonebookEntry | An interface to a data container object that holds the |
| | | attributes of a phonebook entry. |
| | IOwnPhonebookEntry | An interface to a data container object that holds the |
| | | attributes of a subscriber's “own” phonebook entry. |
| IRadio | N/a. | As in Table 3-1. |
| IRadioSubsystemTime | N/a. | As in Table 3-1. |
| ISATManager | TBD | TBD |
| ISIM | N/a. | As in Table 3-1. |
| ISIMCommand | N/a. | As in Table 3-1. |
| IEAPSession | N/a. | As in Table 3-1. |
| IUICCSession | N/a. | As in Table 3-1. |
| ISMSService | ISMSServiceSettings | An interface to a data container object that holds the |
| | | settings for the SMS service. |
| | ISMSMessageStore | An interface to a SM storage facility on the phone. |
| | A myriad of SMS interfaces. | See SMS/CBS.API and SMS Utility.API. |
| | See SMS/CBS.API and SMS | |
| | Utility.API. | |
| IVibrator | N/a. | As in Table 3-1. |

Telephony.PhoneNumber

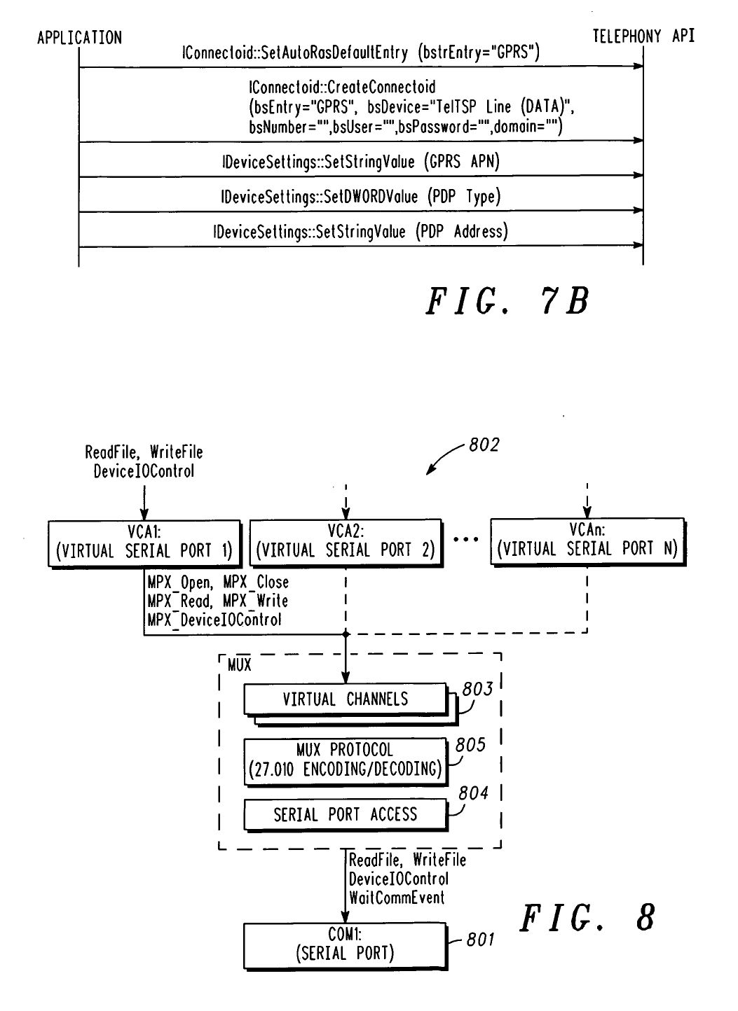

Telephony.PhoneNumber is a utility COM object used to construct, parse and manipulate phone numbers and uses IPhoneNumber interface as reflected in FIG. 13. IPhoneNumber is described further in Phone Number Utility API.

SMS Utility COM Objects

A number of SMS related utility COM objects are defined. These are used to construct short messages (SMs), and to parse received SMs. Functions are also provided to initialize simple text messages. High level COM objects also support concatenated SMs, EMS, and other application specific uses of SMS. The main SMS utility COM objects are described in Table 3-3.

TABLE 3-3
Main SMS-Related COM Objects and Interfaces

| COM Object | Interface | Description |
|---|---|---|
| Telephony.SMSAddress | ISMSAddress | Used to create, parse and manipulate SMS |
| | | addresses. |
| Telephony.SMSDeliver | ISMSDeliver | Used to parse and manipulate SMS deliver SMs. |
| Telephony.SMSDeliverReportRPAck | ISMSDeliverReportRPAck | Used to create, parse and manipulate SMS |
| | | deliver report RP ack SMs. |
| Telephony.SMSDeliverReportRPError | ISMSDeliverReportRPError | Used to create, parse and manipulate SMS |
| | | deliver report RP error SMs. |
| Telephony.SMSSubmit | ISMSSubmit | Used to create, parse and manipulate SMS |
| | | submit SMs. ISMSSubmit has a helper method |
| | | to initialize a simple text SMs. |
| Telephony.SMSSubmitReportRPAck | ISMSSubmitReportRPAck | Used to parse and manipulate SMS submit |
| | | report RP ack SMs. |
| Telephony.SMSSubmitReportRPError | ISMSSubmitReportRPError | Used to parse and manipulate SMS submit |
| | | report RP error SMs. |
| Telephony.SMSCommand | ISMSCommand | Used to create, parse and manipulate SMS |
| | | command SMs. |
| Telephony.SMSStatusRport | ISMSStatusRport | Used to parse and manipulate SMS status report |
| | | SMs. |
| Telephony.PDUInformationElement | IPDUInformationElement | Used to create, parse and manipulate |
| | | information elements in SMs. |

Event Service Overview

Referring to FIG. 1, the Telephony Client 102 allows clients to subscribe to various telephony events through the IEventService interface exposed by the Telephony.ClientAPI. Part of Event Notification Services 104, this interface allows Clients 101 to subscribe to telephony related events as provided by the TIC 100.

There are event categories and event types. Clients can subscribe to either an event category to receive all event types in that category, or to individual event types. Event categories and event types are associated with specific interfaces and are summarized in Table 3-4. If a given interface is not available for a specific platform, its events will also be unavailable.

TABLE 3-4
Event Categories and Event Types

| | | Interface | | |
|---|---|---|---|---|
| | | Implemented by | Event | |
| API | | Telephony.ClientAPI. | Category | Event Types |
| Audio | | IAudioManager | Audio | ModeChange |
| | | | | Mute |
| | | | | Unmute |
| | | IHeadset | Headset | HeadsetInserted |
| | | | | HeadsetRemoved |
| | | ICallManager | Call | NewMOCall |
| | | | | CallCancelled |
| | | | | Dialing |
| | | | | NoCarrier |
| | | | | NoDialTone |
| | | | | CalledPartyBusy |
| | | | | CalledPartyRejectedCall |
| | | | | NoAnswer |
| | | | | Connected |
| | | | | HungUpCall |
| | | | | CalledPartyHungUpCall |
| | | | | CallDroppedByNetwork |
| | | | | HeldCall |
| | | | | CalledPartyPutCallOnHold |
| | | | | CallOffHold |
| | | | | NewUnansweredMTCall |
| | | | | NewWaitingMTCall |
| | | | | MTCallAnswered |
| | | | | MTCallIgnored |
| | | | | MTCallRejected |
| | | | | IncomingCallerIDAvailable |
| | | | | ConnectedLineIDAvailable |
| | | | | GeneralFailure |
| Data | | IPacketDataService | PacketData | ServiceAttach |
| | | | | ServiceDetach |
| | | | | ContextActivated |
| | | | | ContextDeactivated |
| | | | | ContextChanged |
| Device | | IDevice | Device | SIMNotInserted |
| | | | | SIMRemoved |
| | | | | SIMInserted |
| | | | | WaitingForPINorPUK |
| | | IGERANDevice | | |
| | | IUTRANDevice | | |
| | | ILid | | Opened |
| | | | | Shut |
| Event | | IEventService | | |
| Log | | ILog | | |
| Network | | INetworkManager | Network | Registered |
| | | | | Unregistered |
| | | | | SignalStrengthChangedSignificantly |
| Notification | | INotificationManager | | |
| Phonebook | | IPhonebookManager | | |
| Radio | | IRadioPower | RadioPower | Minimum |
| | | | | RxAndTxCircuitsDisabled |
| | | | | TxEnabled |
| | | | | TxDisabled |
| | | | | RxEnabled |
| | | | | RxDisabled |
| | | | | Full |
| | | IRadioSubsystemTime | | |
| SAT | | ISATManager | SAT | DISPLAY_TEXT |
| | | | | GET_INKEY, |
| | | | | GET_INPUT, |
| | | | | MORE_TIME, |
| | | | | PLAY_TONE, |
| | | | | POLL_INTERVAL, |
| | | | | REFRESH, |
| | | | | SETUP_MENU, |
| | | | | SELECT_ITEM, |
| | | | | SEND_SHORT_MESSAGE, |
| | | | | SEND_SS, |
| | | | | SEND_USSD, |
| | | | | SETUP_CALL, |
| | | | | POLLING_OFF, |
| | | | | PROVIDE_LOCAL_INFORMATION, |
| | | | | SETUP_EVENT_LIST, |
| | | | | PERFORM_CARD_APDU, |
| | | | | POWER_OFF_CARD, |
| | | | | POWER_ON_CARD, |
| | | | | GET_READER_STATUS, |
| | | | | TIMER_MANAGEMENT, |
| | | | | SETUP_IDLE_MODE_TEXT, |
| | | | | RUN_AT_COMMAND, |
| | | | | SEND_DTMF, |
| | | | | LANGUAGE_NOTIFICATION, |
| | | | | LAUNCH_BROWSER, |
| | | | | OPEN_CHANNEL, |
| | | | | CLOSE_CHANNEL, |
| | | | | RECEIVE_DATA, |
| | | | | SEND_DATA, |
| | | | | GET_CHANNEL_STATUS, |
| | | | | VOID, |
| | | | | TERMINATE_COMMAND |
| | | | | RETURN_TO_MAIN_MENU |
| SIM | | ISIM | | |
| | | IEAPSession | | |
| | | ISIMCommand | | |
| | | IUICCSession | | |
| SMS/CBS | | ISMSService | SMS | ESMSEVENTTYPE_DELIVER_RECEIVED |
| | | | | ESMSEVENTTYPE_CBM_RECEIVED |
| | | | | ESMSEVENTTYPE_SUBMIT_SEND_RESULT |
| | | | | ESMSEVENTTYPE_SUBMIT_REPORT_RP_ERROR_RECEIVED |
| | | | | ESMSEVENTTYPE_SUBMIT_REPORT_RP_ACK_RECEIVED |
| | | | | ESMSEVENTTYPE_COMMAND_SEND_RESULT |
| | | | | ESMSEVENTTYPE_STATUS_REPORT_RECEIVED |
| Service | Advice of | IAdviceOfChargeService | AdviceOfCharge | CCMChanged |
| | Charge | | | ACMMExceeded |
| | Call Deflection | ICallDeflectionService | CallDeflection | CallDeflected |
| | Call Fowarding | ICallForwardingService | CallForwarding | CallForwarded |
| | Call Waiting | ICallWaitingService | CallWaiting | CallWaiting |
| | Closed User | IClosedUserGroupService | | |
| | Group | | | |
| | Connected Line | IConnectedLineIDService | ConnectedLine | ConnectedLineIDAvailable |
| | ID | | ID | |
| | Facilities | IFacilities | | |
| | Incoming Caller | IIncomingCallerIDService | IncomingCallerID | IncomingCallerIDAvailable |
| | ID | | | |
| | Outgoing Caller | IOutgoingCallerIDRestriction- | | |
| | ID Restriction | Serivce | | |
| | USSD | IUSSDService | | USSDStringReceived |
| | VBS | IVBSService | | |
| | eMLPP | IeMLPPService | | |

| | |
|---|---|
| Vibrator | IVibrator |

Event Service Framework

The Event Service framework provides a subscription based event notification mechanism for all telephony clients. It enables external clients to subscribe (via the Telephony Client 102) to event types of interest (e.g., a new Incoming Call) and then receive notification when an event of this type occurs.

The Event Service can also used internally within the TIC 100 as a general framework for dispatching messages associated with telephony commands and results (as well as unsolicited telephony events) to the appropriate PAL 140 and PDM 160 plug-in components for handling.

Two singleton instances of the Event Service are instantiated within the Telephony Interface Component 100. The first is in the PAL 140, and is the PAL Event Services 142. PAL Event Services 142 is used to queue and dispatch events to PAL components and external telephony clients (i.e. both TSP 145 clients and Telephony Clients 102). The second is in the PDM, and is the PDM Event Services 161. This is used to queue and dispatch events to PDM plug-in components.

Within the overall TIC, Event Services are used to facilitate:
Multi-client support by enabling concurrent use by multiple clients;
Flexibility by providing a generic mechanism that can be used both for notifying external clients of events and also internally as a generic message/event dispatching framework;
Ease of extensibility by allowing new types of events to be added to the system (e.g., for new plug-ins and clients) without affecting existing components. To this end, the Event Service framework itself is domain independent and handles all events in the same generic way; and
Improved system performance by providing efficient dispatch of events to subscribers and minimize blocking.

The Telephony Service can handle certain requests immediately, for example, by just returning some cached value, whereas other requests may require sending one or more commands to the radio equipment, for which there may be a delay before the response is received. To maximize performance and prevent blocking all other client requests while waiting for a response from the radio equipment, requests are handled asynchronously using a single queue and dispatch thread which allows the handler to return as soon as a command had been sent to the radio equipment (rather than waiting for the response); the subsequent response is handled as an asynchronous event. This approach is advantageous as, although it introduces some programming complexity which requires the modeling of states, it is more flexible and simplifies multi-threading management issues.

Events, Event Types and Event Subscriptions

Events are classified by category (i.e. super-type) and type. For example, the Call category contains call related events such as Call Connected and Call Held. Clients can subscribe either by event category, in which case they will receive events belonging to any type within that category, or they can subscribe to specific event types. The category of an event is deduced from its event type using a bit mask). Producers of events publish the types of events that they can produce. When an event consumer subscribes to event categories or types, they can optionally specify whether the Event Service checks the availability to see if there is a producer for those event categories/types. There are three types of Events utilized by the TIC 100:
unsolicited (broadcast) events (e.g., incoming call notification event);
requests for asynchronous commands (e.g., dial command); and
responses to asynchronous command requests (e.g., dial result).

All events are assigned a unique ID. For events associated with requests and results, the subscription ID of the originator of the request is passed as an event attribute. This enables the Event Service to filter the responses so that the subscriber will only receive responses to requests that they were the originator of, and not also those of other subscribers. In the response, the Context attribute is set to the ID of the original request, so that the recipient of the response can determine which request it is a response to.

Events may have additional data parameters that are specific to the event type. In order for all events to be handled in a generic way by the Event Service, at the generic (CTelEvent) level, the data is just passed as a data blob attribute. Recipients of events can use the event type to determine how to interpret the event data using the specific event subclass.

Event Service Class Diagram

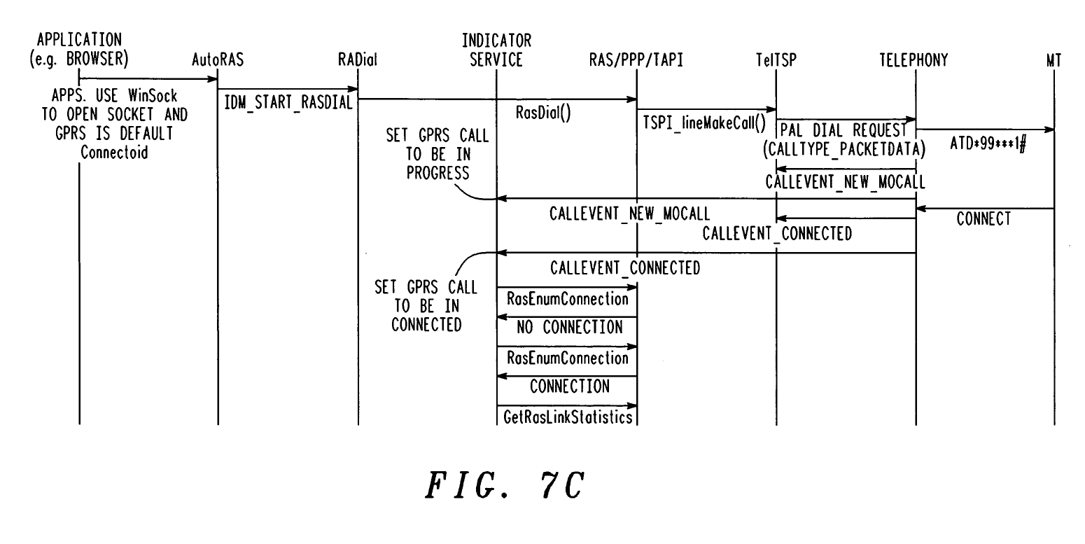

Event Services as implemented in the TIC 100 is illustrated in FIG. 14, Event Service Class Diagram; and the respective interfaces and methods are summarized in Table 3-5, Event Service Overview.

TABLE 3-5
Event Service Overview

| Name | Description |
|---|---|
| ITelEvent | API encapsulating event with accessors for retrieving common attributes |
| | (category, type etc). |
| CTelEvent | Implementation class for ITelEvent. |
| ITelEventService | Event service API, providing methods to subscribe to event |
| | types/categories of interest, to unsubscribe, and to publish new events |
| | (i.e., send new events to the event service for dispatch). |
| CTelEventService | Implementation class ITelEventService. Two instances are created within |
| | the Telephony Suite - PAL and PDM. |
| ITelEventSink | Sink API used for event notification via OnEvent callback (which |
| | provides ITelEvent I/F pointer). |
| CTelSubscription | Stores information about subscription of a given subscriber (event |
| | categories and types of interest) and provides lookup functionality to |
| | determine if a subscriber has subscribed to a given event. |
| CTelEventQueue | Queue of events for dispatching. |
| CTelEventDispatcher | Dispatcher which dequeues each event, queries CTelSubscription objects |
| | to determine which subscribers need to be notified of the event and |
| | invokes the subscriber's OnEvent callback, passing in the ITelEvent I/F |
| | pointer to the event. |
| CTelResult | Specialization of CTelEvent for a response containing an HRESULT |
| | result code. |

Event Service Subscription and Notification Scenario

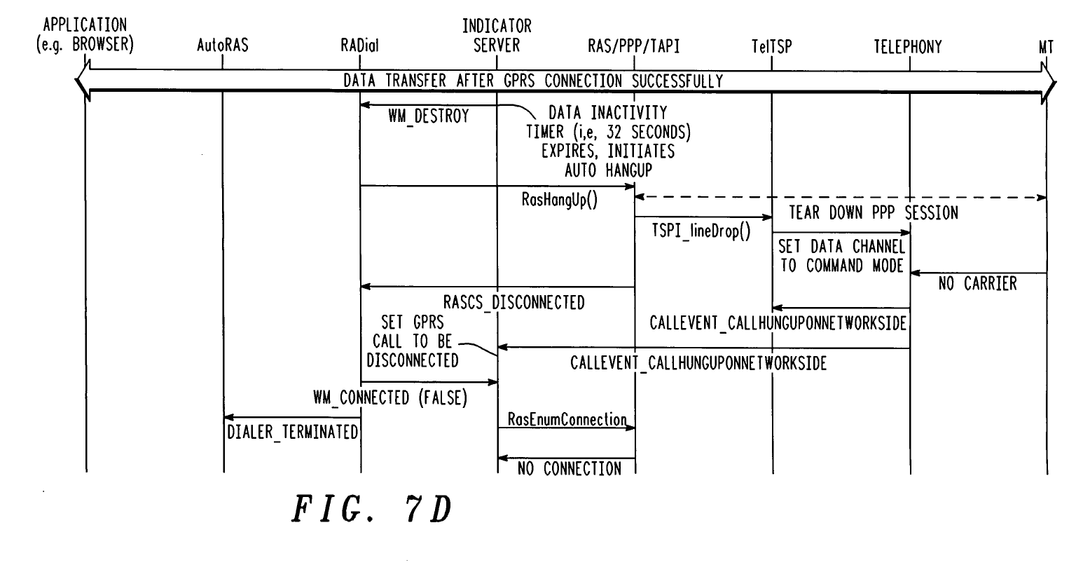

The scenario for subscribing to the event service and for subsequent event notification is presented in FIG. 15, event service subscription and notification sequence diagram. This shows the interactions between the Telephony Event Service objects when an event consumer client (such as a PAL plug-in) subscribes to events of interest and an event producer (such as a PDM plug-in) generates one of those events.

APIs

In general and in reference to FIGS. 1 and 2, the application programming interfaces (APIs) as provided by the Telephony Interface Component 100, are presented. With reference to the figures, it is noted that these are intended to be general representations only, and are not an exhaustive list or discussion of all possible present interfaces and/or components. As a result, the following discussion may present and discuss APIs and/or components, which are not shown in the above referenced figures. It is expected that one skilled in the art will appreciate the general architecture as discussed can be extended to other APIs or components.

Audio API

Referring to FIGS. 1 and 2, the Audio API is not expressly shown. The Audio API assumes and supports one or more of the following:

Device/phone that includes an integrated speaker or mic.

Device/phone may support a headset (wired or wireless).

Multiple audio modes (e.g., normal, handsfree, headset, multimedia, user defined).

The Audio API allows client applications to:

get and set the current integrated speaker volumes;
get and set the current integrated mic gain;
mute the integrated mic;
determine if a headset is available;
set the current headset volume;
set the current headset mic gain;
mute the mic;
define and modify different audio modes;
set the audio configuration for each mode;
select the mode; and
other functions or operations.

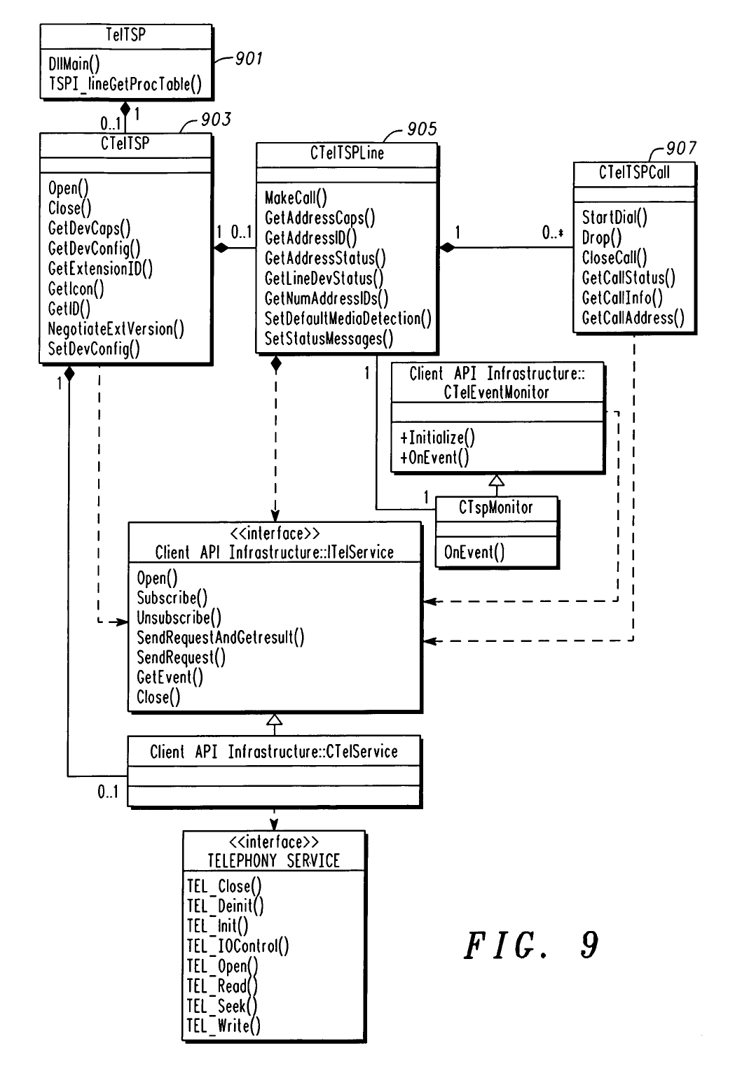

The Audio API is summarized/illustrated in FIG. 16. The Audio API interfaces and methods are summarized in Table 3-6 and events associated with the Audio API were summarized above in Table 3-4.

TABLE 3-6
Audio API Overview

| Interface | Method | Description |
|---|---|---|
| IAudioManager | GetCurrentSpeakerVolume( ) | Gets the current speaker volume. |
| | SetCurrentSpeakerVolume( ) | Sets the current speaker volume. |
| | | Temporarily overrides the |
| | | configuration associated with the |
| | | current mode.. |
| | GetCurrentMicGain( ) | Gets the current mic gain. |
| | SetCurrentMicGain( ) | Sets the current mic gain. |
| | | Temporarily overrides the |
| | | configuration associated with the |
| | | current mode. |
| | GetMuteState( ) | Gets the current mic mute state. |
| | Mute( ) | Mutes the mic. Temporarily |
| | | overrides the configuration |
| | | associated with the current mode. |
| | Unmute( ) | Unmutes the mic. Temporarily |
| | | overrides the configuration |
| | | associated with the current mode. |
| | GetAvailableAudioModes( ) | Gets the available audio modes. |
| | GetCurrentAudioMode( ) | Gets the current audio mode. There |
| | | is always a current audio mode. |
| | SetCurrentAudioMode( ) | Sets the current audio mode. |
| IAudioMode | GetName( ) | Gets the name of the mode. |
| | GetMode( ) | Gets the programmatic mode. |
| | GetAudioConfiguration( ) | Gets the audio configuration |
| | | associated with the mode. |
| | SetAudioConfiguration( ) | Sets the audio configuration |
| | | associated with the mode. |
| IAudioConfiguration | GetSpeakerVolume( ) | Gets the integrated speaker volume |
| | | for the configuration. |
| | SetSpeakerVolume( ) | Sets the integrated speaker volume |
| | | for the configuration. |
| | GetMicGain( ) | Gets the integrated mic gain for the |
| | | configuration. |
| | SetMicGain( ) | Sets the integrated mic gain for the |
| | | configuration. |
| | GetMuteState( ) | Gets the mic mute state for the |
| | | configuration. |
| | SetMuteState( ) | Sets the mic mute state for the |
| | | configuration. |
| IAudioConfigurationWithHeadset | GetHeadsetVolume( ) | Gets the headset volume for the |
| | | configuration. |
| | SetHeadsetVolume( ) | Sets the headset volume for the |
| | | configuration. |
| | GetHeadsetMicGain( ) | Gets the headset mic gain for the |
| | | configuration. |
| | SetHeadsetMicGain( ) | Sets the headset mic gain for the |
| | | configuration. |
| | GetMuteState( ) | Gets the headset mic mute state for |
| | | the configuration. |
| | SetMuteState( ) | Sets the headset mic mute state for |
| | | the configuration. |
| IHeadset | GetState( ) | Gets the current insertion state of |
| | | the headset. |
| | GetVolume( ) | Gets the current volume for the |
| | | headset. |
| | SetVolume( ) | Sets the current volume for the |
| | | headset. Temporarily overrides the |
| | | configuration associated with the |
| | | current mode. |
| | GetMicGain( ) | Gets the current mic gain for the |
| | | headset. |
| | SetMicGain( ) | Sets the current mic gain for the |
| | | headset. Temporarily overrides the |
| | | configuration associated with the |
| | | current mode. |
| | GetMuteState( ) | Gets the mute state for the headset. |
| | Mute( ) | Mutes the headset mic. Temporarily |
| | | overrides the configuration |
| | | associated with the current mode. |
| | Unmute( ) | Unmutes the headset mic. |
| | | Temporarily overrides the |
| | | configuration associated with the |
| | | current mode. |

Call API

Referring to FIGS. 1 and 2, the Call API is a component of Call Manager 122, which allows client applications to:
determine the capabilities of the device, e.g., voice, data and fax and alternating call modes;
make voice, data and fax calls;
be notified of incoming and waiting calls and answer them;
find out what calls exist and their attributes, including: their state; the phone number; duration; caller ID; connected line ID; and affect the state of calls, including: hanging up calls; putting calls on and off hold, connecting calls, managing conference calls.

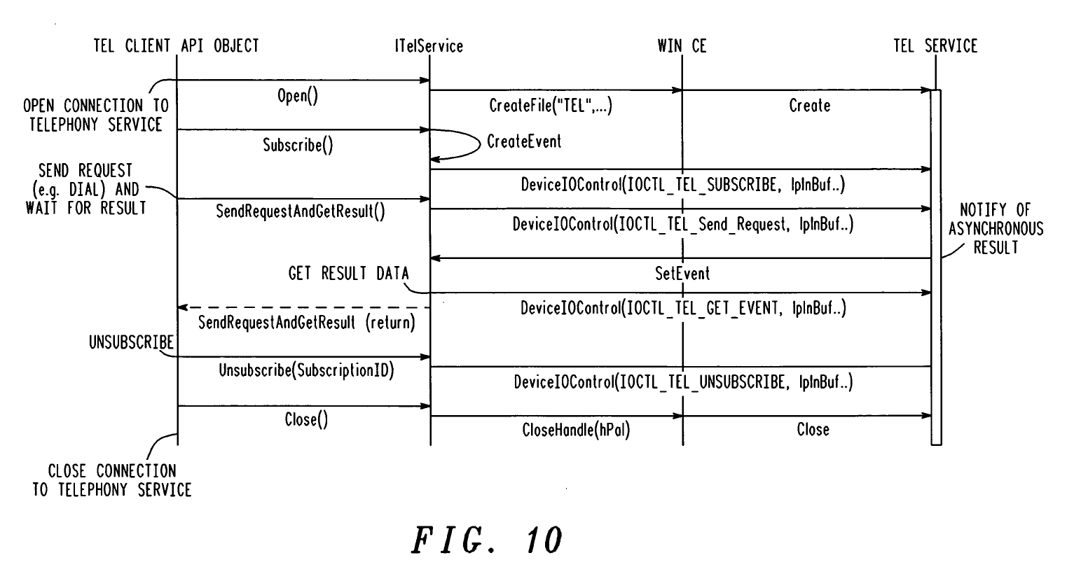

The Call API 122 is summarized in FIG. 17. The interfaces and their methods are summarized in Table 3-7. The events associated with the Call API are summarized above in Table 3-4.

TABLE 3-7
Call API Overview

| Interface | Method | Description |
|---|---|---|
| ICallManager | GetSupportedCallTypes( ) | Gets the supported call types, including: |
| | | Single |
| | | AlternatingVoiceFax |
| | | AlternatingVoiceData |
| | | AlternatingVoiceFollowedByData |
| | GetSupportedCallModes( ) | Gets the supported call modes, including: |
| | | Voice |
| | | Data |
| | | Fax |
| | DialVoice( ) | A simple method to make a voice call. |
| | Dial( ) | General method to make any kind of call |
| | | supported by the device. |
| | DialEmergencyNumber( ) | A simple method to make an emergency |
| | | call. |
| | DialGeneralEmergencyNumber( ) | An even simpler method to make an |
| | | emergency call. |
| | GetCall( ) | Gets a call based on it's call ID. |
| | GetActiveCalls( ) | Gets all active calls. |
| | GetHeldCalls( ) | Gets all held calls. |
| | GetAllCalls( ) | Gets all calls. |
| | AddHeldCallToConversation( ) | Adds a held call to the conversation. |
| | ReleaseAllHeldCalls( ) | Releases all held calls. |
| | ReleaseAllActiveCallsAndMakeHeldOr | Releases all active calls and makes the |
| | WaitingCallActive( ) | held or waiting call active. (With an AT |
| | | command based modem, it appears that we |
| | | cannot specify which of the held or waiting |
| | | calls to activate.) |
| | PlaceActiveCallsOnHoldAndActivate | Puts all active calls on hold and activates |
| | HeldOrWaitingCalls( ) | the held or waiting calls. (With an AT |
| | | command based modem, it appears that we |
| | | cannot specify which of the held or waiting |
| | | calls to activate.) |
| | PlaceActiveCallsOnHoldExcept( ) | Places all active calls on hold except thee |
| | | specified call. |
| | ConnectCalls( ) | Connects two calls and releases the phone |
| | | from the conversation. |
| | GetAutomaticAnswerMode( ) | Gets the automatic answer mode for each |
| | | call mode. |
| | SetAutomaticAnswerMode( ) | Sets the automatic answer mode for each |
| | | call mode. |
| | GetCallTimingSettings( ) | Gets various call timing settings. |
| | SetCallTimingSettings( ) | Sets various call timing settings. |
| | GetSupportedSingleNumberingScheme | Gets the supported single numbering |
| | Modes( ) | scheme modes, e.g. a collection of: |
| | | Voice |
| | | AlternatingVoiceFaxVoiceFirst |
| | | Fax |
| | | AlternatingVoiceDataVoiceFirst |
| | | Data |
| | | AlternatingVoiceFaxFaxFirst |
| | | AlternatingVoiceDataDataFirst |
| | | VoiceFollowedByData |
| | GetSingleNumberingSchemeMode( ) | Gets the single numbering scheme mode |
| | | for the device. |
| | SetSingleNumberingSchemeMode( ) | Sets the single numbering scheme mode |
| | | for the device. |
| | GetCallTerminationReason( ) | Gets the termination reason for a “dead” |
| | | call. (This is retrieved from the Log.) |
| ICall | GetID( )- | Get the unique ID associated with the call. |
| | Answer( ) | Answers an incoming call. Switches the |
| | | phone into the handset audio mode or, if a |
| | | headset is plugged-in, the headset/phone |
| | | mode, if appropriate. |
| | HangUp( ) | Hangs-up the call. Switches the audio |
| | | mode if appropriate. |
| | Hold( ) | Puts the call on hold. |
| | Activate( ) | Makes a held call active. Keeps other |
| | | active calls active. |
| | Redirect( ) | Redirects the call to the specified number. |
| | ChangeMode( ) | Changes the call mode if the call is an |
| | | alternating mode call. |
| | GetNumber( ) | Gets the phone number of the MO call. |
| | GetTimeInitiated( ) | Test the time at which the call was |
| | | initiated. |
| | GetDurationInSeconds( ) | Gets the call duration in seconds. |
| | GetType( ) | Gets the call type, e.g.: |
| | | Single |
| | | AlternatingVoiceFax |
| | | AlternatingVoiceData |
| | | AlternatingVoiceFollowedByData |
| | GetDirection( ) | Gets the call direction, e.g.: |
| | | MobileOriginated |
| | | MobileTerminated |
| | GetCurrentMode( ) | Gets the current call mode, e.g.: |
| | | Voice |
| | | Data |
| | | Fax |
| | | Unknown |
| | GetState( ) | Gets the call state, e.g.: |
| | | Dialing |
| | | Dialed |
| | | Active |
| | | Holding |
| | | Held |
| | | Activating |
| | | UnansweredIncoming |
| | | AnsweringIncoming |
| | | UnansweredWaiting |
| | | AnsweringWaiting |
| | | HangingUp |
| | GetIsMultiParty( ) | Gets whether the call is a multi-party call |
| | | or not. |
| | GetPriority( ) | Gets the eMLPP call priority. |
| | GetIncomingCallingLineId( ) | Gets the incoming caller ID, if available. |
| | GetOutgoingCallingIdRestrictionStatus( ) | Gets whether the calling line ID restriction |
| | | was invoked for the MO call. |
| | GetConnectedLineId( ) | Gets the incoming caller ID, if available. |
| | GetTerminationReason( ) | Gets the termination reason for a “dead” |
| | | call. (This is retrieved from the Log.) |
| IVoiceCall | SendDTMF( ) | Sends the specified DTMF. |
| | SendDTMFOfDuration( ) | Sends the specified DTMF for the |
| | | specified duration. |
| IPacketDataCall | GetPDPType( ) | Gets the packet data protocol, e.g.: |
| | | X25 |
| | | IPv5 |
| | | IPv6 |
| | | OSPIH |
| | | PPP |
| | GetAccessPointName( ) | Gets the access point name. |
| | GetPDPAddress( ) | Gets the packet data protocol address. |
| IHSCSDCall | GetCurrentCallParameters( ) | Gets the HSCSD parameters. |

Data Service APIs

Overview

Data services are either high speed circuit switched or packet data. Referring to FIGS. 1 and 2, these data services and their APIs are shown as Circuit Switched Data 114 and Packet Data 112, respectively. High-speed circuit switched calls are only available in GERAN-based systems. The APIs are described in HSCSD API and Packet Data API. To ensure code compactness and small code space, both APIs may share some common elements which are described as follows.

Data Service Common API Elements

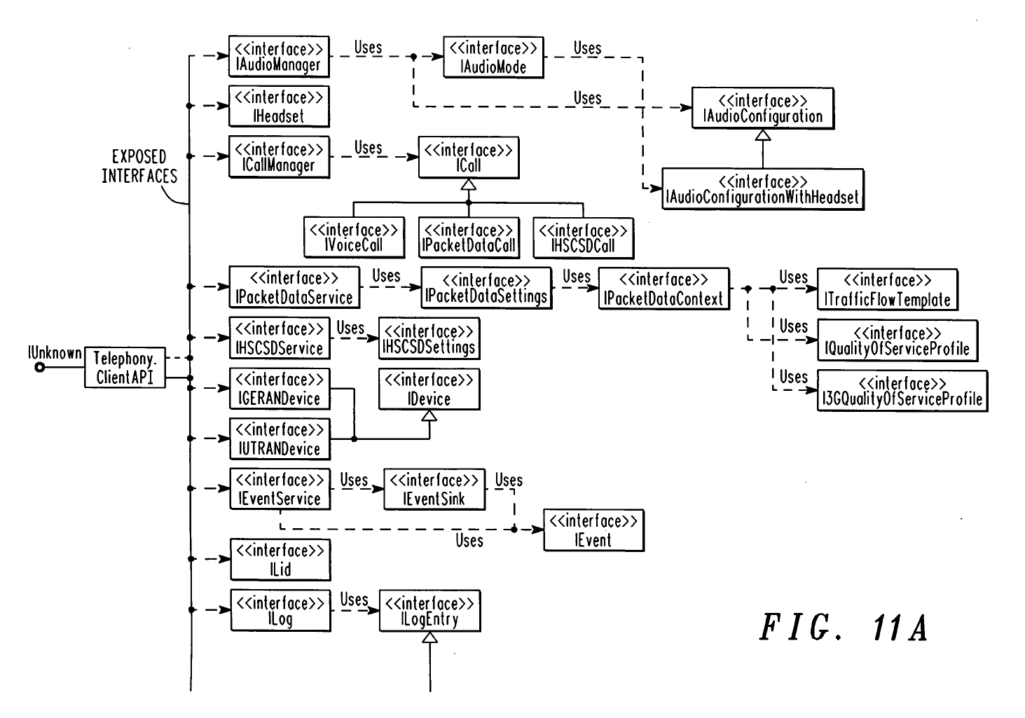

Interface elements shared between the High-Speed Circuit Switched Data API 114 (i.e. HSCSD API) and the Packet Data API 112 are summarized in FIG. 18. The shared interfaces are shown in FIG. 18 and their methods are summarized in Table 3-8. The events associated with the Data Service APIs are summarized in Table 3-4.

TABLE 3-8
Data Services Common Interfaces

| Interface | Method | Description |
|---|---|---|
| IDataServiceSettings | GetSpeed( ) | Gets the desired speed to use |
| | | when a data call is originated. |
| | SetSpeed( ) | Sets the desired speed to use |
| | | when a data call is originated. |

HSCSD API

Referring to FIG. 2, the HSCSD API 114 allows clients applications to control the settings for circuit switched data calls. HSCSD calls are made through the Call API. Current call parameters are obtained through the IHSCSDCall interface. HSCSD call support is available, e.g., for GERAN-based systems.

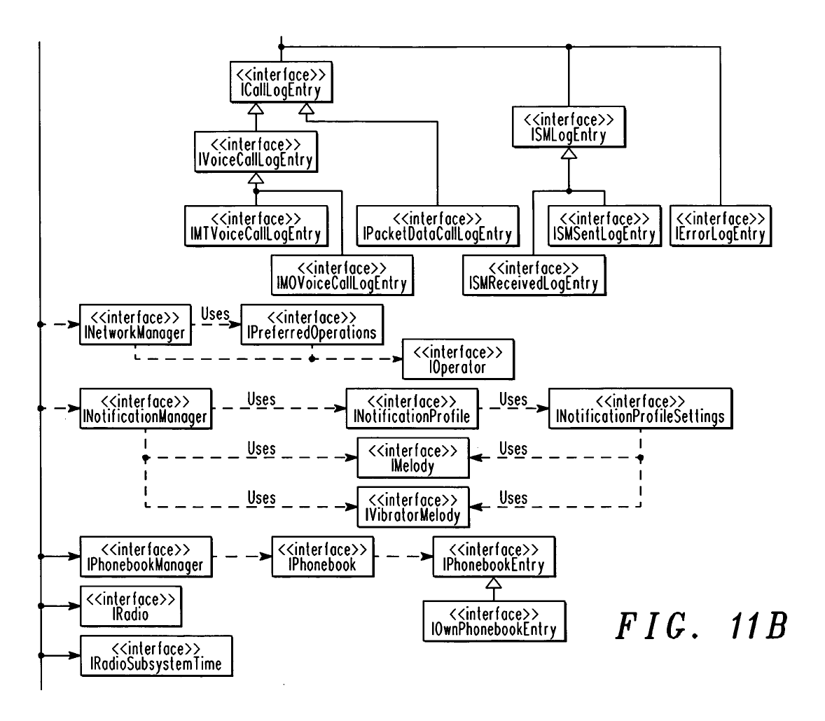

The HSCSD API is summarized in FIG. 19, which illustrates the interfaces and their methods. Table 3-9 itemizes the interfaces and methods in summary form. The events associated with the HSCSD API are summarized in Table 3-4.

TABLE 3-9
High Speed Circuit Switched Data (HSCSD) API

| Interface | Method | Description |
|---|---|---|
| IHSCSDSettings | GetDataBearerServiceName( ) | Gets the data bearer service |
| | | to use. |
| | SetDataBearerServiceName( ) | Sets the data bearer service to |
| | | use. |
| | GetDataBearaerServiceConnectionElement( ) | Gets the service connection |
| | | element to use. |
| | SetDataBearaerServiceConnectionElement( ) | Sets the service connection |
| | | element to use. |
| | GetHSCSDParameters( ) | Gets various HSCSD |
| | | parameters. All parameters |
| | | are read-only. |
| | SetHSCSDTransparentCallParameters( ) | Sets the controls parameters |
| | | for transparent HSCSD calls |
| | | in GERAN. |
| | SetHSCSDNonTransparentCallParameters( ) | Sets the controls parameters |
| | | for non-transparent HSCSD |
| | | calls in GERAN. |
| | GetHSCSDAutomaticUserInitiatedUpgrading( ) | Sets whether automatic user |
| | | initiated service level |
| | | upgrading shall be used for |
| | | non-transparent HSCSD |
| | | calls. |
| | SetHSCSDAutomaticUserInitiatedUpgrading( ) | Gets whether automatic user |
| | | initiated service level |
| | | upgrading shall be used for |
| | | non-transparent HSCSD |
| | | calls. |
| | GetHSCSDNonTransparentAsymmetryConfiguration( ) | Gets the preferred asymmetry |
| | | bias for non-transparent |
| | | HSCSD calls. |
| | SetHSCSDNonTransparentAsymmetryConfiguration( ) | Sets the preferred asymmetry |
| | | bias for non-transparent |
| | | HSCSD calls. |

Packet Data API

Referring to FIG. 2, the Packet Data API 112 allows client applications to control the settings for packet data calls, and to access the packet data service, including attaching to the service; activating a packet data context and modifying the context while activated; retrieving the negotiated service parameters; deactivating a packet data context; and detaching from the service. A packet data context is a collection of parameters that define all of the settings or the configuration of a packet data connection, including compression, traffic flow template and quality of service options.

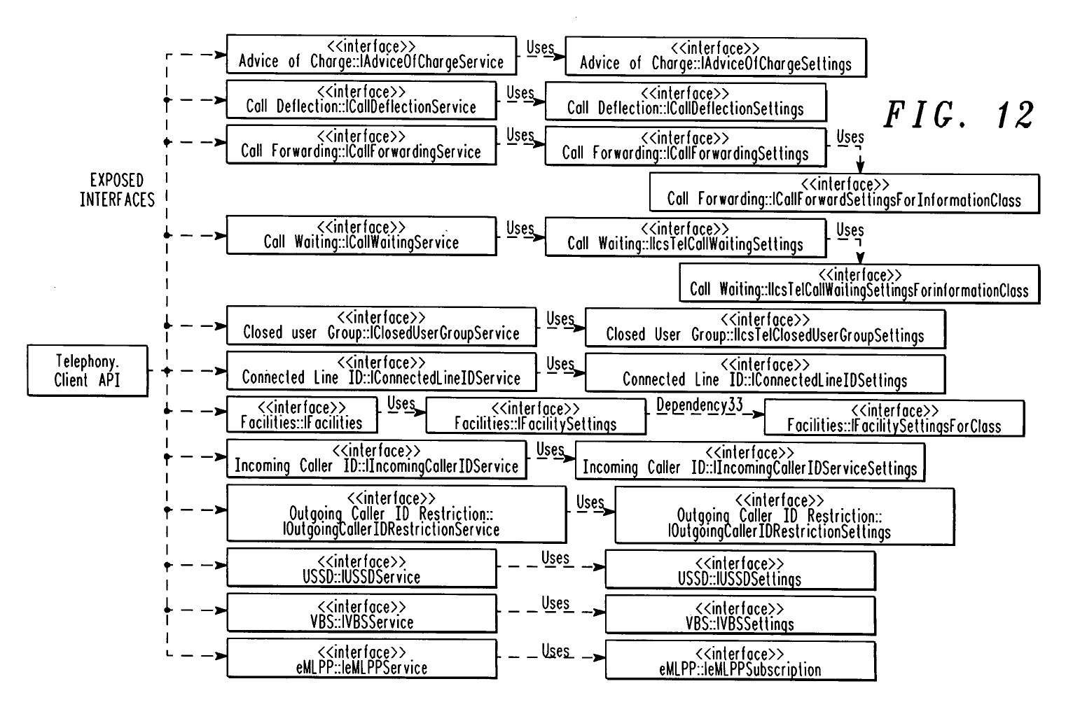

The Packet Data API 112 is summarized in FIG. 20. The interfaces and their methods are summarized in Table 3-10. The events associated with the Packet Data API are summarized in Table 3-4.

TABLE 3-10
Packet Data API Overview

| Interface | Method | Description |
|---|---|---|
| IPacketDataService | GetSupportedPDPTypes( ) | Gets the supported packet data protocols supported |
| | | by the device. |
| | GetRegistrationStatus( ) | Gets the packet data service registration status. |
| | Attach( ) | Attempts to attach to the packet data service. |
| | Detach( ) | Initiates detachment from the packet data service. |
| | Activate( ) | Activates a specific packet data context. |
| | Deactivate( ) | Deactivates a specific packet data context. |
| | ModifyContext( ) | Modifies an activated context. |
| | EnterDataState( ) | Enters the data state for the activated context. |
| | GetPDPAddress( ) | Gets the packet data protocol address associated |
| | | with the activated context. |
| | GetNegotiated3GQualityOfService( ) | Gets the negotiated 3G quality of service. |
| IPacketDataSettings | GetDefaultContext( ) | Gets the default context. |
| | SetDefaultContext( ) | Sets the default context. |
| | GetContexts( ) | Gets all the available contexts. |
| | SetContexts( ) | Sets all the available contexts. |
| | GetContext( ) | Gets a specific context by context ID. |
| | SetContext( ) | Sets a specific context by context ID. |
| | GetSecondaryContext( ) | Gets the secondary context. |
| | SetSecondaryContext( ) | Sets the secondary context. |
| | NewContext( ) | Creates a new context. |
| | DeleteContext( ) | Deletes a context. |
| | RestoreManufacturersSettings( ) | Restores the manufacturer's settings. |
| | GetAutomaticResponseToNetwork- | Gets the automatic response to a network request for |
| | RequestForContextActivation( ) | context activation. |
| | SetAutomaticResponseToNetwork- | Sets the automatic response to a network request for |
| | RequestForContextActivation( ) | context activation. |
| IPacketDataContext | GetCID( ) | Gets the context ID. |
| IPacketDataContext | GetPDPType( ) | Gets the packet data protocol type associated with |
| | | the packet data context. |
| | SetPDPType( ) | Sets the packet data protocol type associated with |
| | | the packet data context. |
| | GetAPN( ) | Gets the access point name. |
| | SetAPN( ) | Sets the access point name. |
| | GetPDPAddress( ) | Gets the access point address. |
| | SetPDPAddress( ) | Sets the access point address. |
| | GetSupportedCompressionOptions( ) | Gets the supported compression options. |
| | GetCompressonOption( ) | Gets the compression option for the context. |
| | SetCompressionOption( ) | Sets the compression option for the context. |
| | GetHeaderCompressionOptions( ) | Gets the supported header compression options. |
| | SetHeaderCompressionOptions( ) | Gets the header compression option for the context. |
| | GetSupportedHeaderCompressionOptions( ) | Sets the header compression option for the context. |
| | GetTrafficFlowTemplate( ) | Gets the traffic flow template for the context. |
| | SetTrafficFlowTemplate( ) | Sets the traffic flow template for the context. |
| | GetRequestedQualityQfServiceProfile( ) | Gets the requested QOS profile for the context. |
| | SetRequestedQualityOfSerivceProfile( ) | Sets the requested QOS profile for the context. |
| | GetMinimumQualityOfServiceProfile( ) | Gets the minimum QOS profile for the context. |
| | SetMinimumQualityOfServiceProfile( ) | Sets the minimum QOS profile for the context. |
| ITrafficFlowTemplate | GetPacketFilterIdentifier( ) | Gets the packet filter identifier for the traffic flow |
| | | template. |
| | SetPacketFilterIdentifier( ) | Sets the packet filter identifier for the traffic flow |
| | | template. |
| | GetSourceAddressAndSubnetMask( ) | Gets the source address and subnet mask for the |
| | | traffic flow template. |
| | SetSourceAddressAndSubnetMask( ) | Sets the source address and subnet mask for the |
| | | traffic flow template. |
| | GetProtocolNumber( ) | Gets the protocol number for the traffic flow |
| | | template. |
| | SetProtocolNumber( ) | Sets the protocol number for the traffic flow |
| | | template. |
| | GetDestinationPortRange( ) | Gets the destination port range for the traffic flow |
| | | template. |
| | SetDestinationPortRange( ) | Sets the destination port range for the traffic flow |
| | | template. |
| | GetSourcePortRange( ) | Gets the source port range for the traffic flow |
| | | template. |
| | SetSourcePortRange( ) | Sets the source port range for the traffic flow |
| | | template. |
| | GetIPSecurityParameterIndex( ) | Gets the IP security parameter index for the traffic |
| | | flow template. |
| | SetIPSecurityParameterIndex( ) | Sets the IP security parameter index for the traffic |
| | | flow template. |
| | GetTypeOfService( ) | Gets the type of service for the traffic flow template. |
| | SetTypeOfService( ) | Sets the type of service for the traffic flow template. |
| | GetIPv6FlowLabel( ) | Gets the IPv6 flow label for the traffic flow |
| | | template. |
| | SetIPv6FlowLabel( ) | Sets the IPv6 flow label for the traffic flow |
| | | template. |
| | GetEvaluationPrecedenceIndex( ) | Gets the evaluation precedence index for the traffic |
| | | flow template. |
| | SetEvaluationPrecedenceIndex( ) | Sets the evaluation precedence index for the traffic |
| | | flow template. |
| IQualityOfServiceProfile | GetPrecedence( ) | Gets the precedence for the QOS profile. |
| | SetPrecedence( ) | Sets the precedence for the QOS profile. |
| | GetDelay( ) | Gets the delay for the QOS profile. |
| | SetDelay( ) | Sets the delay for the QOS profile. |
| | GetReliability( ) | Gets the reliability for the QOS profile. |
| | SetReliability( ) | Sets the reliability for the QOS profile. |
| | GetPeak( ) | Gets the peak throughput class for the QOS profile. |
| | SetPeak( ) | Sets the peak throughput class for the QOS profile. |
| | GetMean( ) | Gets the mean throughput class for the QOS profile. |
| | SetMean( ) | Sets the mean throughput class for the QOS profile. |
| I3GQualityOfServiceProfile | GetTrafficClass( ) | Gets the traffic class for the 3G QOS profile. |
| | SetTrafficClass( ) | Sets the traffic class for the 3G QOS profile. |
| | GetMaximumBitrateUL( ) | Gets the requested maximum uplink bit rate for the |
| | | 3G QOS profile. |
| | SetMaximumBitrateUL( ) | Sets the requested maximum uplink bit rate for the |
| | | 3G QOS profile. |
| | GetMaximumBitrateDL( ) | Gets the requested maximum downlink bit rate for |
| | | the 3G QOS profile. |
| | SetMaximumBitrateDL( ) | Sets the requested maximum downlink bit rate for |
| | | the 3G QOS profile. |
| | GetGuaranteedBitrateUL( ) | Gets the guaranteed maximum uplink bit rate for the |
| | | 3G QOS profile. |
| | SetGuaranteedBitrateUL( ) | Sets the guaranteed maximum uplink bit rate for the |
| | | 3G QOS profile. |
| | GetGuaranteedBitrateDL( ) | Gets the guaranteed maximum downlink bit rate for |
| | | the 3G QOS profile. |
| | SetGuaranteedBitrateDL( ) | Sets the guaranteed maximum downlink bit rate for |
| | | the 3G QOS profile. |
| | GetDeliveryOrder( ) | Gets the delivery order for the 3G QOS profile. |
| | SetDeliveryOrder( ) | Sets the delivery order for the 3G QOS profile. |
| | GetMaximumSDUSize( ) | Gets the service data unit size for the 3G QOS |
| | | profile. |
| | GetMaximumSDUSize( ) | Sets the service data unit size for the 3G QOS |
| | | profile. |
| | GetSDUErrorRatio( ) | Gets the target service data unit error ratio for the |
| | | 3G QOS profile. |
| | SetSDUErrorRatio( ) | Sets the target service data unit error ratio for the |
| | | 3G QOS profile. |
| | GetResidualBER( ) | Gets the target residual bit error ratio for the 3G |
| | | QOS profile. |
| | SetResidualBER( ) | Sets the target residual bit error ratio for the 3G |
| | | QOS profile. |
| | GetDeliveryOfErroneousSDUs( ) | Gets whether erroneous SDUs should be delivered |
| | | for the 3G QOS profile. |
| | SetDeliveryOfErroneousSDUs( ) | Sets whether erroneous SDUs should be delivered |
| | | for the 3G QOS profile. |
| | GetTransferDelay( ) | Gets the target transfer delay for the 3G QOS |
| | | profile. |
| | SetTransferDelay( ) | Sets the target transfer delay for the 3G QOS |
| | | profile. |
| | GetTrafficHandlingPriority( ) | Gets the traffic handling priority for the 3G QOS |
| | | profile. |
| | SetTrafficHandlingPriority( ) | Sets the traffic handling priority for the 3G QOS |
| | | profile. |

Device API

Referring to FIGS. 1 and 2, the Device API is shown as TelDevice API 126, which allows client applications to:
determine some fundamental features of the device, including whether the device supports GERAN or UTRAN networks, or both;
get the supported GPRS class, if applicable;
get various attributes of the device (e.g. manufacturer, model, revision, serial number, IMEI);
manage the SIM lock state.

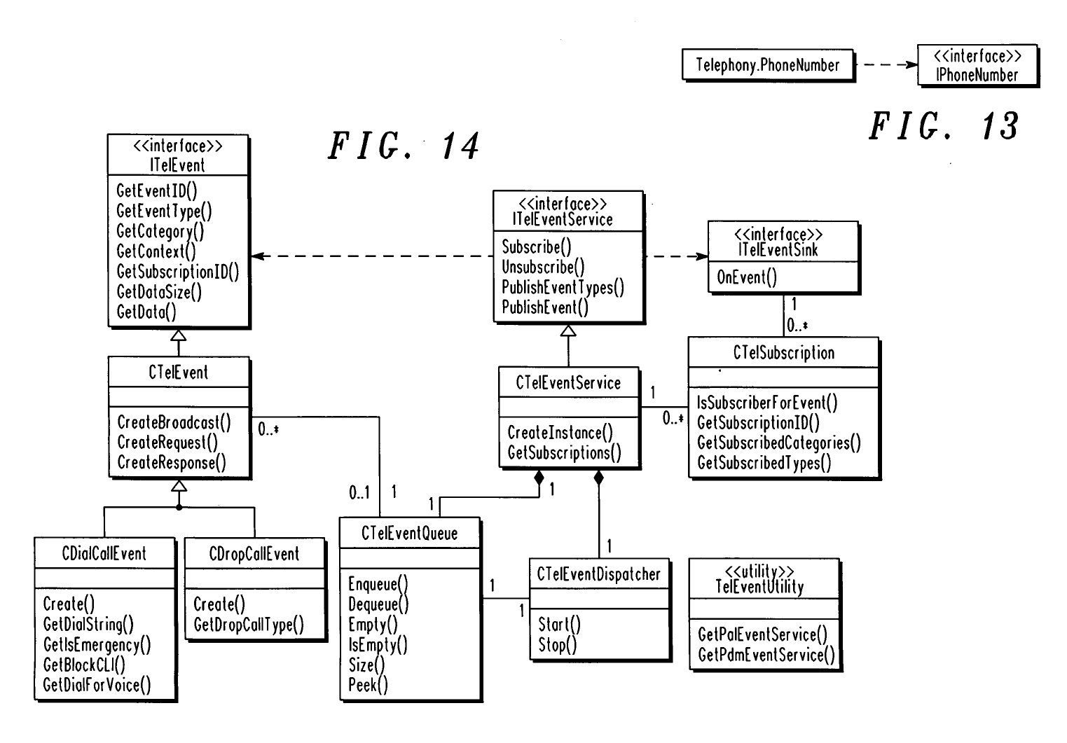

The Device API is summarized in FIG. 21. The interfaces and their methods are summarized in Table 3-11. The events associated with the Device API are summarized in Table 3-4. If the device supports GERAN, then Telephony.ClientAPI will expose an IGERANDevice interface. If the device supports UTRAN, then Telephony.ClientAPI will expose an IUTRANDevice interface. If the device supports both, then both will be exposed. The DeviceAPI always exposes the IDevice interface.

TABLE 3-11
Device API Overview

| Interface | Method | Description |
|---|---|---|
| IDevice | GetLockState( ) | Gets the lock state of the |
| | | device. |
| | GetPINMaximumLength( ) | Gets the maximum length of |
| | | the specified PIN. |
| | EnterPIN( ) | Allows an application to |
| | | provide the PIN to unlock the |
| | | device. |
| | EnterPUKNewPIN( ) | Allows an application to |
| | | provide a PUK and a new PIN. |
| | LockPhoneToSIM( ) | Locks the phone to the SIM. |
| | LockPhoneToFirstInsertedSIM( ) | Locks the phone to the first |
| | | inserted SIM. |
| | LockSIM( ) | Locks the SIM. |
| | GetManufacturer( ) | Gets the name of the |
| | | manufacturer of the device. |
| | GetModel( ) | Gets the model of the device. |
| | GetRevision( ) | Gets the revision. |
| | GetSerialNumber( ) | Gets the serial number. |
| | GetIMEI( ) | Gets the international mobile |
| | | equipment identity number. |
| | GetSupportedAccessTechnology( ) | Gets the supported access |
| | | technologies. |
| IGPRSDevice | GetSupportedGPRSClasses( ) | Gets the supported GPRS |
| | | classes. |
| | GetGPRSClass( ) | Gets the current GPRS class. |
| | SetGPRSClass( ) | Sets the current GPRS class. |
| IUTRANDevice | There are no IUTRANDevice methods defined at | N/a. |
| | this point. | |

Event API

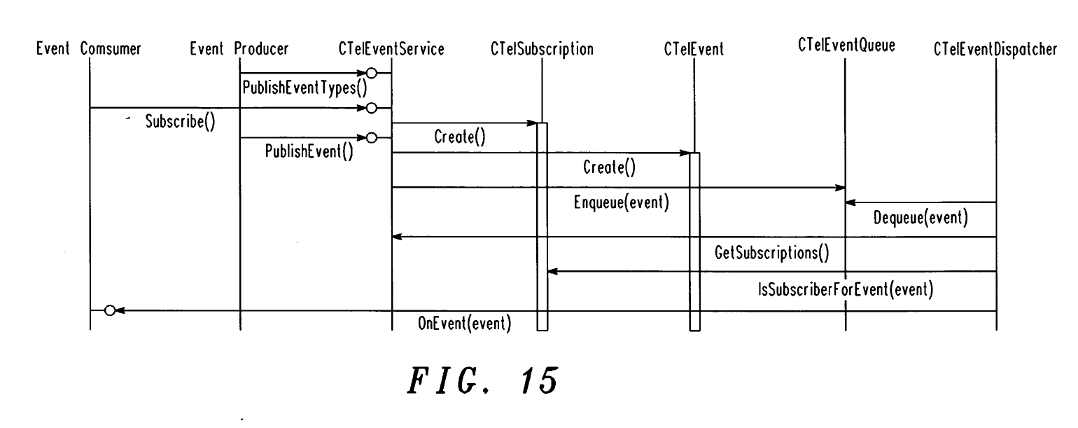

Referring to FIGS. 1 and 2, the Event API is a component of the Event Notification Service 104. It allows client applications to subscribe to event categories or specific event types. Clients can provide either a callback API or register a Windows message queue. The Event Notification API is summarized in FIG. 22. The interfaces and their methods are summarized in Table 3-12.

TABLE 3-12
Event API Overview

| Interface | Method | Description |
|---|---|---|
| IEventService | SubscribeCallback( ) | Allows the client to subscribe with a callback |
| | | interface - IEventSink. |
| | SubscribeWindowsMessageQueue( ) | Allows the client to subscribe with a windows |
| | | message queue. When an event occurs, |
| | | WM_POLARIS_TEL_EVENT is posted to the |
| | | queue. The event is subsequently gotten with a call to |
| | | GetEvent( ). |
| | Unsubscribe( ) | Terminates the subscription. No further events will |
| | | be received. |
| | GetEvent( ) | Gets the event object. Called immediately after being |
| | | notified of the occurrence of an event. |
| IEventSink | OnEvent( ) | Invoked when an event occurs for which the client |
| | | has subscribed. |
| IEvent | GetEventID( ) | Gets the ID of the event. |
| | GetEventType( ) | Gets the event type. |
| | GetCategory( ) | Gets the event category. |
| | GetContext( ) | Gets the context of the event. |
| | GetSubscriptionID( ) | Gets the subscription ID. |
| | GetDataSize( ) | Gets the size of the data payload. |
| | GetData( ) | Gets the data payload. |

Lid API

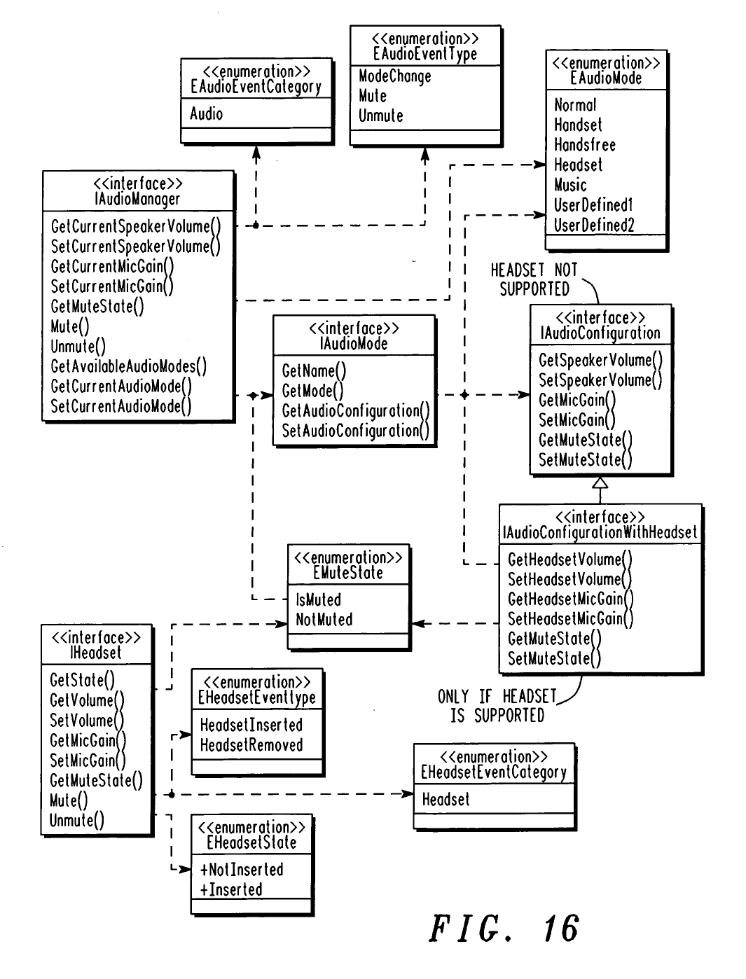

Not specifically shown, the Lid API allows client applications to determine if the device has a lid, and to determine the state of the lid. Lid is a cover for a device and the state of the lid will have an impact device/phone capabilities. The Lid API is summarized in FIG. 23. The interfaces and their methods are summarized in Table 3-13. The events associated with the Lid API are summarized in Table 3-4. If the Telephony.ClientAPI supports the ILid interface, the device has a lid.

TABLE 3-13
Lid API Overview

| Interface | Method | Description |
|---|---|---|
| ILid | GetLidState( ) | Gets the lid state. |

Log API

Referring to FIG. 2, the Log API is a component of the Call History Service 106 of FIG. 1. It allows client applications to access the call history with the objective of examining recent calls for the purposes of, e.g., dialer recall, to access recent SMS and data call activity, to clear the log, and to display systems errors. A separate API is used to log events to the Call Log 109.

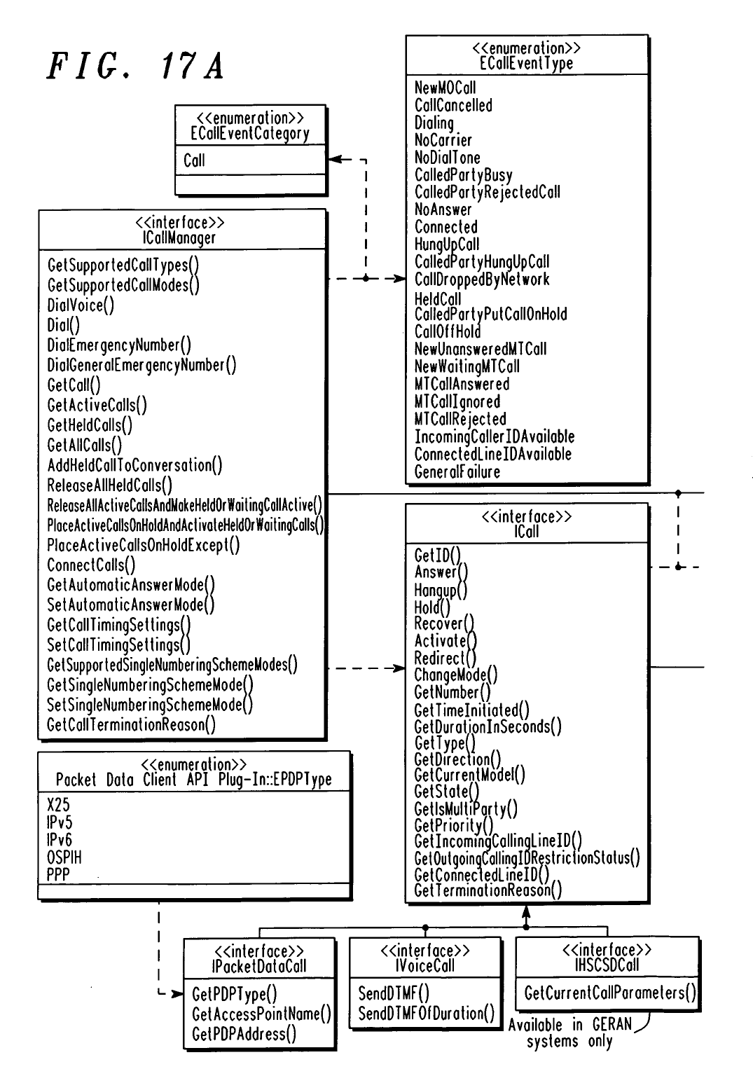

The Log API is summarized in FIG. 24. The interfaces and their methods are summarized in Table 3-14. The events associated with the Log API are summarized in Table 3-4.

TABLE 3-14
Log API Overview

| Interface | Method | Description |
|---|---|---|
| ILog | GetNumberOfEntries( ) | Gets the number of entries in the log. |
| | GetOldestEntry( ) | Gets the oldest entry. |
| | GetYoungestEntry( ) | Gets the youngest entry. |
| | GetMaximumNumberOfCallsToLog( ) | Gets the maximum number of calls that will |
| | | be logged. |
| | SetMaximumNumberOfCallsToLog( ) | Sets the maximum number of calls that will |
| | | be logged. |
| | GetMaximumNumberOfSMsToLog( ) | Gets the maximum number of short messages |
| | | to log. |
| | SetMaximumNumberOfSMsToLog( ) | Sets the maximum number of short messages |
| | | to log. |
| | Clear( ) | Clears the log. |
| ILogEvent | GetTime( ) | Gets the time at which the event was logged. |
| | GetDescription( ) | Gets a description of the event. |
| | GetNext( ) | Gets the next event, if any. |
| | GetPrevious( ) | Gets the previous event, if any. |
| | Delete( ) | Deletes the event. |
| ICallLogEntry | GetStartTime( ) | Gets the start time of the call. |
| | GetDirection( ) | Gets the direction of the call: MO vs MT. |
| | GetDurationInSeconds( ) | Gets the call duration in seconds. |
| | GetCallTerminationReason( ) | Gets the reason why the call was terminated. |
| | GetPhonebookEntry( ) | Attempts to get the phonebook entry |
| | | associated with the number. |
| | GetNumber( ) | In the case of an MO call, the number called. |
| | | In the case of an MT call, the caller ID, if |
| | | available. |
| IPacketDataCallEntry | GetBytesSent( ) | The number of bytes sent. |
| | GetBytesReceived( ) | The number of bytes received. |
| IHSCSDCallEntry | GetBytesSent( ) | The number of bytes sent. |
| | GetBytesReceived( ) | The number of bytes received. |

Network API

Referring to FIGS. 1 and 2, the Network API 106 is a component of Network 116. It allows client applications to:
manage and manipulate preferred operator lists stored on the SIM;
determine the locally available networks;
control the network selection process—automatic or manual;
initiate an attempt to register the device on a network;
get the registration and GPRS registration status;
get information about the network on which the device is registered;
determine the signal quality, radio access technology, etc.

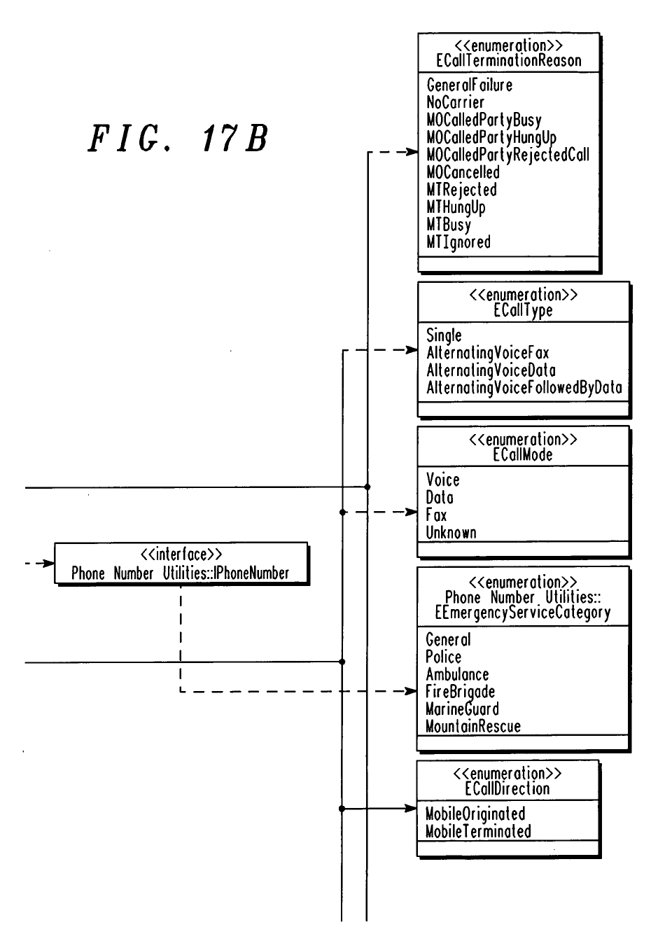

The Network API is summarized in FIG. 25. The interfaces and their methods are summarized in Table 3-15. The events associated with the Network API are summarized in Table 3-4.

TABLE 3-15
Network API Overview

| Interface | Method | Description |
|---|---|---|
| INetworkManager | GetSignalQuality( ) | Gets the available signal strength and bit error |
| | | rate. |
| | GetRegistrationStatus( ) | Gets the registration status. |
| | GetGPRSRegistrationStatus( ) | Gets the GPRS registration status. |
| | GetSupportedSelectionModes( ) | Gets the supported network selection modes. |
| | Register( ) | Initiates an attempt to register on the network |
| | | given the settings. |
| | GetRegisteredOperator( ) | Gets the registered operator. |
| | GetAvailableOperators( ) | Gets the available operators. |
| | GetPreferredOperatorList( ) | Gets the preferred operator list - the one that will |
| | | be used in the selection process. |
| | SetPreferredOperatorList( ) | Sets the preferred operator list - the one that will |
| | | be used in the selection process. |
| | GetOperatorList( ) | Gets the specified preferred operator list, one of: |
| | | UserControlledPLMNSelector, |
| | | OperatorControlledPLMNSelector, or, |
| | | HPLMNSelectorWithAccessTechnology |
| | SetOperatorList( ) | Sets the updated list and writes it to the SIM. |
| IPreferredOperatorList | GetType( ) | Gets the type of list. |
| | GetPreferredOperators( ) | Gets the operators in the list. |
| | SetPreferredOperators( ) | Sets the operators in the list. The list is only |
| | | written to the SIM when |
| | | INetworkManager::SetOperatorList is invoked. |
| | RestoreManufacturersDefaults( ) | Restores the manufacturer's default for the list. |
| | NewOperator( ) | Creates a new operator object that can be put in |
| | | the list. |
| IOperator | GetIndex( ) | Gets the index of the operator entry in the SIM. |
| | GetName( ) | Gets the name of the operator. This should return |
| | | the long name of the operator, if it is available. |
| | GetShortName( ) | Gets the short name of the operator. |
| | GetLongName( ) | Gets the long name. |
| | GetNumericName( ) | Gets the numeric name of the operator. |
| | GetRegistrationStatus( ) | Gets the registration status of the operator. This is |
| | | a snapshot and may not represent the up-to the |
| | | minute status. |
| | GetAvailableAccessTechnologies( ) | Gets the available access technologies for the |
| | | operator. |
| | GetSelectedAccessTechnologies( ) | Gets the selected access technologies for the |
| | | operator. |
| | SetSelectedAccessTechnologies( ) | Sets the selected access technologies for the |
| | | operator. |

Notification API

Not specifically shown in FIG. 1 or 2, the Notification API typically is another vertical component (such as 108, etc.) in FIG. 1 with constituent plug-ins in FIG. 2. The Notification API allows client applications to:
define and manipulate notification profiles such as:
   normal=audible melodies and flashing of the keypad backlights;
   active call=different, much quieter melody for waiting and missed calls;
   vibrator=no audio notification, for example when the user is in a movie theatre;
   flash=only a visible notification; and
   none=no notification at all of any event;
specify the handling of specific events, including:
   what audio melody is played and when;
   what vibrator melody is played when;
   whether to flash the keypad backlight; and
list the available audio and vibrator melodies and preview them.

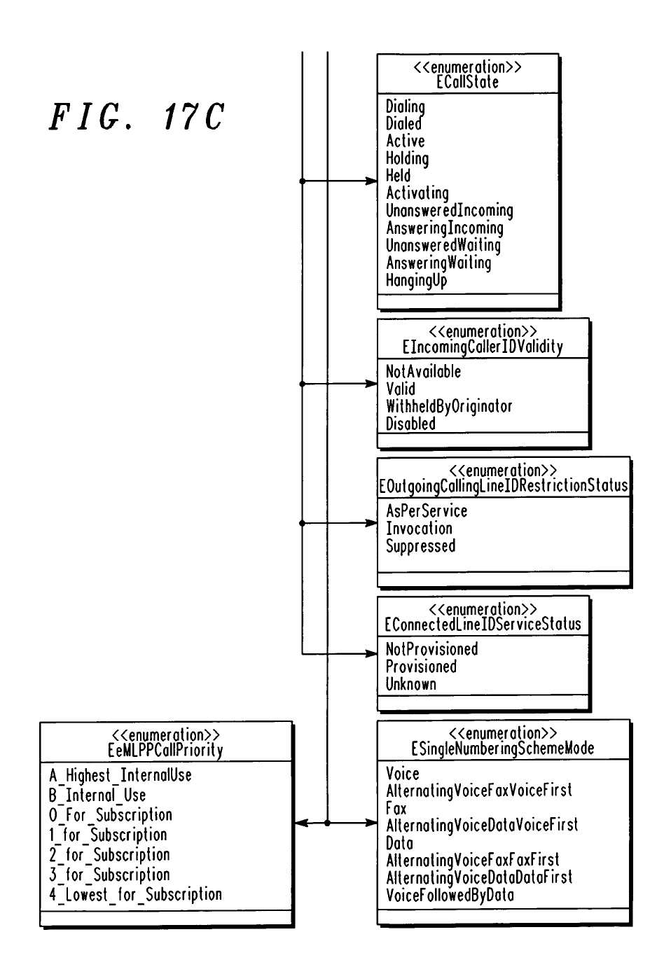

The Notification API is summarized in FIG. 26. The interfaces and their methods are summarized in Table 3-16. The events associated with the Notification API are summarized in Table 3-4.

TABLE 3-16
Notification API Overview

| Interface | Method | Description |
|---|---|---|
| INotificationManager | GetAvailableEventTypes( ) | Gets the available event types. |
| | GetAvailableMelodies( ) | Gets the available melodies. |
| | GetAvailableVibratorMelodies( ) | Gets the available vibrator melodies. |
| | GetProfiles( ) | Gets the defined profiles. |
| | SetProfiles( ) | Sets the defined profiles and updates |
| | | them in the Device Information |
| | | Manager. |
| | GetCurrentProfile( ) | Gets the current profile. |
| | SetCurrentProfile( ) | Sets the current profile and updates |
| | | the current profile in the Device |
| | | Information Manager. |
| | NewNotificationProfile( ) | Creates a new notification profile. |
| | RestoreManufacturersDefaults( ) | Restores the manufacturer's defaults. |
| INotificationProfile | GetName( ) | Gets the name of the profile. |
| | SetName( ) | Sets the name of the profile. |
| | GetMelodyProfileSettings( ) | Gets the settings for the profile. |
| | SetMelodyProfileSettings( ) | Sets the settings for the profile. |
| | NewNotificationProfileSettings( ) | Creates a new settings object. |
| INotificationProfileSettings | GetEventType( ) | Gets the event type associated with |
| | | the settings. I.e., if the event occurs, |
| | | play the associated melodies. |
| | SetEventType( ) | Sets the event type associated with |
| | | the settings. |
| | GetVolume( ) | Gets the relative volume level |
| | | associated with the melody. (Of |
| | | course, this is combined with the |
| | | global volume settings to produce |
| | | the actual volume.) |
| | SetVolume( ) | Sets the relative volume level |
| | | associated with the melody. |
| | GetMelody( ) | Gets the audio melody to play when |
| | | the specified event occurs. |
| | SetMelody( ) | Sets the audio melody to play when |
| | | the specified event occurs. |
| | GetVibrateMelody( ) | Gets the vibrator melody to play |
| | | when the specified event occurs. |
| | SetVibrateMelody( ) | Sets the vibrator melody to play |
| | | when the specified event occurs. |
| | GetFlashKeypadBacklight( ) | Gets whether the keypad backlight is |
| | | flashed or not. |
| | SetFlashKeypadBacklight( ) | Sets whether the keypad backlight is |
| | | flashed or not. |
| IMelody | Play( ) | Plays the audio melody. |
| | Stop( ) | Stops playing the audio melody. |
| | GetName( ) | Gets the name of the audio melody. |
| | SetName( ) | Sets the name of the audio melody. |
| | GetFilename( ) | Gets the filename of the audio |
| | | melody. |
| IVibratorMelody | Play( ) | Plays the vibrator melody. |
| | Stop( ) | Stops playing the vibrator melody. |
| | GetName( ) | Gets the name of the vibrator |
| | | melody. |
| | SetName( ) | Sets the name of the vibrator |
| | | melody. |
| | GetFilename( ) | Gets the filename of the vibrator |
| | | melody. |

Phonebook API

Referring to FIGS. 1 and 2, the Phonebook API 120 is a component of the Phonebook 120. The Phonebook API allows client applications to query and manipulate the various phonebooks that are available on the device. This includes the phonebooks that exist on the SIM and those that may exist uniquely on the device. It should be noted that the list below is not exhaustive does not limit the number of phonebooks that can be defined. Various types of phonebooks in accordance with the list that can be available on the device include:
Dialed Calls (i.e. contains recently placed calls);
Emergency Numbers (i.e. contains emergency numbers);
Fixed Dialing (i.e. contains a set of phone numbers that, when fixed number dialing is enabled, only these numbers can be called);
Last Dialing (i.e. contains the set of recently called phone numbers);
Missed Calls (i.e. contains the set of recently missed calls);
Local (i.e. a phonebook not on the SIM);
Combined (i.e. a virtual phonebook that contains all the entries from all phonebooks);
Own Numbers (i.e. contains the subscribers own phone numbers, including potentially different numbers for different services such as fax and data);
Received Calls (i.e. contains the set of recently answered calls); SIM (i.e. a user defined phonebook on the SIM);
Terminal Adaptor (i.e. if the device contains an AT-based modem, it may have its own phonebooks);
Application (i.e. an application phonebook).

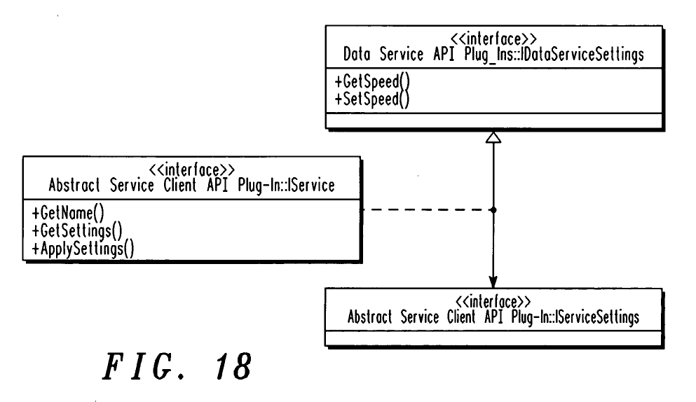

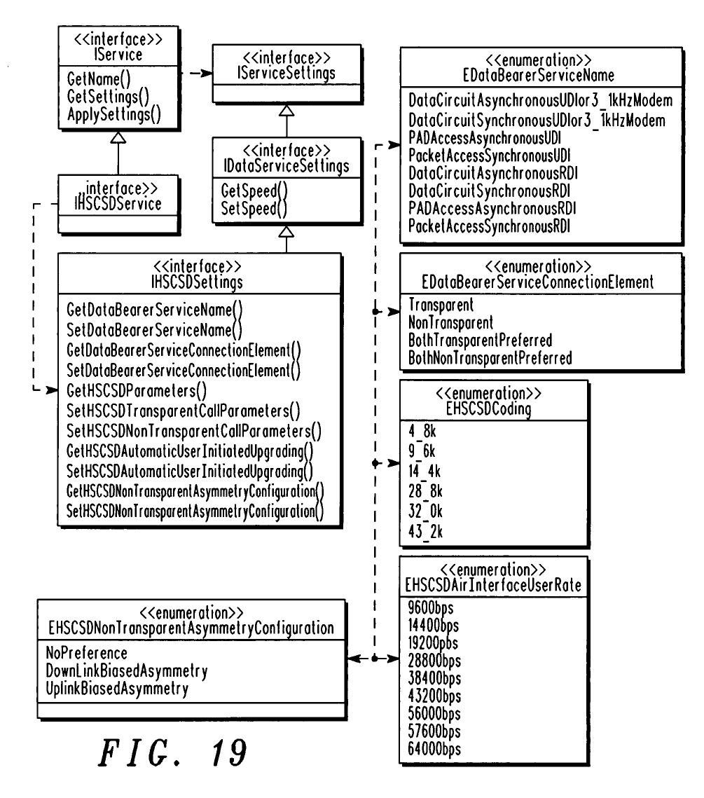

The Phonebook API uses the IPhoneNumber interface. IPhoneNumber is defined in Phone Number Utility API. The Phonebook API is summarized in FIG. 27. The interfaces and their methods are summarized in Table 3-17. The events associated with the Phonebook API are summarized in Table 3-4.

TABLE 3-17
Phonebook API Overview

| Interface | Method | Description |
|---|---|---|
| IPhonebookManager | GetAvailablePhonebooks( ) | Gets the available phonebooks. |
| | GetPhonebook( ) | Gets the specified phonebook. |
| | NewPhonebook( ) | Create a new local phonebook. Only |
| | | phonebooks local to the device can be |
| | | created. |
| IPhonebook | GetName( ) | Gets the name of the phonebook. |
| | GetType( ) | Gets the type of the phonebook. |
| | GetLocation( ) | Gets the location of the phonebook. |
| | GetTotalNumberOfEntries( ) | Gets the total number of entries that |
| | | the phonebook can hold. |
| | GetNumberOfEntries( ) | Gets the number of entries that are |
| | | currently in the phonebook. |
| | FindEntries( ) | Searches for phonebook entries in the |
| | | specified phonebook. |
| | ReadEntries( ) | Gets the specified entries. |
| | NewPhonebookEntry( ) | Creates a new phonebook entry. |
| | DeleteEntry( ) | Deletes a phonebook entry. |
| IPhonebookEntry | GetIndex( ) | Gets the index associated with the |
| | | phonebook entry. |
| | GetMaximumGroupLength( ) | Gets the maximum length of a group |
| | | field. |
| | GetGroup( ) | Gets the group field. |
| | SetGroup( ) | Sets the group field. |
| | GetMaximumTextLength( ) | Gets the maximum length of the text |
| | | field. |
| | GetText( ) | Gets the text field. |
| | SetText( ) | Sets the text field. |
| | GetMaximumSecondTextLength( ) | Gets the maximum length of the |
| | | second text field. |
| | GetSecondText( ) | Gets the second text field. |
| | SetSecondText( ) | Sets the second text field. |
| | GetNumber( ) | Gets the phone number. |
| | SetNumber( ) | Sets the phone number. |
| | GetAdditionalNumber( ) | Gets the additional number. |
| | SetAdditionalNumber( ) | Sets the additional number. |
| | GetMaximumEmailAddressLength( ) | Gets the maximum length of the email |
| | | address field. |
| | GetEmailAddress( ) | Gets the email address. |
| | SetEmailAddress( ) | Sets the email address. |
| | GetHidden( ) | Gets whether the phonebook entry is |
| | | hidden or not. |
| | SetHidden( ) | Sets whether the phonebook entry is |
| | | hidden or not. |
| | Delete( ) | Deletes the entry from the phonebook. |
| | Update( ) | Update the entry in the phonebook. |
| | | This may result in a request to the |
| | | SIM. |
| | IsOwnNumber( ) | Returns whether the number is an own |
| | | phonebook entry or not. |
| IOwnNumberPhonebookEntry | GetDataBearerServiceSpeed( ) | Gets the data bearser service speed |
| | | that may be associated with an own |
| | | number. |
| | GetService( ) | Gets the service associated with the |
| | | own number. |
| | GetInformationTransferCapability( ) | Gets the information transfer |
| | | capability of the own number. |

Device/Radio API

The Device/Radio API is not explicitly shown in FIGS. 1 and 2. This API will be specific to the underlying Device/Radio Hardware 103 and may require custom modifications specific to the Device/radio equipment, and therefore can be associated with the Custom Plug-in 128 or may be merged with the TelDevice API 126. As provided, the Device/Radio API provides generic radio interfaces which allows client applications to, e.g.:
control the power state of the radio;
adjust the audio sample gains;
determine if the radio subsystem has an independent clock and to get/set the time of this clock.

The Device/Radio API is summarized in FIG. 22. The interfaces and methods associated with the Device/Radio API are summarized in Table 3-18. The events associated with the Radio API are summarized above in Table 3-4.

TABLE 3-18
Radio API Overview

| Interface | Method | Description |
|---|---|---|
| IRadio | GetPowerState( ) | Gets the power state of the |
| | | radio subsystem. |
| | SetPowerState( ) | Sets the power state of the |
| | | radio subsystem. |
| | GetTxAudioGain( ) | Gets the transmit audio |
| | | gain. |
| | SetTxAudioGain( ) | Sets the transmit audio |
| | | gain. |
| | GetRxAudioGain( ) | Gets the receive audio gain. |
| | SetRxAudioGain( ) | Sets the receive audio gain. |
| IRadioSubsystemTime | GetTime( ) | Gets the time of the |
| | | independent clock in the |
| | | radio subsystem. |
| | SetTime( ) | Sets the time of the |
| | | independent clock in the |
| | | radio subsystem. |

SIM API

Referring to FIGS. 1 and 2, the SIM API 124 is a component of the SIM 124, which allows client applications to, e.g.:
read and update specific fields on the SIM;
send SIM commands;
manage UICC sessions; and
manage EAP sessions.

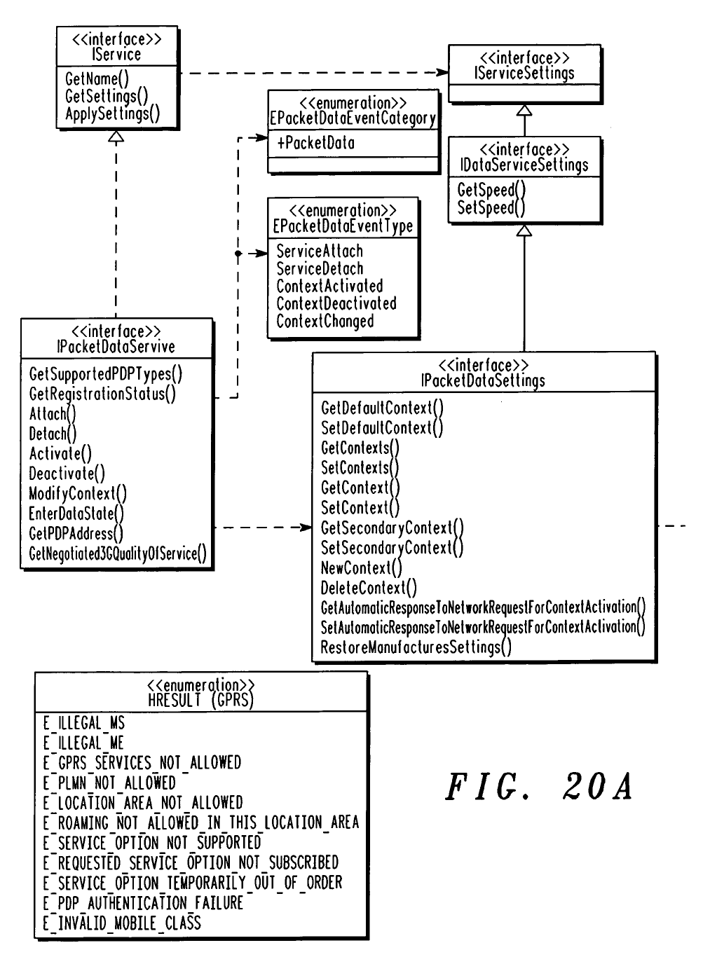

UICC and EAP sessions are protocols used to provide secure communication paths to applications on the SIM. The SIM API is summarized in FIG. 29. The interfaces and their methods are summarized in Table 3-19. The events associated with the SIM API are summarized in Table 3-4.

TABLE 3-19
SIM API Overview

| Interface | Method | Description |
|---|---|---|
| ISIM | GetSIMType( ) | Gets the SIM type: SIM or USIM. |
| | GetLanguangePreference( ) | Gets the language preference from the SIM. |
| | SetLanguagePreference( ) | Writes the language preference to the SIM. |
| | GetIMSI( ) | Gets the IMSI from the SIM. |
| | GetUICCApplications( ) | Gets the list of UICC applications. |
| ISIMCommand | SendCommand( ) | Sends raw SIM commands. The application |
| | | using this is fully responsible for all interactions |
| | | with the SIM. |
| | SendRestrictedCommand( ) | This command permits easier but more limited |
| | | access to the SIM. Interface locking and file |
| | | selection are handled by Telephony. |
| IUICCSession | OpenUICCLogicalChannel( ) | Opens a UICC logical channel. |
| | SendUICCLogcialCommand( ) | Sends a UICC logical channel command. |
| | SendRestrictedUICCLogicalCommand( ) | Sends a restricted UICC logical channel |
| | | command. Provides easier access than |
| | | SendUICCLogcialCommand. |
| | CloseUICCLogicalChannel( ) | Closes the channel. |
| IEAPSession | OpenEAPSession( ) | Opens an EAP session. |
| | GetEAPSessionParameters( ) | Gets the EAP session parameters. |

SMS/CBS API

Referring to FIG. 1, the SMS/CBS API is a component of SMS Services 108. As shown in FIG. 2, the SMS/CBS API 108 allows client applications to send and receive SMS messages and to receive cell broadcast (CBS) messages. The SMS/CBS API 108 uses extensively the SMS Utility API which is described in the description below.

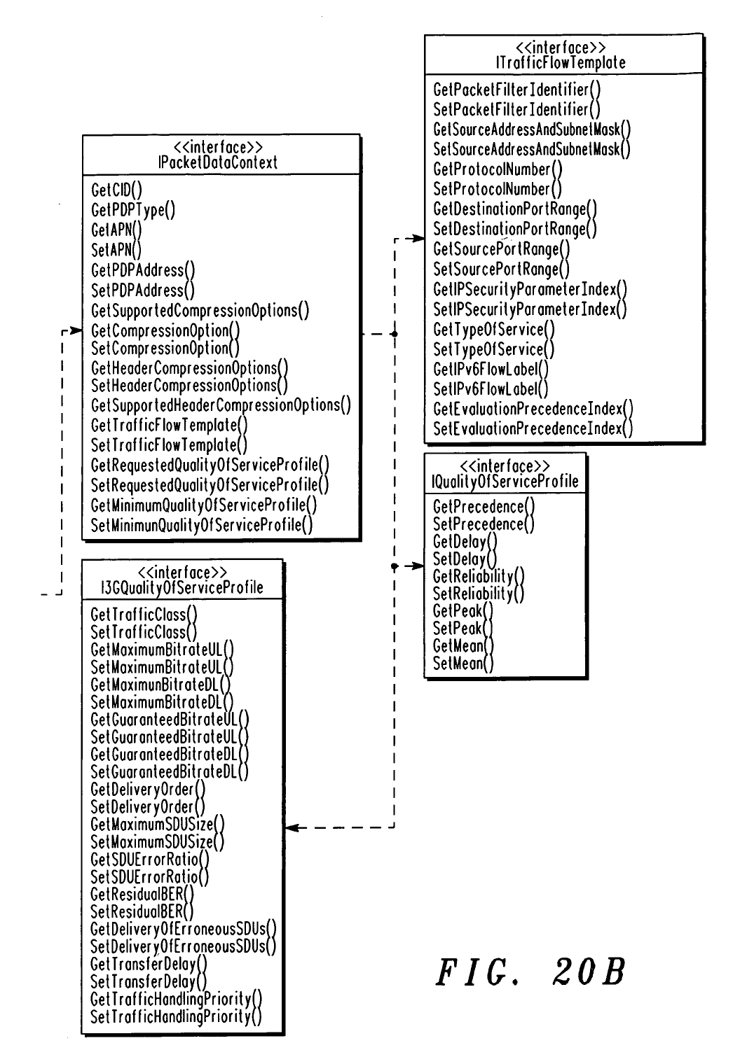

The SMS/CBS API is summarized in FIG. 30. The interfaces and their methods are summarized in Table 3-20. The events associated with the SMS/CBS API are summarized in Table 3-4.

TABLE 3-20
SMS/CBS API Overview

| Interface | Method | Description |
|---|---|---|
| ISMSService | GetServiceCapabilities( ) | Gets the capabilities of the |
| | | message service supported by |
| | | the device. |
| | GetAvailableMessageStores( ) | Enumerates through the |
| | | available message stores on |
| | | the device. |
| | GetMessageStore( ) | Gets the specified message |
| | | store. |
| | SendMessage( ) | Sends an SMS Submit |
| | | message to the network. |
| | SendCommand( ) | Sends an SMS Command to |
| | | the network. |
| | AcknowledgeMessage( ) | Acknowledges receive of a |
| | | message. This should only be |
| | | invoked when the message has |
| | | been successfully stored by |
| | | messaging. |
| | RestoreManufacterersSettings( ) | Restores the manufacturer's |
| | | settings. |
| ISMSServiceSettings | GetDefaultServiceCentreAddress( ) | Gets the service centre |
| | | address. |
| | SetDefaultServiceCentreAddress( ) | Sets the service centre address. |
| | GetPreferredStoreForSent( ) | Gets the preferred message |
| | | store for sent messages. |
| | SetPreferredStoreForSent( ) | Sets the preferred message |
| | | store for sent messages. |
| | GetPreferredStoreForReceived( ) | Gets the preferred message |
| | | store for received messages. |
| | SetPreferredStoreForReceived( ) | Sets the preferred message |
| | | store for received messages. |
| | GetCBSMessageTypesToReceive( ) | Gets the cell broadcast |
| | | message types to receive. |
| | SetCBSMessageTypesToReceive( ) | Sets the cell broadcast |
| | | message types to receive. |
| ISMSMessageStore | GetStoreType | Get the type of this store. |
| | GetNumberOfMessages( ) | Gets the number of messages |
| | | in the message store. |
| | GetTotalNumberOfStorageLocations( ) | Gets the total number of |
| | | storage locations in the |
| | | message store. |
| | ListMessages( ) | Enumerates through the |
| | | messages in the message store. |
| | ReadMessage( ) | Gets a specific message in the |
| | | message store. |
| | WriteMessage( ) | Updates a message in the |
| | | message store. |
| | DeleteMessage( ) | Deletes a message in the |
| | | message store. |
| | DeleteMessages( ) | Deletes multiple messages in |
| | | the message store. |
| ISMSStoredPDUEnumerator | Current | Retrieves the current |
| | | SMSStoredPDU from the |
| | | collection. |
| | GetNext | Retrieve the next |
| | | SMSStoredPDU from the |
| | | collection. |
| ISMSMessageStoreEnumerator | Current | Retrieves the current |
| | | SMSMessageStore from the |
| | | collection. |
| | GetNext | Retrieves the next |
| | | SMSMessageStore from the |
| | | collection. |

Service APIs

Referring to FIG. 1, many of the telephony services implemented by the TIC 100 are provided by the component Supplementary Services 118. As such, Supplementary Services 118 has several APIs which are exposed via the Telephony Client 102. In general, these interfaces, like all those of the Telephony Client, employ a common architecture or design pattern consisting of a service interface and a settings interface.

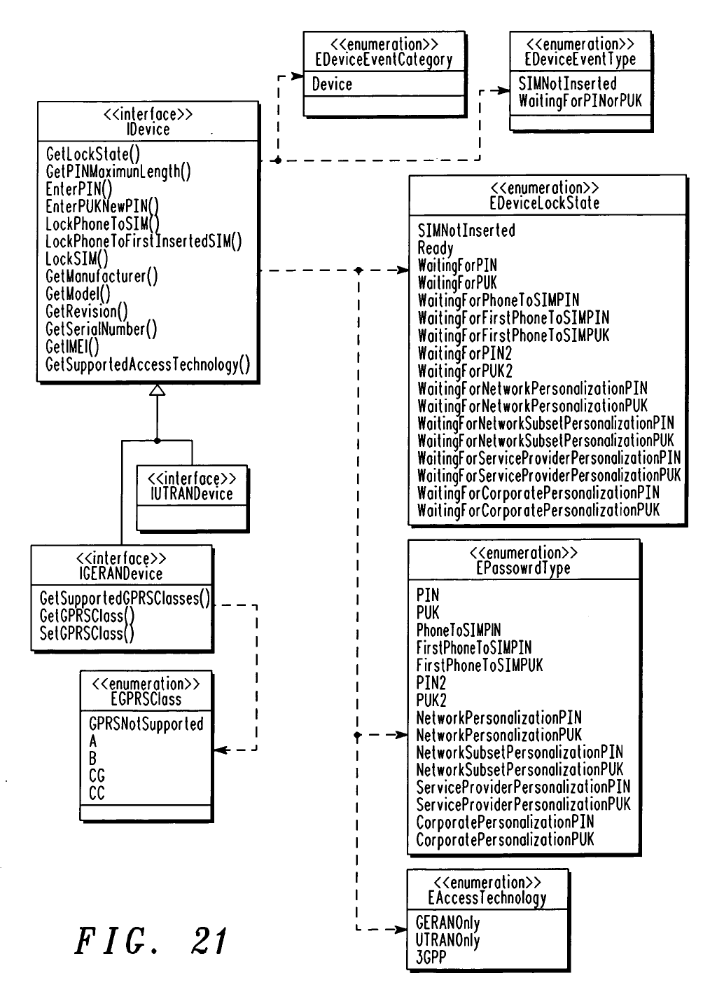

More specifically, the settings interface is an interface to a dumb data container that represents all the settings for the service. The methods in the settings interface are simple “getters” and “setters”. Generally the client applications can get a settings object, manipulate it as much as they want, and then apply the settings all at once. In contrast, the service interface provides direct, real-time control over the service. The service interfaces are summarized in FIG. 31.

As shown (Table 3-21 and FIG. 31), all services inherit from IService and all setting interfaces inherit from IServiceSettings. IServiceSettings has no methods; it is simply used to pass any settings object of any type through IService. IService is summarized in Table 3-21. Various Service APIs which are contained within Supplementary Services 118, are described in the following sections.

TABLE 3-21
IService Interface

| Interface | Method | Description |
|---|---|---|
| IService | GetName( ) | Gets the name of the service. |
| | GetSettings( ) | Gets the settings for the service. |
| | ApplySettings( ) | Sets the settings for the service. |

Advice of Charge API

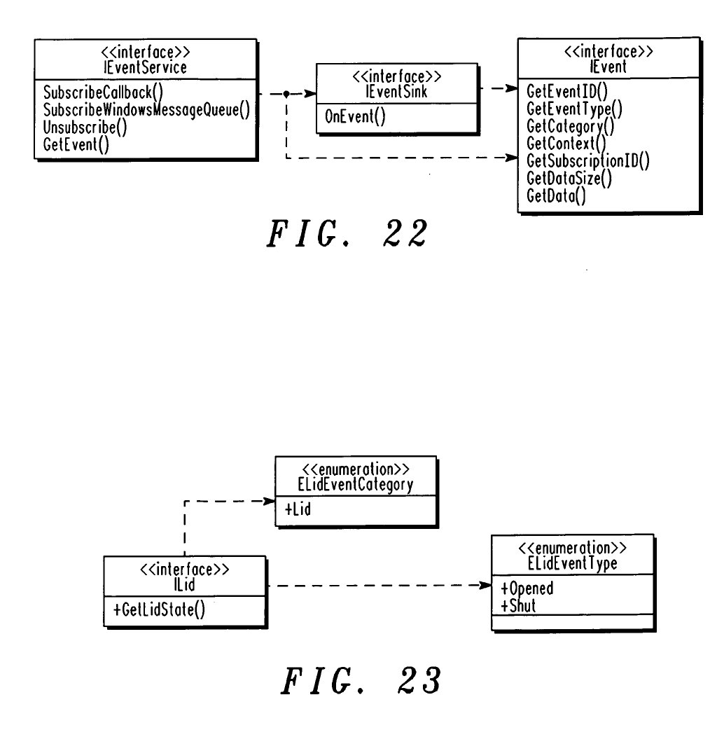

A component of Supplementary Services 118, the Advice of Charge API allows client applications to control the advice of charge service. The Advice of Charge API is summarized in FIG. 32. The interfaces and their methods are summarized in Table 3-22. The events associated with the Advice of Charge API are summarized in Table 3-4.

TABLE 3-22
Advice of Charge API Overview

| Interface | Method | Description |
|---|---|---|
| IAdviceOfChargeService | GetAccumulatedCallMeter( ) | Gets the current accumulated |
| | | call meter. |
| | ResetAccumulatedCallMeter( ) | Resets the call meter. |
| IAdviceOfChargeSettings | GetAccumulatedChargeMaximum( ) | Gets the ACM maximum. |
| | SetAccumulatedChargeMaximum( ) | Sets the ACM maximum |
| | | (setting to 0 to disables) |
| | GetCurrencyAndPricePerUnit( ) | Gets the currency - (free form |
| | | text) and price per unit |
| | SetCurrencyAndPricePerUnit( ) | Sets the currency - (free form |
| | | text) and price per unit. |

Call Deflection API

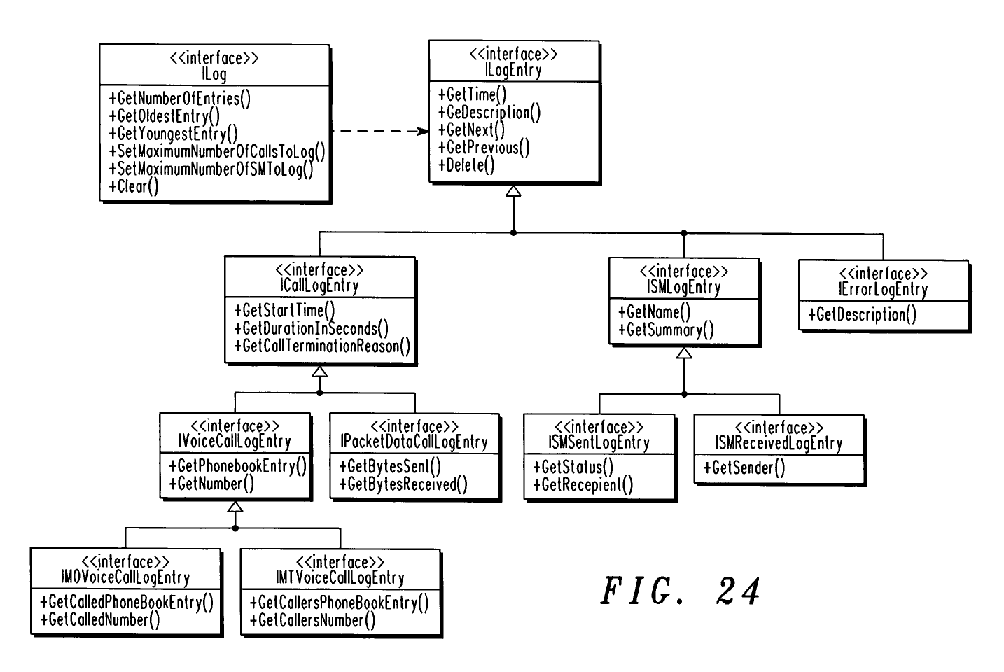

A component of Supplementary Services 118, the Call Deflection API allows client applications to control the call deflection service. While the settings could be readily extended, the present settings include enabled/disabled. The Call Deflection API is summarized in FIG. 33. The interfaces and their methods are summarized in Table 3-23. The events associated with the Call Deflection API are summarized in Table 3-4.

TABLE 3-23
Call Deflection API Overview

| Interface | Method | Description |
|---|---|---|
| ICallDeflectionService | N/a. | N/a. |
| ICallDeflectionSettings | GetEnabled( ) | Gets whether the |
| | | service is enabled. |
| | Enable( ) | Enables the service. |
| | Disable( ) | Disables the service. |

Call Forwarding

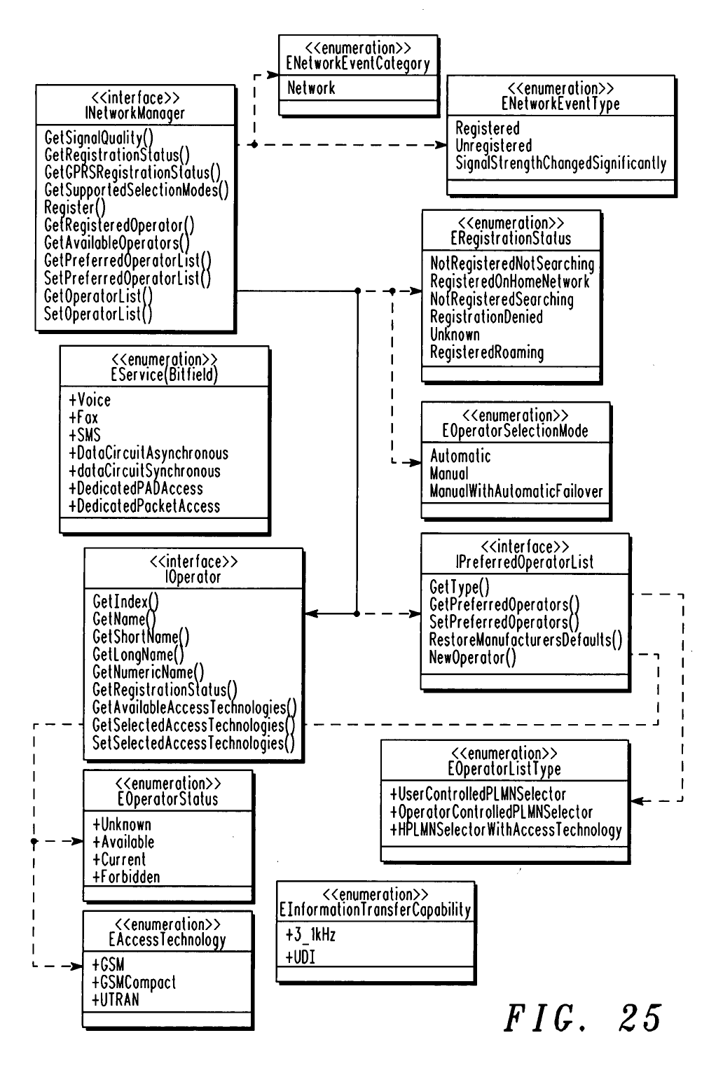

A component of Supplementary Services 118, the Call Forwarding API allows client applications to control the call forwarding service. The Call Forwarding API is summarized in FIG. 34. The interfaces and their methods are summarized in Table 3-24. The events associated with the Call Forwarding API are summarized in Table 3-4.

TABLE 3-24
Call Forwarding API Overview

| Interface | Method | Description |
|---|---|---|
| ICallForwardingService | N/a. | N/a. |
| ICallForwardSettings | Register( ) | Register with the network for call the call |
| | | forwarding service. |
| | GetSupportedReasons( ) | Get the supported reasons for call forwarding. |
| | GetSetting( ) | Get the settings for the specified information |
| | | class. |
| | SetSetting( ) | Set the settings for the specified information |
| | | class. |
| | GetSettings( ) | Get all the class settings. |
| | SetSettings( ) | Set all the class settings. |
| ICallForwardSettingsForInformationClass | GetClass( ) | Gets the information class for the settings. |
| | SetClass( ) | Sets the information class for the settings. |
| | GetReason( ) | Gets the reason for calls to be forwarded. |
| | SetReason( ) | Sets the reason for calls to be forwarded. |
| | GetNumber( ) | Gets the number to which calls are to be |
| | | forwarded. |
| | SetNumber( ) | Sets the number to which calls are to be |
| | | forwarded. |
| | GetTimeInSecondsBeforeCallIsForwarded( ) | Gets the time in seconds before the call is to be |
| | | forwarded. |
| | SetTimeInSecondsBeforeCallIsForwarded( ) | Sets the time in seconds before the call is to be |
| | | forwarded. |
| | GetEnabled( ) | Gets whether the settings for the information class |
| | | are enabled or disabled. |
| | Enable( ) | Enables call forwarding for the information class. |
| | Disable( ) | Disables call forwarding for the information class. |

Call Waiting

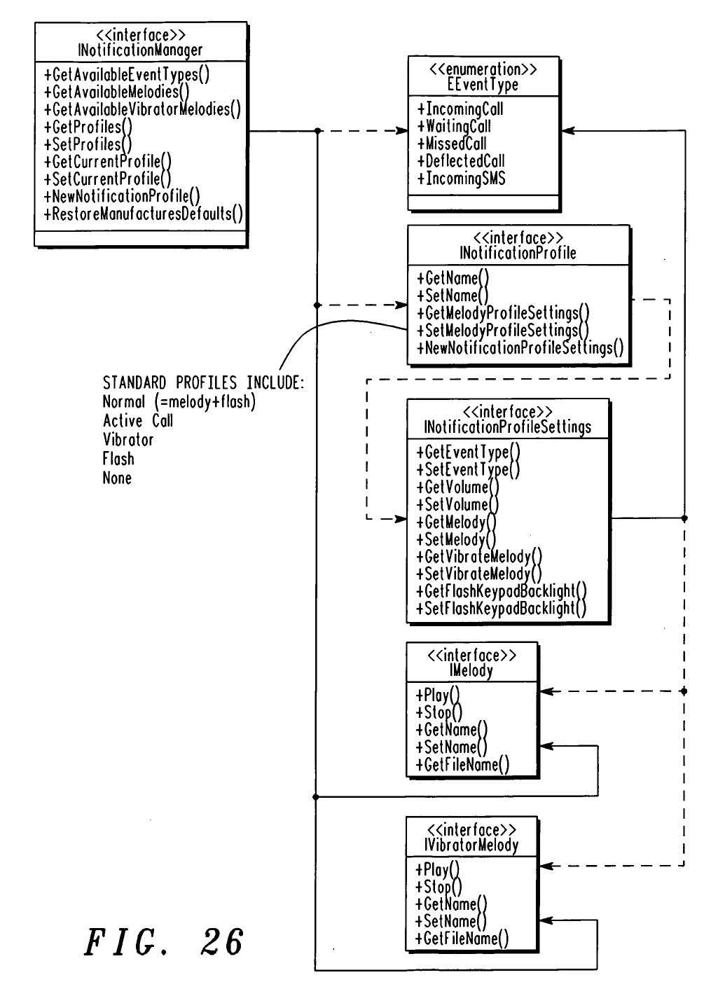

A component of Supplementary Services 118, the Call Waiting API allows a client applications to control (configure and query) the call waiting service. The Call Waiting API is summarized in FIG. 35. The interfaces and their methods are summarized in Table 3-25. The events associated with the Call Waiting API are summarized in Table 3-4.

TABLE 3-25
Call Waiting API Overview

| Interface | Method | Description |
|---|---|---|
| ICallWaitingService | N/a. | N/a. |
| ICallWaitingSetttings | GetSetting( ) | Gets the settings for the specified class. |
| | SetSetting( ) | Sets the settings for the specified class. |
| | GetSettings( ) | Gets all the settings. |
| | SetSettings( ) | Sets all the settings. |
| ICallWaitingSettingsForClass | GetClass( ) | Gets the information class. |
| | SetClass( ) | Sets the information class. |
| | GetEnabled( ) | Returns whether call waiting is enabled for the |
| | | class. |
| | Enable( ) | Enables call waiting for the class. |
| | Disable( ) | Disables call waiting for the class. |

### Closed User Group API

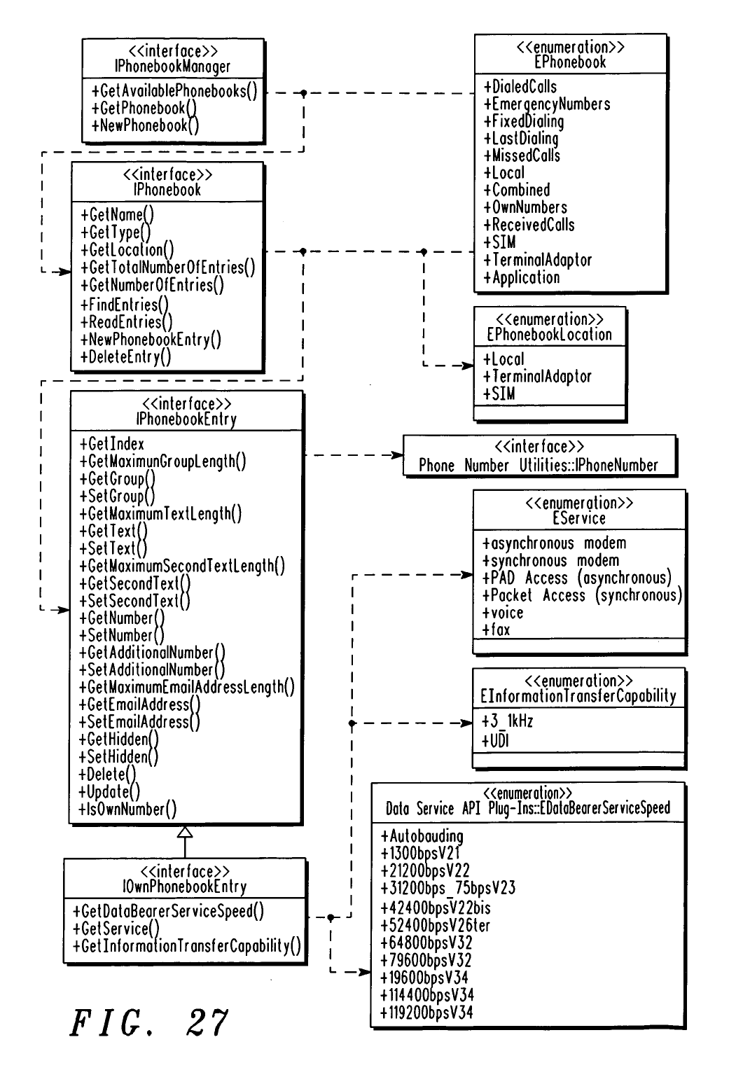

A component of Supplementary Services 118, the Closed User Group API allows client applications to control the closed user group service. The Closed User Group API is summarized in FIG. 36. The interfaces and their methods are summarized in Table 3-26. The events associated with the Closed User Group API are summarized in Table 3-4.

TABLE 3-26
Closed User Group API Overview

| Interface | Method | Description |
|---|---|---|
| IClosedUserGroupSerivce | N/a. | N/a. |
| IClosedUserGroupSettings | GetPreferredClosedUserGroup( ) | Gets the preferred closed user group. |
| | SetPreferredClosedUserGroup( ) | Sets the preferred closed user group. |
| | GetInfoClosedUserGroup( ) | Gets the information setting for the closed |
| | | user group. |
| | SetInfoClosedUserGroup( ) | Sets the information setting for the closed |
| | | user group. |
| | GetEnabled( ) | Returns whether the closed user group |
| | | service is enabled. |
| | Enable( ) | Enables the closed user group service. |
| | Disable( ) | Disables the closed user group service. |

Connected Line ID API

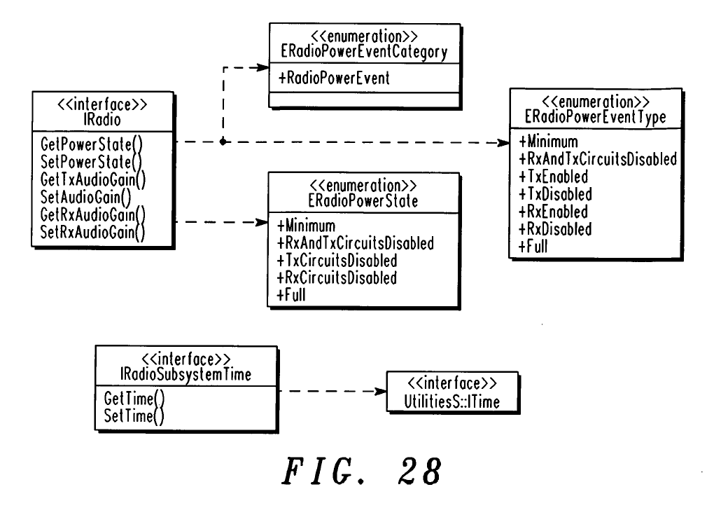

A component of Supplementary Services 118, the Connected Line ID API allows client applications to control the connected line ID service. The Connected Line ID API is summarized in FIG. 37. The interfaces and their methods are summarized in Table 3-27. The events associated with the Connected Line ID API are summarized in Table 3-4.

TABLE 3-27
Connected Line ID API Overview

| Interface | Method | Description |
|---|---|---|
| IConnectedLineIDService | N/a. | N/a. |
| IConnectedLineIDServiceSettings | GetEnabled( ) | Returns whether the connected line ID |
| | | service is enabled. |
| | Enable( ) | Enables the connected line ID service. |
| | Disable( ) | Disables the connected line ID service. |

Facilities API

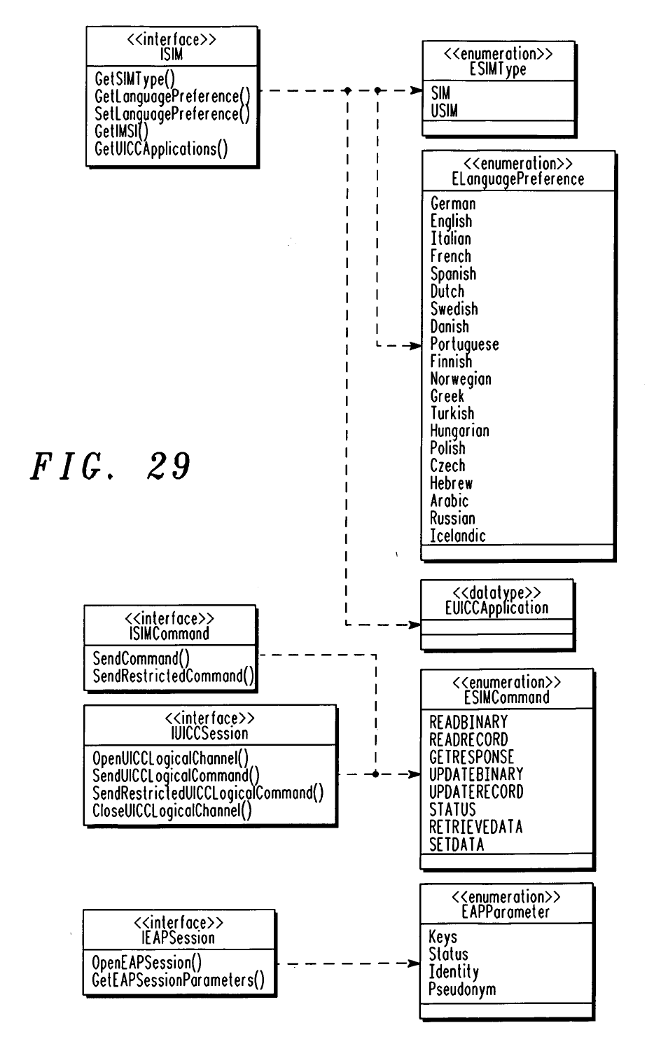

A component of Supplementary Services 118, the Facilities API allows clients (applications) to control various facilities, including call barring, fixed number dialing, and network and corporate personalization. The Facilities API is summarized in FIG. 38. The interfaces and their methods are summarized in Table 3-28. The events associated with the Facilities API are summarized in Table 3-4.

TABLE 3-28
Facilities API Overview

| Interface | Method | Description |
|---|---|---|
| IFacilities | N/a. | N/a. |
| IFacilitySettings | GetClasses( ) | Gets the available |
| | | facility classes. |
| | GetSettingsForClass( ) | Gets the settings |
| | | for the specified |
| | | class. |
| | SetSettingsForClass( ) | Sets the settings |
| | | for the specified |
| | | class. |
| | GetSettingsForClasses( ) | Gets the settings |
| | | for all classes. |
| | SetSettingsForClasses( ) | Sets the settings |
| | | for all classes. |
| IFacilitySettingsForClass | GetClass( ) | Gets the class |
| | | for the setting. |
| | GetMode( ) | Gets the mode: |
| | | active/not active. |
| | SetMode( ) | Sets the mode. |
| | GetStatus( ) | Gets the lock status: |
| | | locked/unlocked. |
| | SetStatus( ) | Sets the lock status. |

Incoming Caller ID API

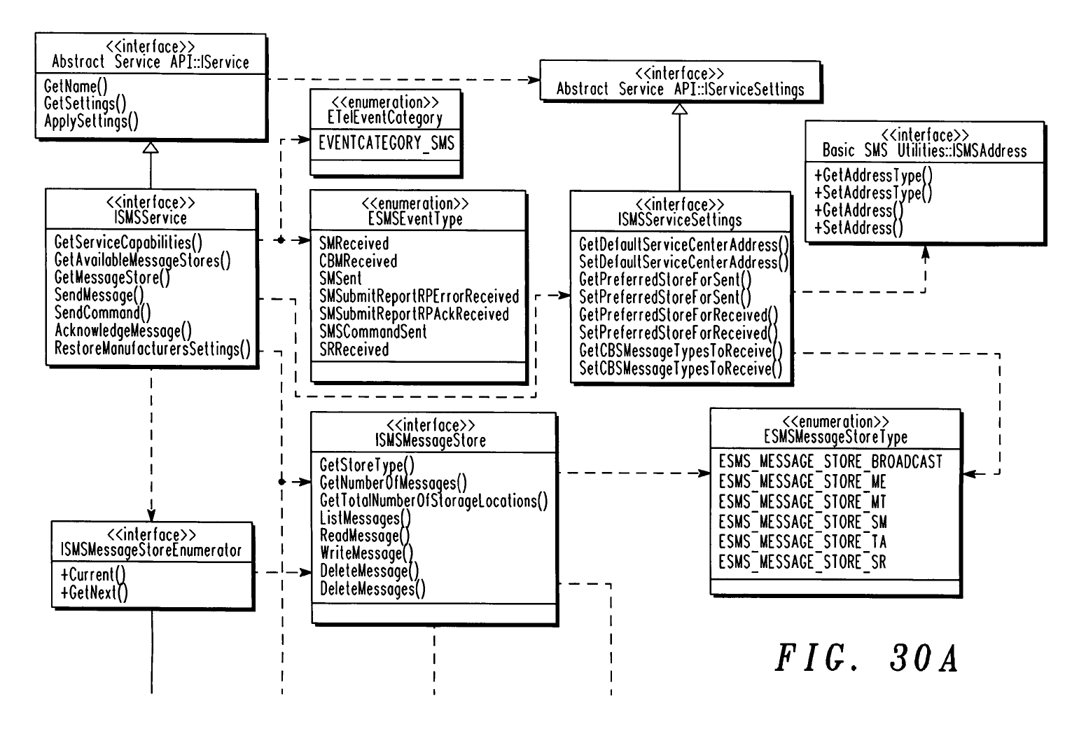

A component of Supplementary Services 118, the Incoming Caller ID API allows clients (applications) to control the calling line identification service. The Incoming Caller ID API is summarized in FIG. 39. The interfaces and their methods are summarized in Table 3-29. The events associated with the Incoming Caller ID API are summarized in Table 3-4.

TABLE 3-29
Incoming Caller ID API Overview

| Interface | Method | Description |
|---|---|---|
| IIncomingCallerIDService | GetStatus( ) | Gets the statue |
| | | of the service |
| | | in the network. |
| IIncomingCallerIDServiceSettings | GetEnabledStatus( ) | Gets the status |
| | | of the service. |
| | Enable( ) | Enables the |
| | | service. |
| | Disable( ) | Disables the |
| | | service. |

Outgoing Caller ID API

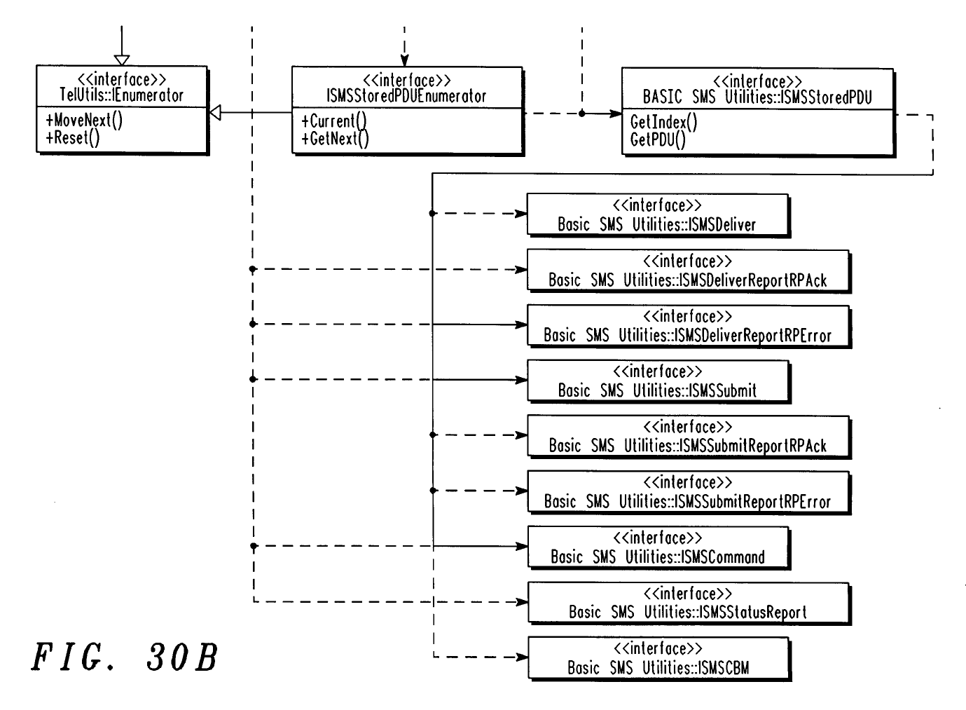

A component of Supplementary Services 118, the Outgoing Caller ID API allows client applications to restrict outgoing calling line presentation to the called party. The Outgoing Caller ID API is summarized in FIG. 40. The interfaces and their methods are summarized in Table 3-30. The events associated with the Outgoing Caller ID API are summarized in Table 3-4.

TABLE 3-30
Outgoing Caller ID API Overview

| Interface | Method | Description |
|---|---|---|
| IOutgoingCallerIDRestrictionService | GetStatus( ) | Gets the |
| | | status of the |
| | | service in |
| | | the network. |
| IOutgoingCallerIDRestrictionSettings | GetEnabledStatus( ) | Gets the |
| | | status of the |
| | | service. |
| | Enable( ) | Enables |
| | | the service. |
| | Disable( ) | Disables |
| | | the service. |

USSD API

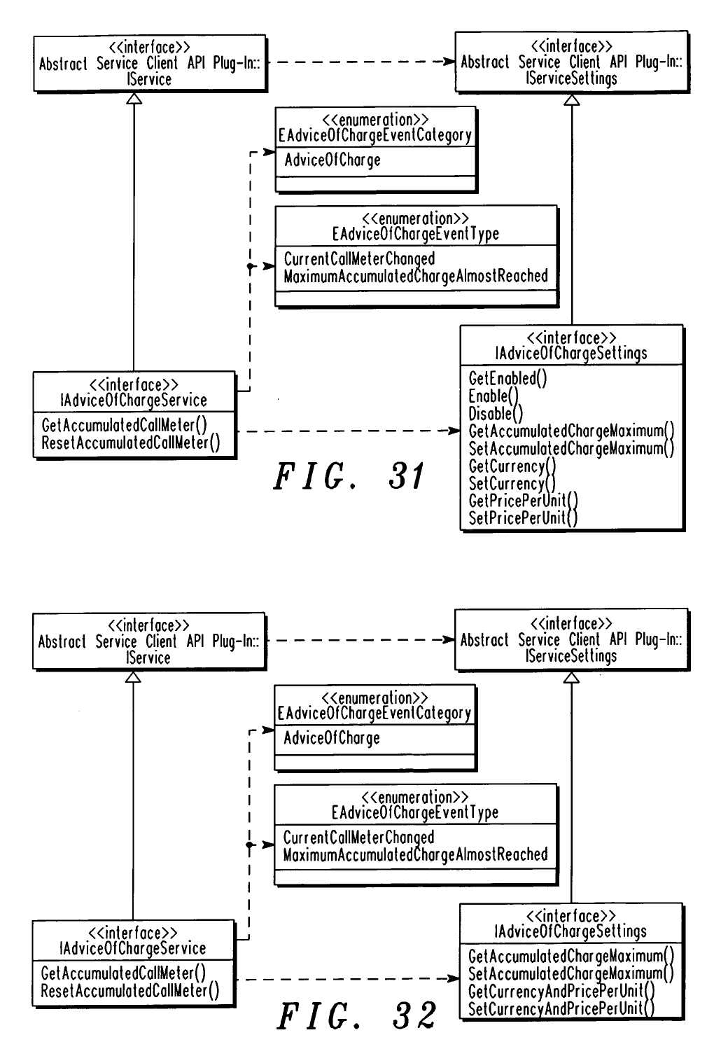

A component of Supplementary Services 118, the USSD API allows client applications to send and receive USSD strings. The USSD API uses the USSD Utility API further described in USSD Utility API. The USSD API is summarized in FIG. 41. The interfaces, methods and associated events are summarized in table 3-31.

TABLE 3-31
USSD API Overview

| Interface | Method | Description |
|---|---|---|
| IUSSDService | SendUSSDString( ) | Sends a USSD String. |
| | CancelSession( ) | Cancels the USSD session. |
| IUSSDSettings | GetEnabled( ) | Returns whether the service is |
| | | enabled. |
| | Enable( ) | Enables the service. |
| | Disable( ) | Disables the service. |

eMLPP API

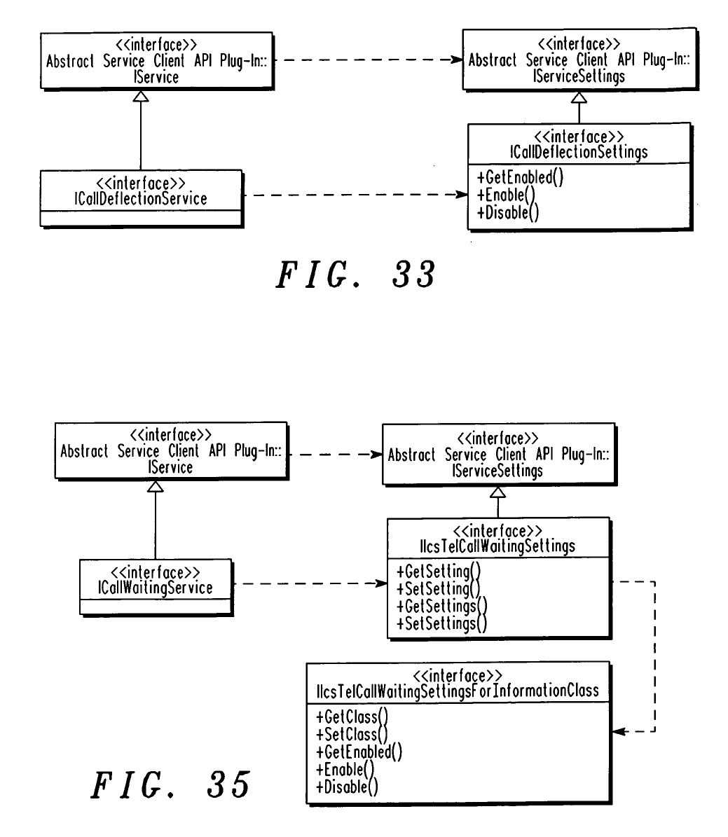

A component of Supplementary Services 118, the eMLPP API allows client applications to control the eMLPP service. The eMLPP API is summarized in FIG. 42. The interfaces and their methods are summarized in Table 3-32. The events associated with the eMLPP API are summarized in Table 3-4.

TABLE 3-32
eMLPP API Overview

| Interface | Method | Description |
|---|---|---|
| IeMLPPService | GetDefaultPriority( ) | Gets the default priority associated with |
| | | the service. |
| | GetMaximumPriority( ) | Gets the maximum priority. |
| | SetPriority( ) | Sets the priority for subsequent calls. |
| | GetSubscriptions( ) | Gets the subscriptions. |
| | SetSubscriptions( ) | Sets the subscriptions. |
| IeMLPPSubscription | GetPriority( ) | Gets the priority associated with the |
| | | subscription. |
| | SetPriority( ) | Sets the priority associated with the |
| | | subscription. |
| | GetFastCallSetupStatus( ) | Gets the fast call setup status. |
| | SetFastCallSetupStatus( ) | Sets the fast call setup status. |
| | GetAutomaticAnswerStatus( ) | Gets the automatic answer status. |
| | SetAutomaticAnswerStatus( ) | Sets the automatic answer status. |

Vibrator API

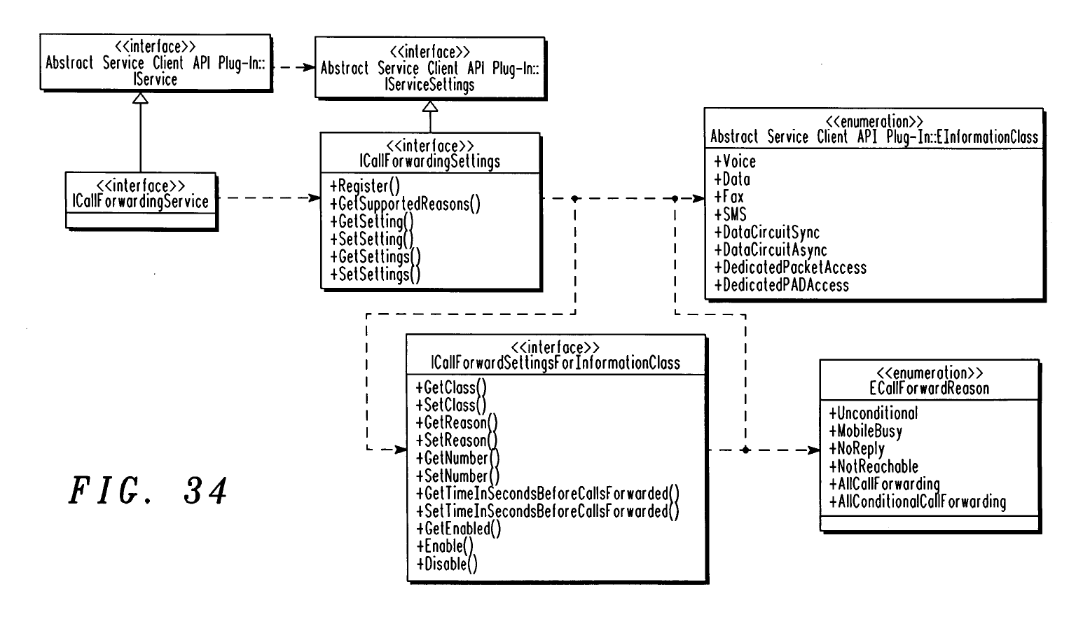

Although not explicitly shown in FIGS. 1 and 2, the Vibrator API allows client applications to control the vibrator, if any, on the device. The Vibrator API is summarized in FIG. 43. The interfaces and their methods are summarized in Table 3-33. The events associated with the Vibrator API are summarized in Table 3-4.

TABLE 3-33
Vibrator API Overview

| Interface | Method | Description |
|---|---|---|
| IVibrator | Vibrate( ) | Starts the vibrator. |
| | Stop( ) | Stops the vibrator. |

Utility APIs

To support the various TIC components disclosed in FIGS. 1 and 2, component level Utility APIs are provided. In particular, a Utility API associated with a specific component provides access to custom, component specific libraries and code as a simple and efficient means for a client application to easily and rapidly assess and deploy the required component specific telephony functionality. Component level Utility APIs are not explicitly shown on FIGS. 1 and 2, however there are such Utility APIs associated with many components. With reference to FIGS. 1 and 2, the Utility APIs are presented as follows.

Phone Number Utility API

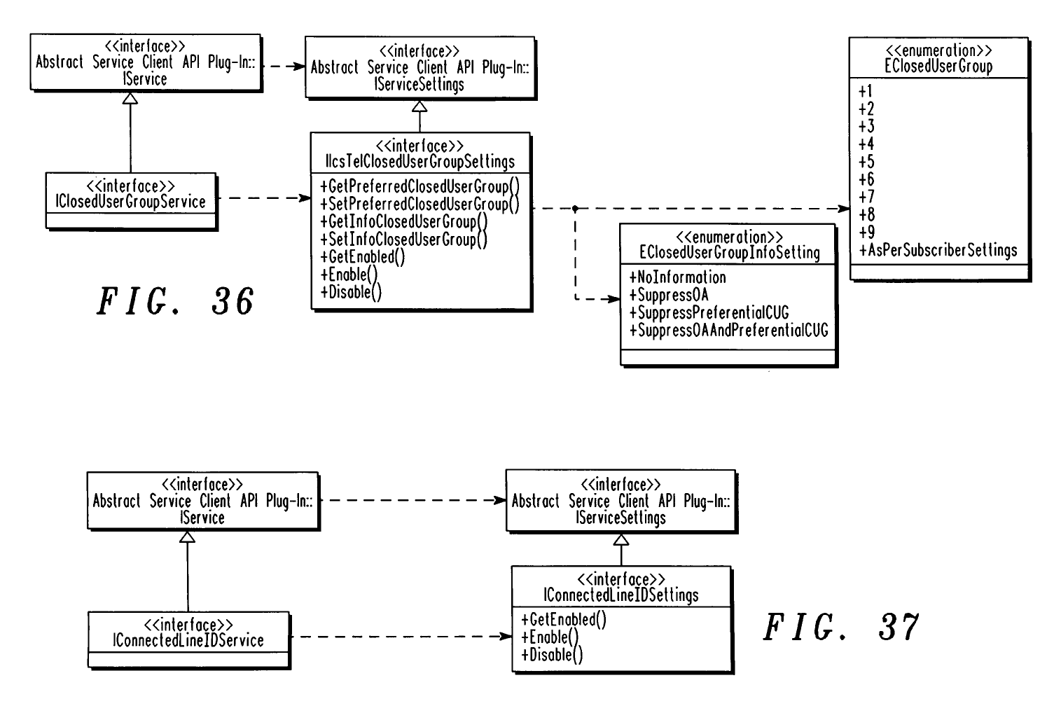

The Phone Number Utility API is a utility API that is not specifically shown in FIG. 1 or FIG. 2 but can be a component of Phonebook 118. The Phone Number Utility API allows client applications to manipulate phone numbers. Additionally it may support the parsing of supplementary service code strings. The Phone Number Utility API is summarized in FIG. 44. The interfaces and their methods are summarized in Table 3-34.

TABLE 3-34
Phone Number Utility API Overview

| Interface | Method | Description |
|---|---|---|
| IPhoneNumber | GetNumber( ) | Gets the string. |
| | SetNumber( ) | Sets the string. |
| | IsEmergency( ) | Returns whether the |
| | | number is an emergency |
| | | number or not. |
| | GetEmergencyCategory( ) | Gets the emergency |
| | | category. |
| | SetEmergencyCategory( ) | Sets the emergency |
| | | category. |

SMS Utility API

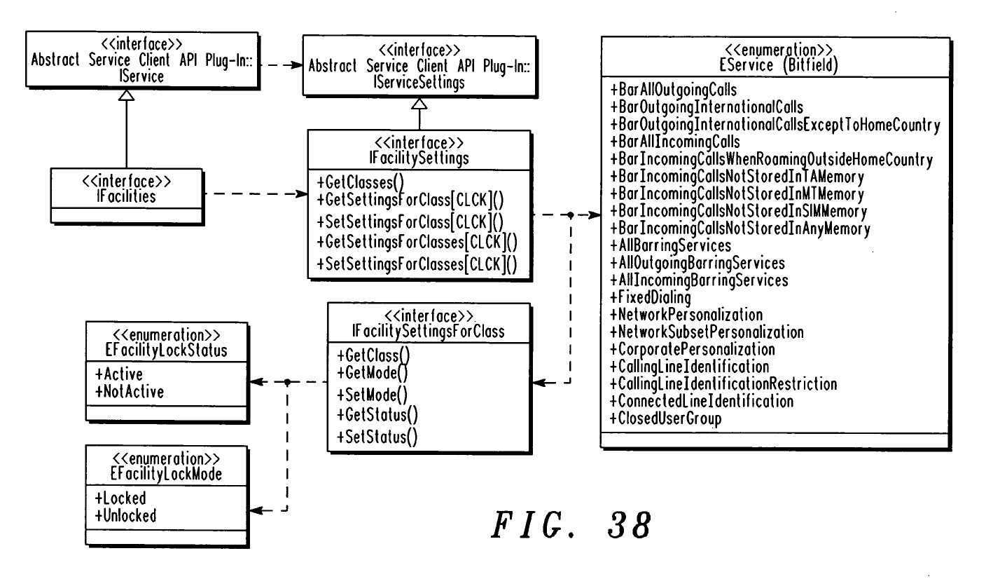

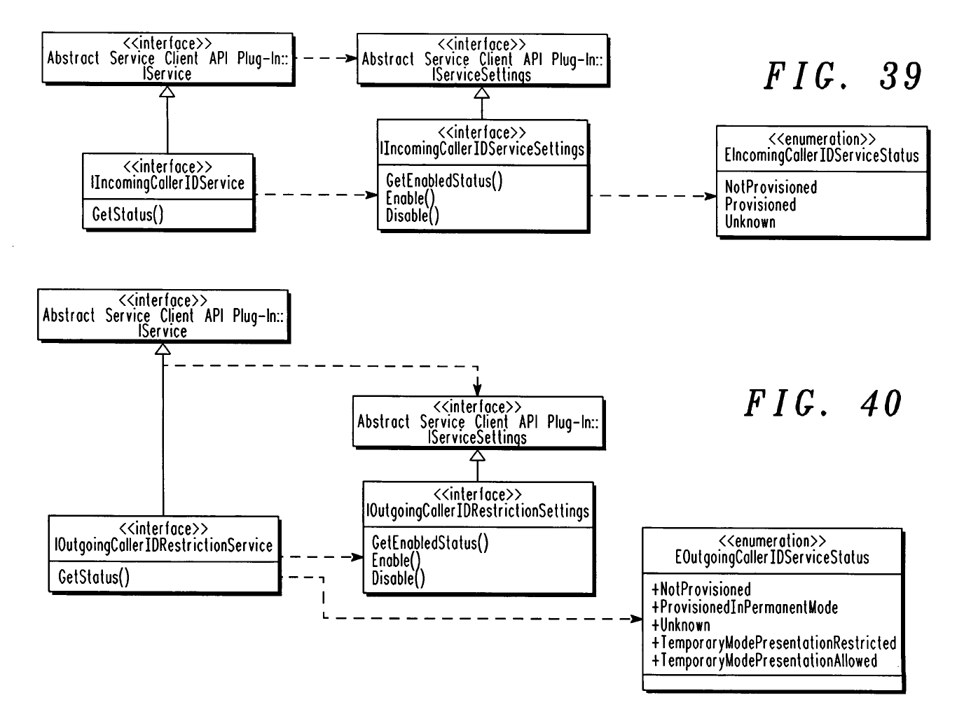

A component of the Short Message Services (SMS) 108, the SMS Utility API allows client applications to create SMs consisting of one or more segments (T-PDU); parse SMs consisting of one or more segments; and parse CBMs. The SMS Utility API is summarized in FIG. 45 and FIG. 46.

Two of the COM objects shown in FIG. 45 are of particular interest to concatenated short messages and EMS, namely Telephony.EnhancedMessage and Telephony.EnhancedMessageReassembler. The Telephony.EnhancedMessage is a container for multiple IPDU derived objects (e.g. ISMS-Submit, ISMS-Deliver, ISMS-Status-Report, etc.). Each of the PDU types support concatenation and EMS, although ISMS-Deliver and ISMS-Submit are the ones most commonly used. Note that Telephony.EnhancedMessage is suitable for working with both mobile originated (MO) SM (short message) and mobile terminated (MT) SM.

To insert content into an MO message, the GetEMSFormatter( ) method is used to retrieve an IEMSFormatter interface. This interface provides methods to insert the various EMS elements including simple text, formatted text, predefined sounds, user defined sounds, etc. As the various methods are called, the Telephony.EnhancedMessage object will create and concatenate additional T-PDUs as necessary.

For MT message support, methods are provided to support adding received T-PDUs, in any order. The Telephony.EnhancedMessage object will sort them appropriately and provides an API to check if all segments have been received.

In addition, the ParseEMS( ) method provides a mechanism to parse the EMS elements contained in the concatenated message. A callback interface (IEMSFormatter) is passed as a parameter to this method. For example, when ParseEMS( ) encounters a formatted text IE it will call the FormattedText method on the given interface pointer. This approach hides the complexity and nuances of EMS from the client application.

Telephony.EnhancedMessageReassembler is a utility object to assist in reassembling concatenated short messages. It accepts T-PDUs as input data, and returns completely reassembled Telephony.EnhancedMessage objects. An application that is a client of the SMS service can pass all received T-PDUs to the Telephony.EnhancedMessageReassembler. When a complete messages is reassembled (single PDU messages are “reassembled” immediately), they are returned as Telephony.EnhancedMessage objects.

USSD Utility API

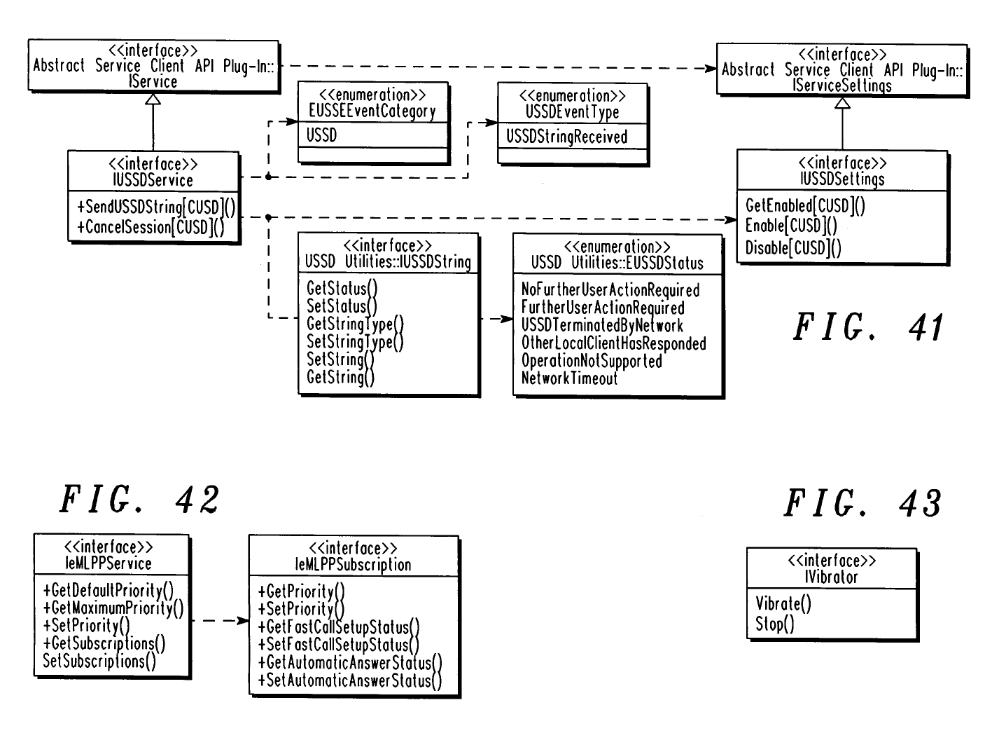

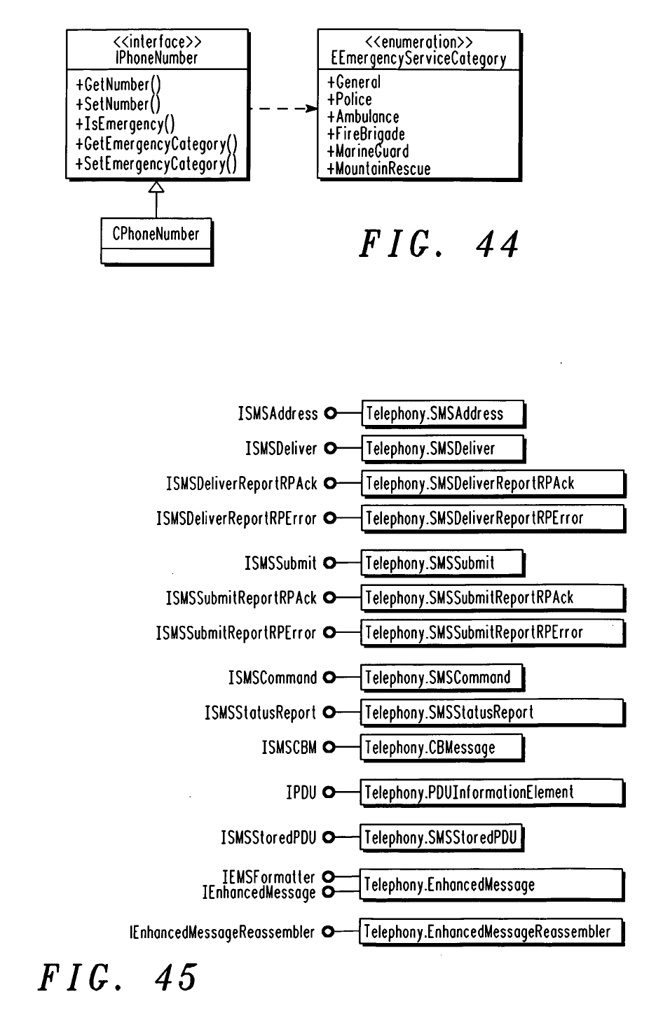

Not associated with a specific component of the TIC 100, the USSD Utility is a general, core utility that provides functionality to multiple components. The USSD Utility API allows client applications to parse USSD strings. The USSD Utility API is illustrated in FIG. 47, USSD utility COM objects, and FIG. 48, USSD utility API, with associated interfaces and methods summarized in Table 3-35.

TABLE 3-35
USSD Utility API Overview

| Interface | Method | Description |
|---|---|---|
| IUSSDString | GetStatus( ) | Gets the status associated with the |
| | | string. |
| IUSSDString | SetStatus( ) | Sets the status. |
| | GetStringType( ) | Gets the string type. |
| | SetStringType( ) | Sets the string type. |
| | GetString( ) | Gets the string |
| | SetString( ) | Sets the string. |

Phone Abstraction Layer

Device (Phone) Independence

The purpose of the DAL (PAL) 140 is to implement service functionality including telephony service functionality in a device (phone) independent manner. Customization for specific phone devices can be provided through the Device (Phone) Driver Module (DDM (PDM)) 160 and a Unit Abstraction Layer (shown as Custom Plug-ins 128). Porting to new device or phone hardware involves customizing the DDM/PDM (hereafter referred to as PDM) and UAL, but normally does not require changes to DAL/PAL components (hereafter referred to as PAL).

Telephony Service

Referring to FIG. 2, the set of telephony services 199 and functionality is provided by the TIC 100. The Telephony Services 199 include services and functionality provided by both the PAL 140 and PDM 160. When deployed within the context of the Windows CE OS, Telephony Services 199 are provided via the PAL 140 which runs as a WinCE service that exposes an IOCTL-based interface (i.e. via IPC Mechanisms 141). This provides a defined interface to enable invocation of the Telephony Service 199 by multiple clients running in different processes.

The Event Service paradigm is used to provide Telephony Services 199 using three classes of event: Request (e.g. PDM Dial Request); Result (e.g. PDM Dial Result); and Unsolicited event (e.g. New Unanswered Call). Telephony Service is provided via the PAL 140 and PDM 160 layers. Events are queued and there is a single dispatch thread for each Event Service. No blocking is allowed in the PAL and PDM plug-in call backs are executed in context of Event Service dispatch threads. Plug-ins are all loosely coupled via the Event Service and only interact via the events/requests/results they exchange throughout the Event Service. Plug-ins do not interact directly via functions calls, and a particular plug-in generally has no knowledge that another plug-in component is responding to a request or generating a response to an event. As any plug-in can be replaced or interchanged, the event service mechanism is designed to be transparent to all components without compromising telephony services.

More specifically, the PAL 140 is required to support multiple simultaneous clients (i.e. Telephony Clients 102, and/or TSP 145). All input requests to the PAL are queued and handled asynchronously via the PAL Event Services 142. The PAL uses this subscription based event service to dispatch the request to the appropriate PAL plug-in for handling. The use of a single queue and dispatch thread simplifies multi-threaded access issues. To minimize delays, the PAL handles all functionality that takes a significant amount of time (e.g. calls that require radio equipment interaction) asynchronously. Control is returned to the dispatcher thread as soon as the request to the radio equipment (i.e. Radio Hardware 103) has been queued (via the MUX 195), and the client is subsequently notified when the result is available.

In the context of the Windows CE OS, the TIC 100 implements Telephony Service 199 using standard Windows stream I/F functions TSV_Init, TSV-Open, TSV_IoControl etc. On initialization, the TIC 100 creates a CPAL object. This object implements the interfaces that are used internally for initialization and communication with the PAL 140.

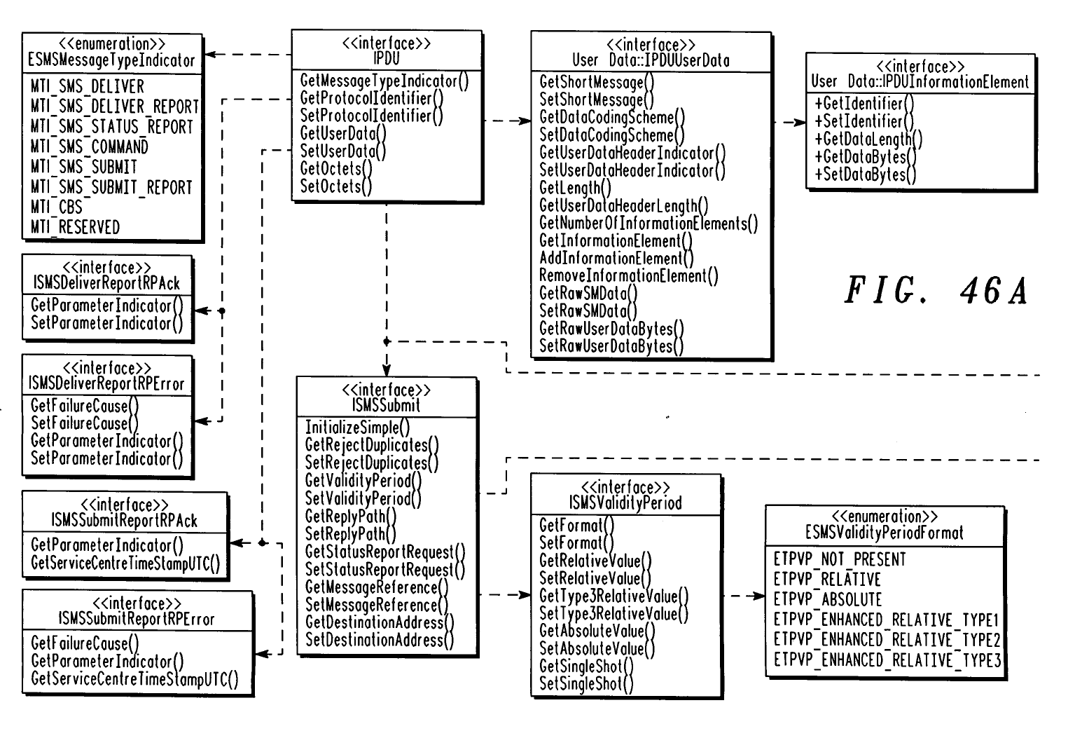

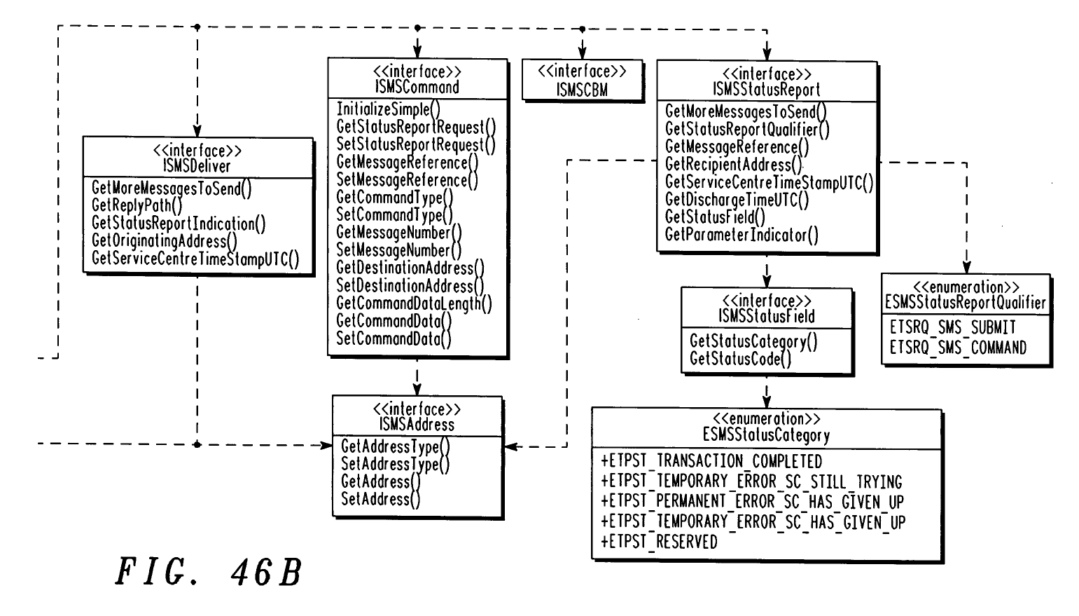

More specifically, and with reference to FIG. 49, Telephony Service Class Diagram; and FIG. 50, PAL class diagram, the initialization sequence is as follows. The TSV_Init function instantiates the CPAL object and invokes its IPAL::Initialize method and causes it to:
Instantiate the PAL Event Service (i.e. PAL Event Services 142)
Instantiate the object CPDM of the PCM 160, and invoke its IPDM::Initialize method. This causes the PDM to load the PDM plug-ins. It passes in a pointer to the IPALPDMInterface, which PDM plug-ins can then use to send command results and unsolicited events to the PAL.
Query configuration information in the Device Info Store (i.e. PAL-PDM Device Info Store 144) to look up the set of PAL plug-in classes to be loaded.
Instantiate each PAL plug-in (e.g. 150, 151, 152, 153, 154, 155, 156, 157, 158, 159, etc.) and initialize it, passing in a pointer to the IPDM interface that they can use to send requests to the PDM.
Invoke each plug-ins SubscribeToEventTypes method, passing in a pointer to the PAL Event Service (i.e. PAL Event Services 143) so that the plug-in can subscribe to the requests and unsolicited events that it handles.
Start the PAL Event Service 143 dispatcher.

The de-initialization sequence is as follows. TheTSV_Deinit function invokes the IPAL::Deinitialize method. This causes it to:
Stop the PAL Event Service dispatcher
Instruct each plug-in to clean-up (de-initialize), including unsubscribing
Unload each plug-in
Unload the PAL Event Service.

The processing of TSV_IoControl requests is as follows. If the control code is IOCTL_TEL_SUBCRIBE, it invokes the IPAL::Subscribe method which:
Creates a client subscription node which provides an implementation of the ITelEventSink::OnEvent method, contains a client event queue and also stores the Win32 event to be used for notification purposes.
Invokes the PAL ITelEventService::Subscribe method to subscribe to events on behalf of the client and store the returned subscription ID.
   If the control code is IOCTL_TEL_UNSUBCRIBE, it invokes the IPAL::Unsubscribe method, which:
Calls the PAL ITelEventService::Unsubscribe method to unsubscribe from event notification.

Removes the subscription node.

If the control code is IOCTL_TEL_SEND_REQUEST, it invokes the IPAL::SendRequest method, which:

Calls the PAL ITelEventService::PublishEvent method to submit the request for queuing and dispatch.

The Event Service subsequently invokes the subscription node's OnEvent method to notify it when an asynchronous result or unsolicited event occurs. The OnEvent method adds the result/event object to the client's event queue and sets the Win32 event.

If control code is IOCTL_TEL_GET_EVENT, it invokes the IPAL::GetEvent method, which:

Returns the next event from the client's event queue and resets the Win32 event if the queue is empty.

State Models

State machines and models are used to determine and control the behavior associated with various components and objects within the Telephony Interface Component 100. Whenever events occur, such as a call being connected or hung up, the state machine is used to determine what state transitions need to occur and what actions need to be taken on entry or exit from those states.

Rather than distributing it throughout the system, the logic for dealing with state behavior of the TIC 100 is centralized within PAL state models to make it easier to maintain and update (device or phone independent). The other components (i.e. the Telephony Client 102, PDM 160, TSP 145, etc.) are as stateless as possible.

Modeling state and particularly call state information is required in order to: validate telephony commands which are state dependent to ensure that valid commands are sent to the radio equipment; cache information about calls and call ID mappings; and to take appropriate action when events occur that cause the state to change.

Attempts to model all the states of a phone using a single non-hierarchical state model results in a complex model with a large number of permutations of states and transitions. Such an approach may make the resultant system difficult to understand and maintain. I.e., adding a new state or event might require updating the logic associated with all the existing states. Furthermore, a single phone model typically does not capture the concurrency associated with separate objects within the phone each having their own state—for example, the state of each of multiple concurrent calls, the SIM lock state and the radio equipment power state.

The state model utilized for the Telephony Interface Component 100 as disclosed herein, differs from typical phone state models in that separate state models are used for each object that exhibits concurrent state behavior. Furthermore, hierarchical super-state models are used which greatly simplifies the modeling as many events can be handled more generally at the super-state level. Advantageously, the state model is key to providing core services within the overall TIC system, and it is utilized by all or most system components that need to be aware of state. This single unified state model and associated state engine further facilitates the componentized nature of the disclosed telephony architecture.

Plug-ins

Overview

Extensibility and componentization of the TIC 100, is achieved via plug-ins. While the core phone plug-ins for call management, network management etc will always be required for basic phone operation, other plug-ins may be optionally configured to be included or excluded depending on a particular device or phone capabilities. Plug-ins are integral to the overall telephony architecture disclosed herein.

When implemented to execute on the Windows CE OS, plug-ins are COM components. Referring to FIG. 2, PAL plug-ins (i.e. shown as 150 through 159) are COM components that are required to implement the ITelIntPlugIn interface. They must also implement the ITelEventSink interface in order to receive notification of events, telephony requests messages and asynchronous results.

All plug-ins are loosely coupled via Event Services. That is to say, they interact via the event/results/requests which are exchanged through the Event Services mechanisms (142, 143, 161 and 170). Thus all inter-plug-in communication is via the aforementioned components, and plug-ins generally do not interact directly via function calls. At start-up, plug-ins subscribe to the categories and/or types of requests and unsolicited events that they wish to receive. Subscribing to an event category (i.e. Request; Result; Unsolicited) provides an efficient, convenient way in which to subscribe to all specific event types within a category. When a specific event category or type occurs, the Event Service invokes the method OnEvent callback to all event subscribers. When the result to a request is ready, the Event Services notifies all subscribers via the OnResult call back method of the original requestor. Thus, the Event Service subscription method ensures that data is propagated to all interested subscribing components simultaneously with minimal processing overhead.

Event Service asynchronous messaging mechanism is normally used for all interactions which involve the radio equipment, but for efficiency and programming ease, allow more direct, synchronous access to cached data via C++ or COM APIs. In general, PAL plug-ins handle requests that require radio equipment/network interaction by sending the corresponding PDM request type(s) to the PDM 160. Since direct access to the SIM is not advised, requests that involve querying/updating configuration information stored on the SIM, such as preferred operator lists and SIM phonebook entries, should also be sent to the PDM.

Plug-in Library

Not a specific component shown in FIGS. 1 and 2, the Plug-in Library is a library and the various Plug-in components, such as teldevice, network, power, call management and audio plug-ins components, etc which are, shown are selected and built into a Plug-in library. More specifically, the Plug-In Library thus provides an aggregate set of services and functionality as provided by various TIC components to provide generally accepted cellular phone behavior.

TelDevice Plug-in

The TelDevice plug-in 126 is responsible for implementing functionality associated with the device or radio device, such as querying for the radio equipment model, manufacturer, revision and functionality related to the radio power state, PIN lock state, and device operational mode. The TelDevice plug-in 126 initiates power up/power down of the radio equipment based on the required device operational mode, etc.

Network Plug-in

The Network plug-in 116 is responsible for implementing functionality associated with network registration and network operators. It caches the current network registration state and generates events of category Network when changes to the network registration state occur, or when the signal strength changes significantly.

The Network plug-ins ITelEventSink::OnEvent processes event types for requests corresponding to the INetworkManager, IOperator and IPreferredOperatorList interfaces of the Client API. The Network Manager request types that are handled by the Network Plug-in include:
GetSignalQuality
GetRegistrationStatus
GetGPRSRegistrationStatus
GetSupportedSelectionModes
Register
GetRegisteredOperator
GetAvailableOperators
GetPreferredOperators

Network Operator request types that are handled by the Network Plug-in include:
GetOperatorIndex
GetOperatorName
GetOperatorShortName
GetOperatorLongName
GetOperatorNumericName
GetOperatorRegistrationStatus
GetOperatorAvailableAccessTechnologies
GetOperatorSelectedAccessTechnologies
SetOperatorSelectedAccessTechnologies

Preferred Network Operator request types that are handled by the Network Plug-in include:
GetPreferredoperatorType
GetPreferredOperators
SetPreferredOperators
RestorePreferredOperatorManufacturersDefaults
NewOperator

The Network plug-in subscribes for PDM events associated with changes to the network registration state and signal strength. It publishes the following events types of category Network: Registered; Unregistered; and SignalStrengthChangedSignificantly. When changes to the network registration state occur, it updates its cached registration state value and publishes an event of type Registered/unregistered. The Network plug-in provides a COM API IRegister which has a method GetRegistrationState, to allow other plug-ins to access this value without going through the Event Service.

The PAL Network Plug-in handles requests that require radio equipment/network interaction (Register, GetRegisteredOperator etc) by sending the corresponding PDM request type to the PDM. (see network PDM plug-in description below).

Call Management Plug-in

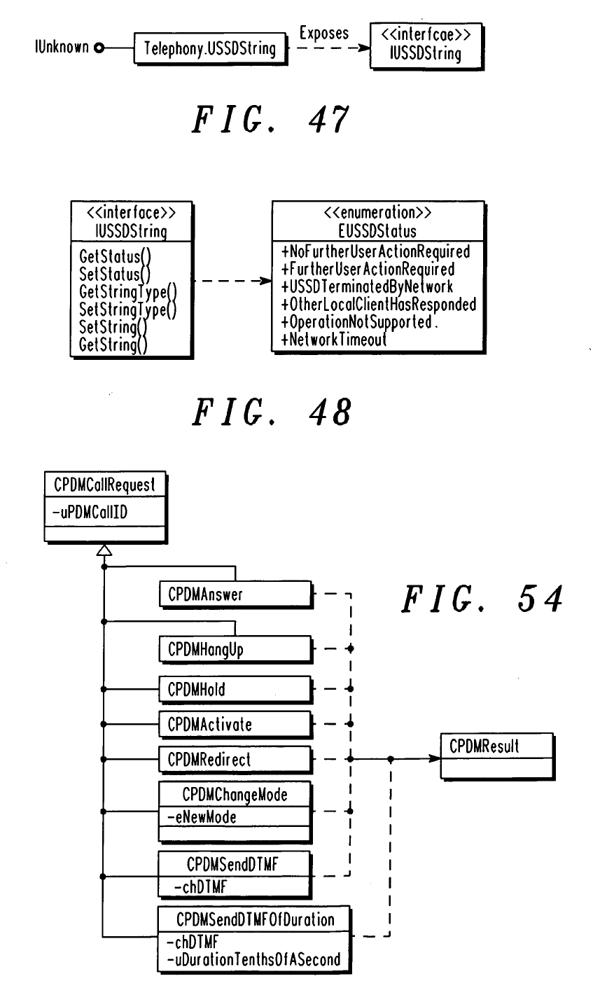

Referring to FIGS. 1 and 2, the Call Management Plug-in is shown as component 122. The Call Management Plug-in is responsible for managing the collection of call objects. It handles events associated with call commands that may cause the state of one or more call objects to change. The Call Management Plug-in uses the Call State Model to model the state of an individual call. The Call Manager and Call State Model class diagram is provided in FIG. 51.

Phone Driver Module

Overview

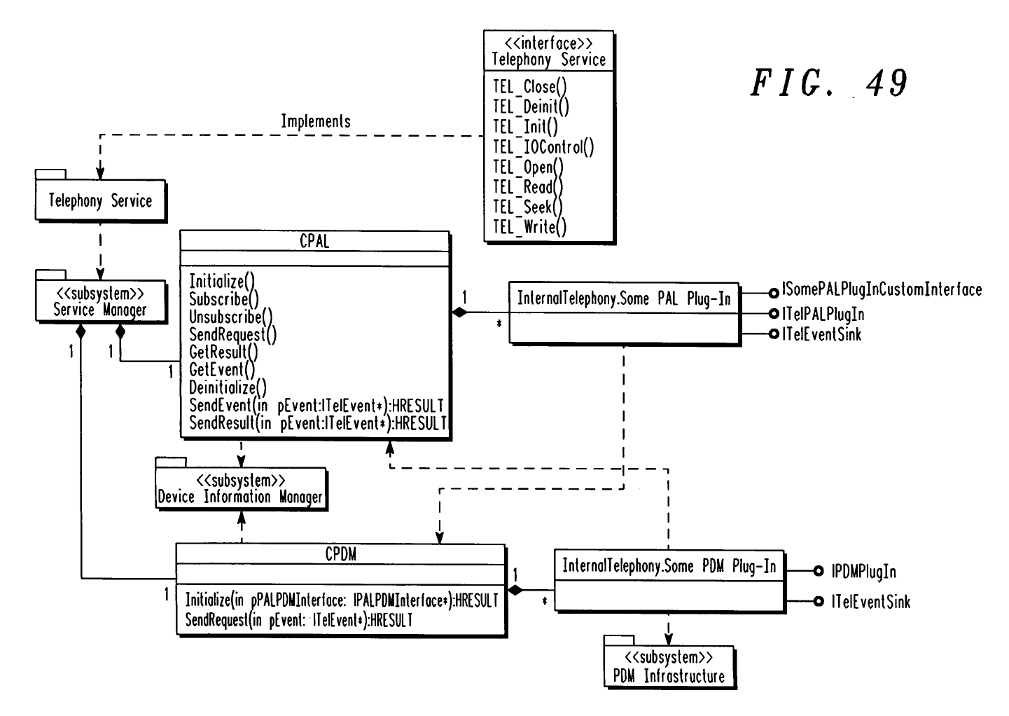

The PDM 160 is responsible of instantiating the required objects and classes for PAL-PDM interprocess communications. A PDM class diagram is shown in FIG. 52. In particular, the PDM is responsible for the main CPDM class, and implementing the IPDM interface that the PAL will use to initialize and send requests to the PDM. The CPDM object is instantiated by the PAL as part of its initialization sequence. The PAL invokes the IPDM::Initialize method. This causes the CPDM object to instantiate the PDM Event Service (iCTelEventService instance). It also queries the Device Information Store (i.e. PAL-PDM Device Info Store 144) for the ProgIDs of the configured set of PDM plug-ins, instantiates each PDM plug-in and invokes its IPDMPlugIn::SubcribeToPDMEventTypes method, passing in a pointer to the PDM ITelEventService interface.

All PDM plug-ins derive from the abstract CPDMPlugIn class and must implement the IPDMPlugIn::SubscribeToPDMEventTypes and ITelEventSink::OnEvent methods. PDM Plug-ins implement the SubscribeToPDMEventTypes method by invoking the ITelEventService::Subscribe method to subscribe for the Event Types of the PDM requests that they handle. For example, the PDM Call Plug-in 177 (CPDMCallPlugIn) subscribes for the Event Types of the call related requests: CPDMDial, CPDMGetSupportedCallModes etc.

The PAL 140 sends requests to the PDM 160 by invoking the IPDM::SendRequest method. This causes the CPDM object to forward the request to the PDM Event Service by invoking the ITelEventService::PublishEvent method. The request is queued. The Event Service dispatcher thread (i.e. PAL-PDM Event Services 161) then looks up the subscribers for the Event Type and invokes their ITelEventSink::OnEvent method. For example, the CPDMDial request is passed to the OnEvent method of the PDM Call Plug-in.

Each plug-in implements the OnEvent method to handle the requests that it subscribed for. It will typically switch based on the Event Type value, to perform request-specific processing using the request-specific parameters. The handling of the request will depend on the radio equipment. For example, for an AT-command based modem, it involves formatting the appropriate AT command, writing it to the modem's command stream. The plug-in can invoke the SendResult method on the CPDMPlugIn superclass to return the result. This method invokes the IPALPDMInterface::SendResult method to send it to the PAL.

Plug-ins may also monitor the radio equipment (i.e. Radio Hardware 103) via the Command Handler 190, for events. The Plug-in can then invoke the SendEvent method to send the appropriate PDM event (e.g., CPDMConnected) to the PAL.

PDM Plug-Ins

Referring to FIG. 2, various PDM level plug-ins are presented in further detail as follows.

Command Handler PDM Plug-in

Referring to FIG. 2, the Command Handler (CH) 190 is responsible for brokering requests and results from the PDM plug-ins to the MUX 195. The Command Handler plug-in encapsulates the overall Command Handler state management and PDM request handling, and drives the rest of the functionality groups. The Command Handler is configurable via the PAL-PDM Configuration Registry 144, where data such as virtual serial port and COM port settings, number and configuration of data channels, initialization commands, channel company type assignment, timeouts, and retries, to name a few, are stored.

More specifically, the Command Handler 190 brokers requests and results from the PDM plug-ins to the MUX 195 via one of the appropriate channels herein indicated as Data Channel 194, Command Channel 1 196, and Command Channel 2 197. The Command Handler 190 is also responsible for propagating unsolicited response code in the form of asynchronous events. The TIC 100 disclosed herein is structured to support any number of data channels, however there may be a practical upper bound, which is typically determined by the design of the system hardware.

As shown, the Command Handler is responsible for driving the Command Response Queue associated with each data channel (i.e. indicated as 194, 196 and 197 in FIG. 2). Each Queuing Command Channel manages separate Queue, Dispatch Thread, and Read Thread objects for the channel for which it is responsible. For the AT command set (i.e. GSM 27.005/0.007 protocols), the Command Channel is responsible for encapsulating the AT command queuing and dispatching. The Modem Control and Modem Serial objects encapsulate control of the actual interface to the modem, such as the serial port, multiplexing, etc.

In general, the Command Handler 190 only handles generic protocol result codes, for example such as that for GSM 27.007. The Command Handler allows other PDM plug-ins to subscribe with the Command Handler, and specify pattern matches for URCs, IRCs, and FRCs for example, and thus supports the paradigm of adding custom PDM plug-ins for different functional areas such as Call, Network, SIM, SMS, and SAT without modifying

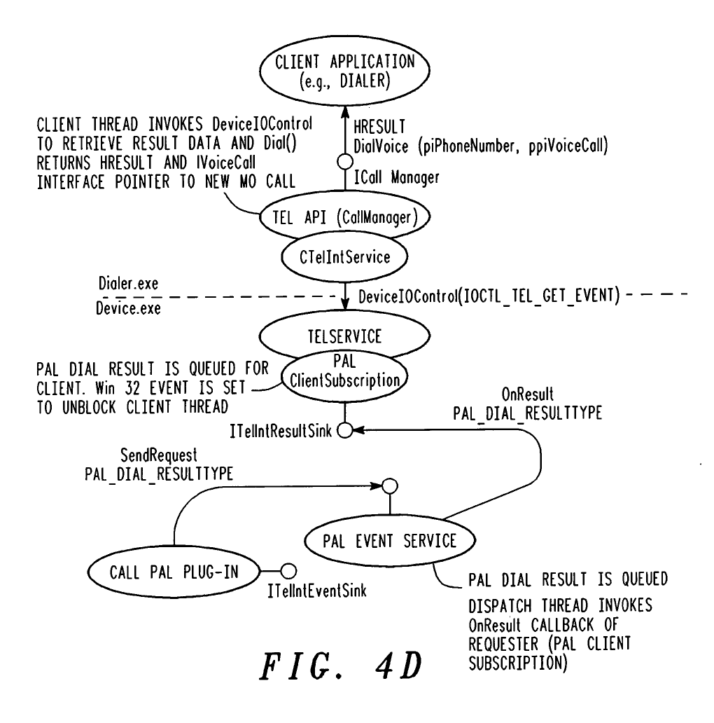

Command Handler 190 itself. In addition the Command Handler 190 is extensible and customizable via Custom Command Handler Plug-ins 181. Instances where a Custom Command Handler may be required included implementing interfaces to override default GSM 27.007 behavior, for channel, modem and error control as are provided in the software objects for IGSM27007 CommandChannelControl, IGSM27007ModemControl, (as shown in FIG. 6) and Command Handler Error.

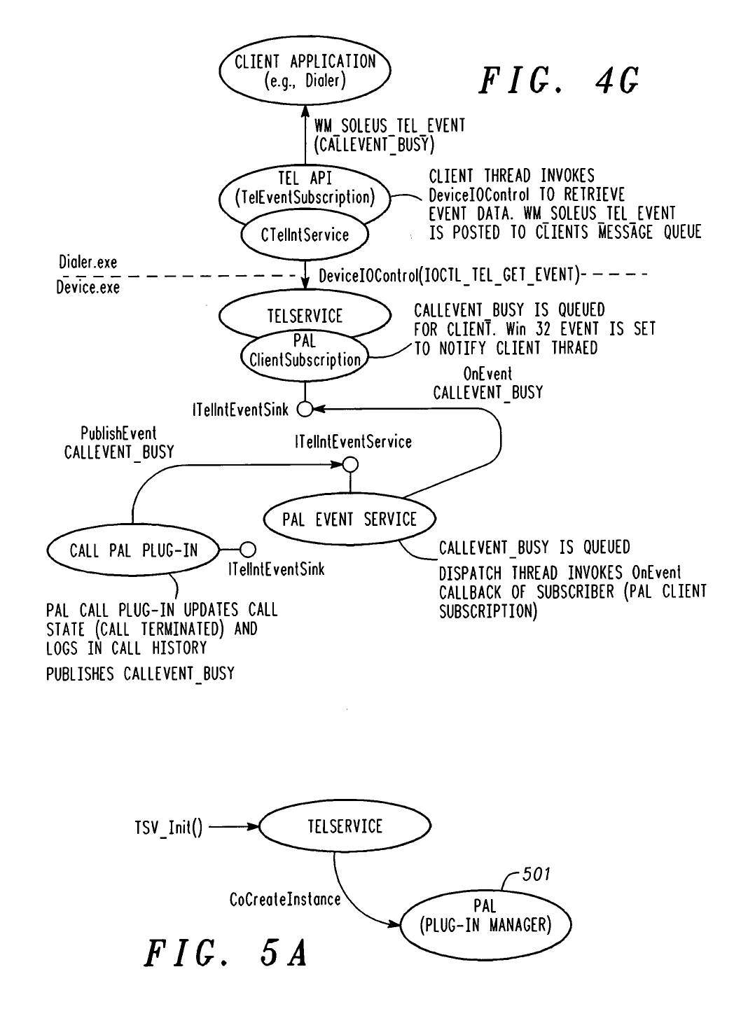

Referring to FIG. 8, the correspondence between the Command Handler Data Channels and the MUX 195 is further described. Typical phone hardware has a single service port (COML: (Serial Port) 801) connected to the mobile terminal (MT). The multiplexer enables multiple virtual serial channels 802, 803 to have serial port access 804 over this single port without the client applications being aware that multiplexing is being performed. This allows, e.g., support of data and command channels on a signal physical channel. The MUX framework shown in FIG. 8, implements a Win32 stream driver. Standard Win32 file operations (e.g. CreatFile( ), WriteFile( ), ReadFile( ), DeviceIOControl) are implemented according to the communication protocol (i.e. GSM 27.007). The most common multiplexer protocol is GSM 27.010 805, as is shown by way of this example.

Call PDM Plug-in

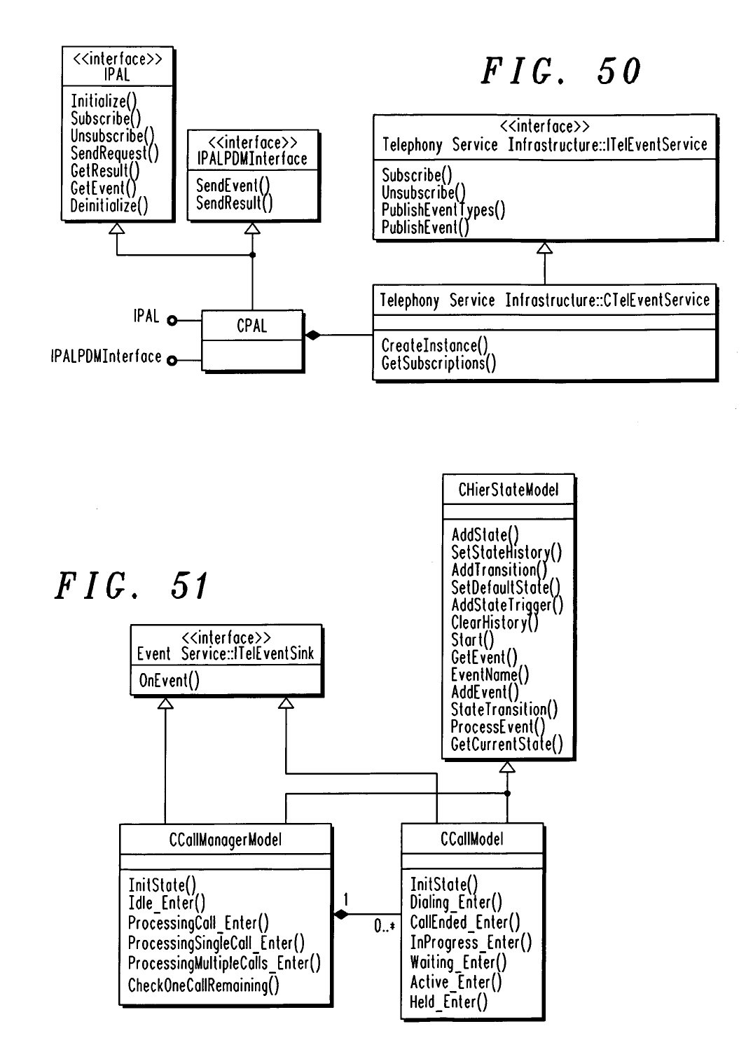

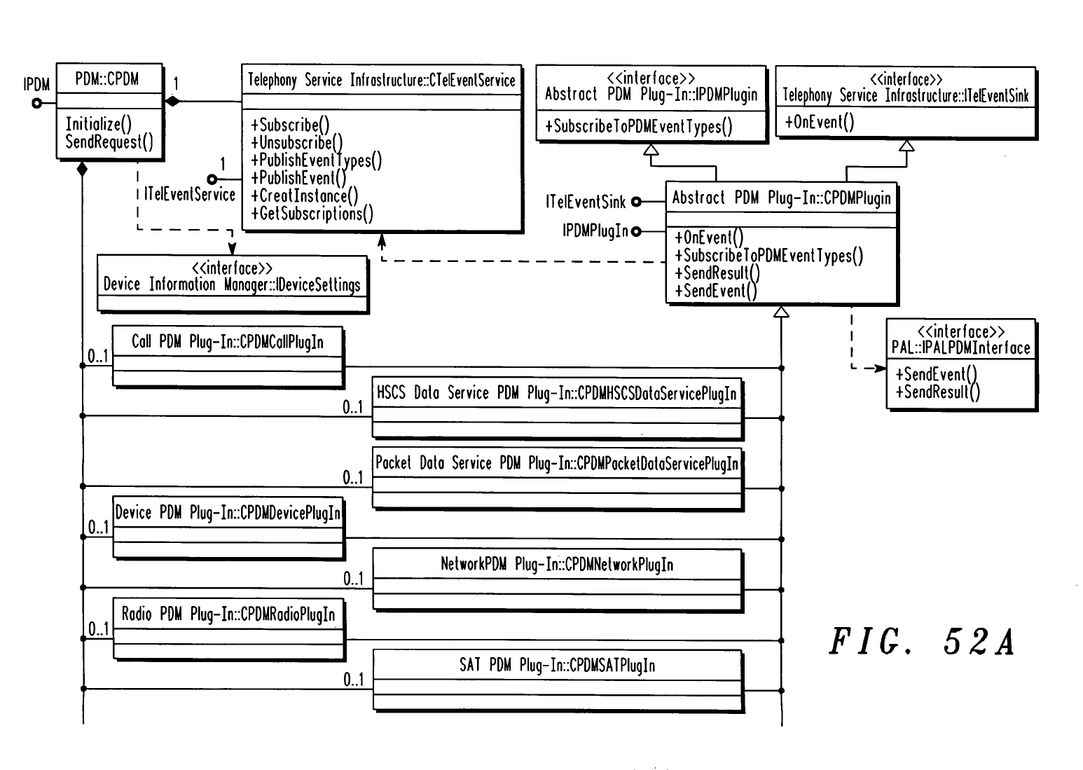

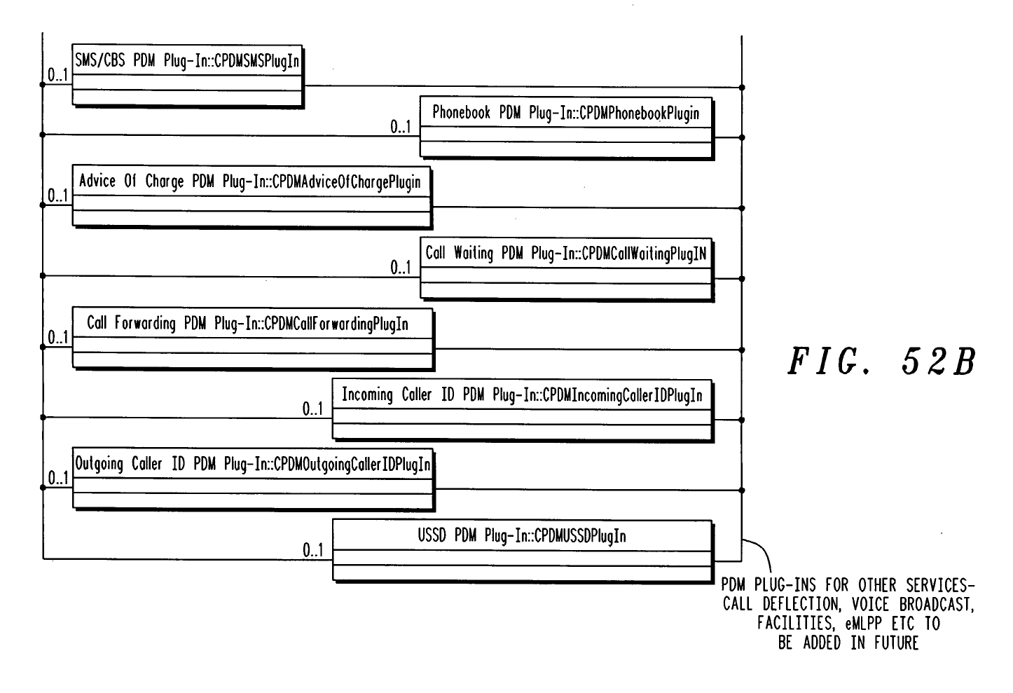

Referring to FIG. 2, the Call PDM Plug-in 177 handles requests associated with calls and call management. These requests generally apply to both voice and circuit switched data calls and possibly packet data calls. The Call PDM Plug-in also generates unsolicited events associated with calls. The Call PDM Plug-in objects, events and requests are illustrated in FIG. 53, PDM call management requests and results; FIG. 54, PDM call requests and results; and FIG. 55, PDM Call Events.

HSCSD PDM Plug-in

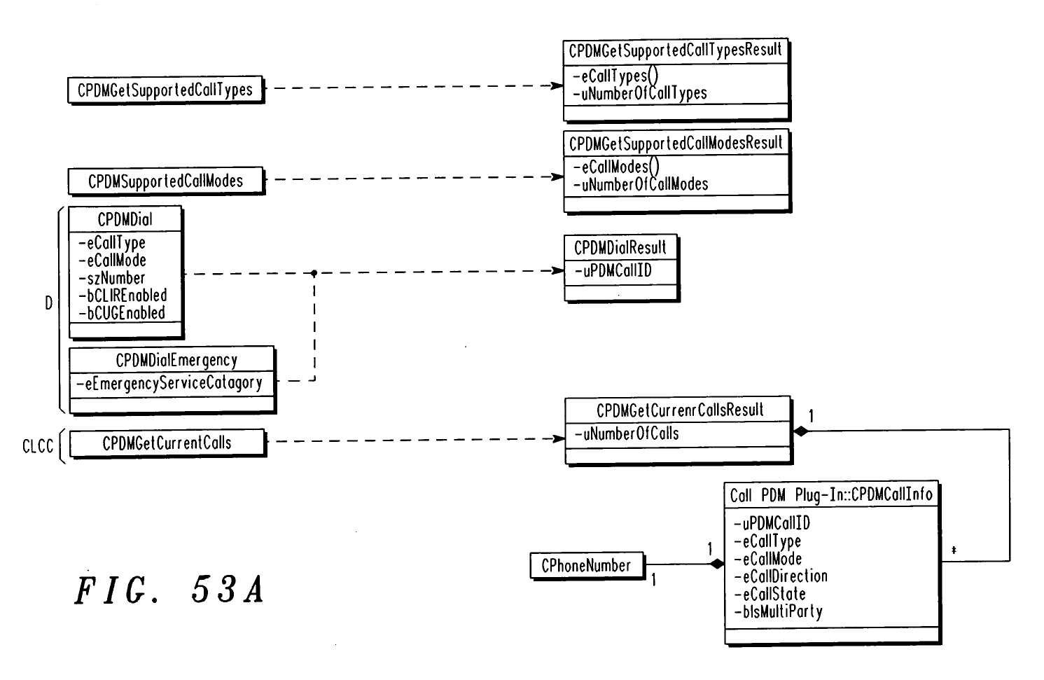

Referring to FIG. 2, the HSCSD PDM Plug-in 176 handles requests associated with high-speed circuit switched data service settings. HSCSD PDM Plug-in objects, events and requests are presented in FIG. 56, PDM HSCSD Requests and Results.

Packet Data PDM Plug-in

Referring to FIG. 2, the Packet Data Plug-in 175 handles requests associated with packet switched data services. This includes PSAttach, PSDetach, PSActive, PSDeactivate, EnterDataState, Modify context, Define context, Delete context GetNegotiated3GQualityOfService, etc.

Tel Device PDM Plug-in

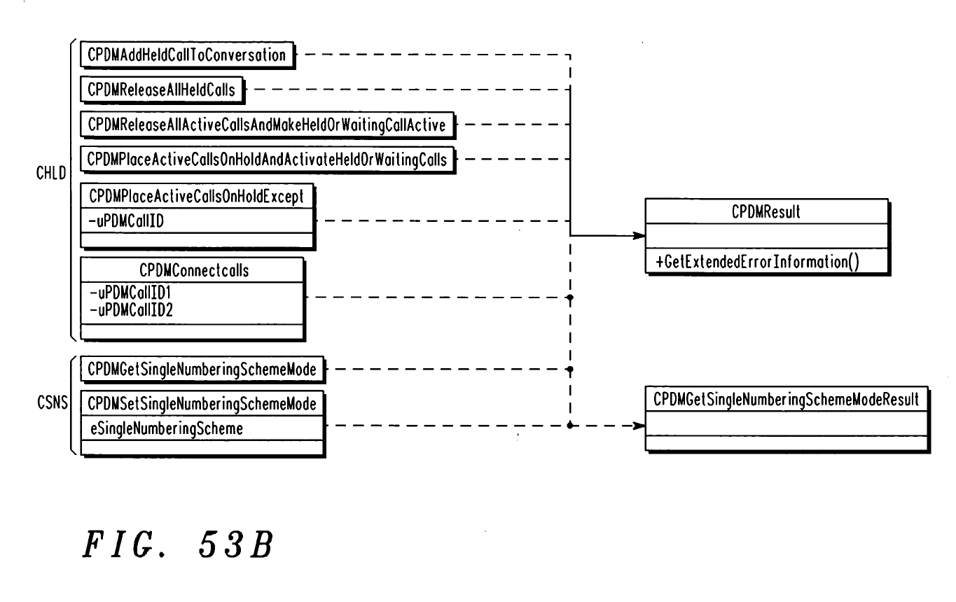

Referring to FIG. 2, the Tel Device Plug-in 172 handles requests associated with the phone device (model, manufacturer, serial number, GPRS capabilities and lock state etc). Tel Device Plug-in objects, events and requests are presented in FIG. 57, PDM Device Requests and Results.

Network PDM Plug-in

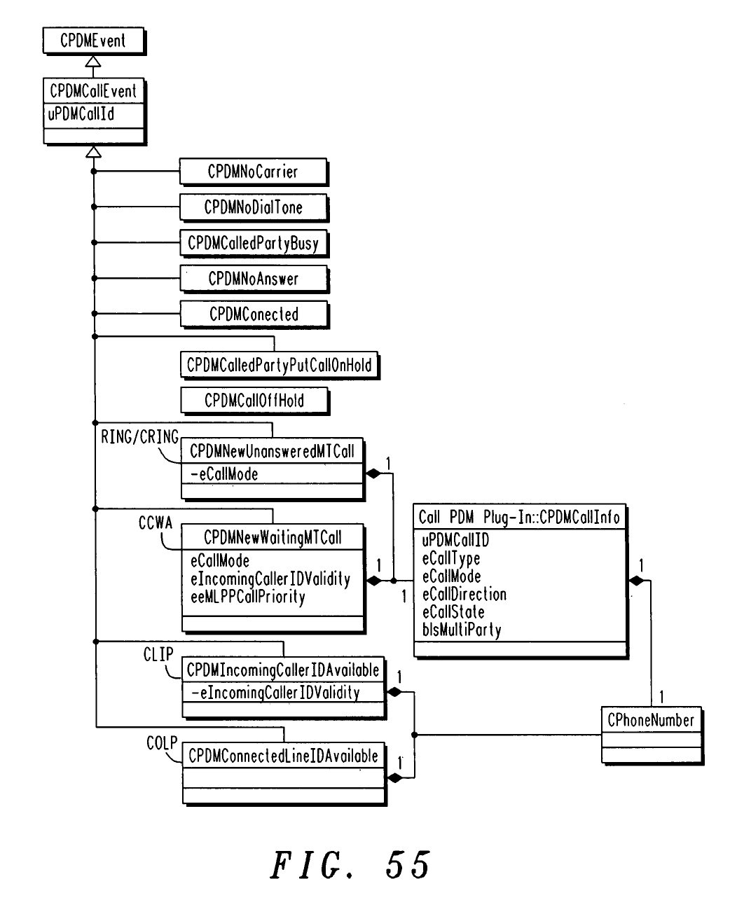

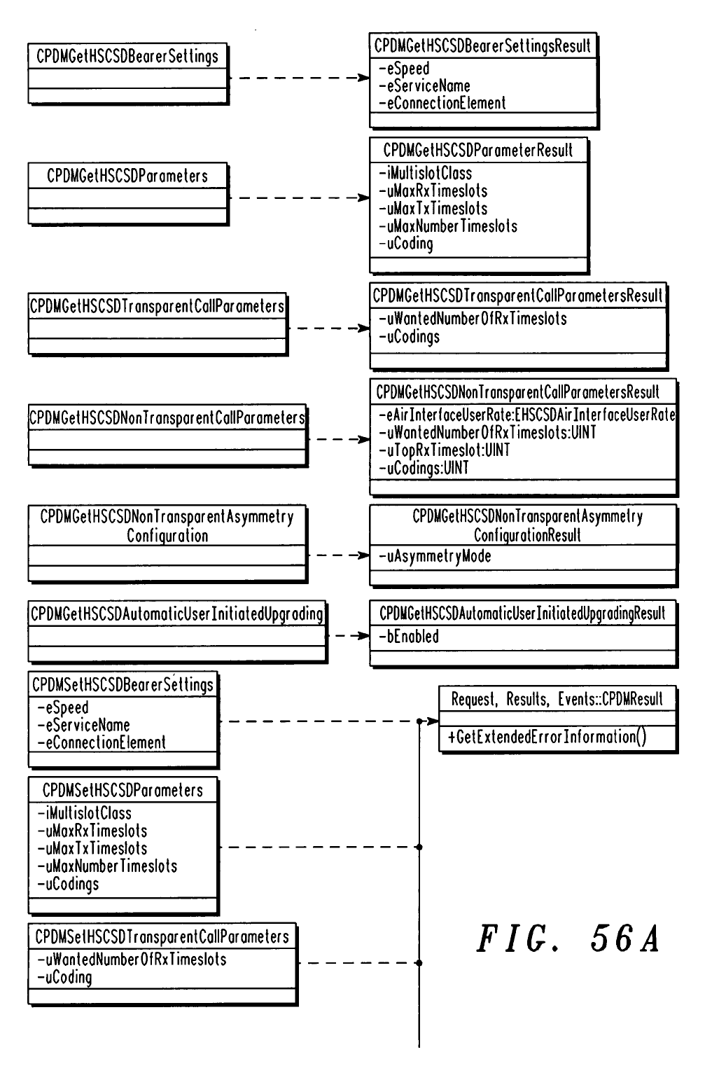

Referring to FIG. 2, the Network PDM Plug-in 179, handles requests associated with network registration and network operators. Network PDM Plug-in objects, events and requests are presented in FIG. 58: PDM Network Requests and Results; and in FIG. 59, PDM

Network Registration Events.

In some embodiments of the PDM, the PAL 140 has responsibility to generate events associated with “significant” changes in signal strength and in these situations the signal strength matters are not included in the set of PDM Network Events. In other embodiments, the PDM reports signal strength change events, i.e., when this is supported by the radio hardware.

Radio PDM Plug-in

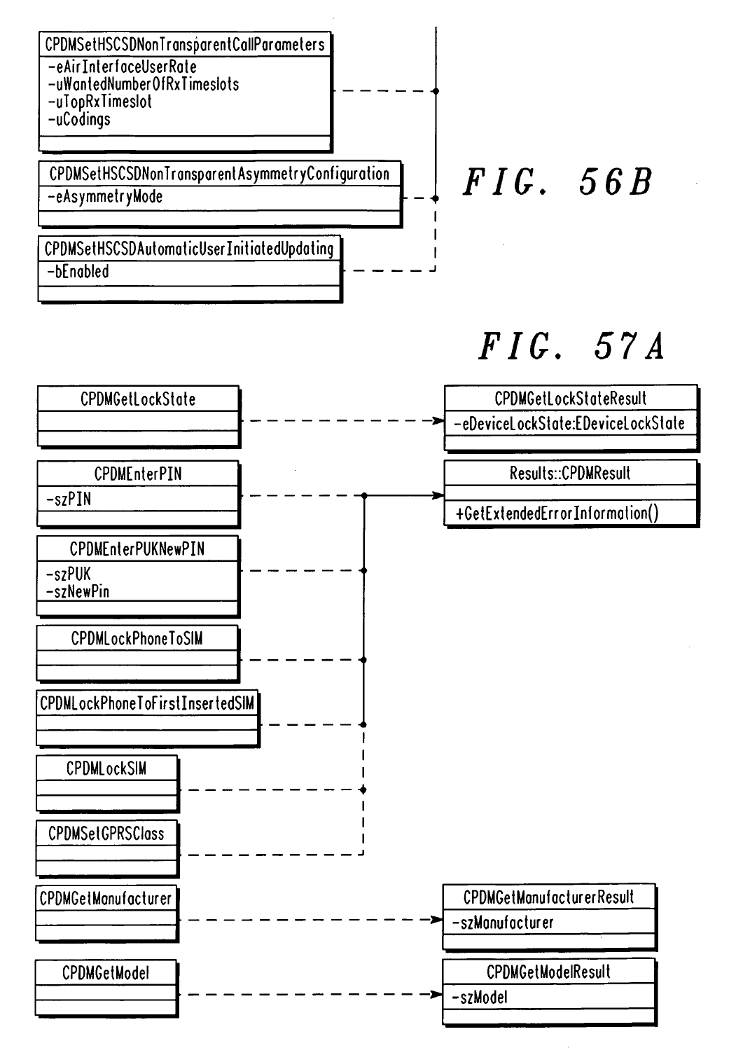

Not explicitly shown in FIG. 1 or 2, the Radio PDM Plug-in handles requests associated with the radio equipment power state, transmitter and receiver gains and Real Time Clock. This functionality can be included in the TelDevice PDM plug-in 172. Alternatively, if customization is required for radio equipment, this plug-in can be included in a DAL Custom Plug-in 128. Radio PDM Plug-in objects, events and requests are presented in FIG. 60, PDM Radio Requests and Results.

Phonebook PDM Plug-in

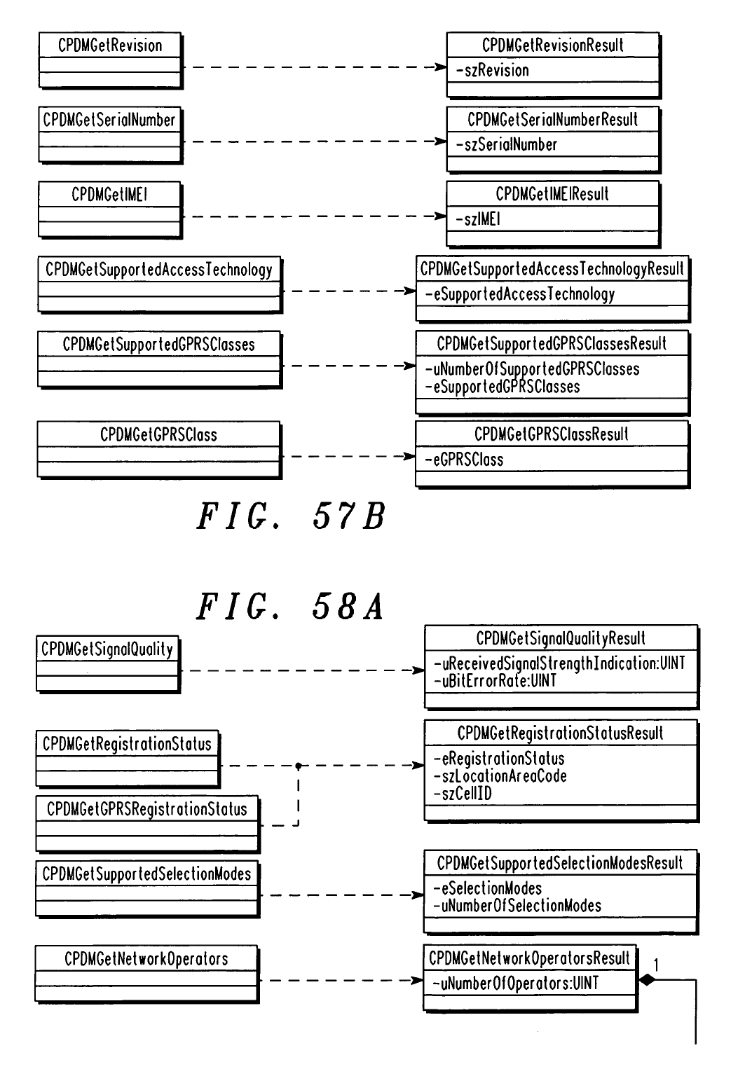

The Phonebook PDM plug-in 174 is responsible for handling requests associated with querying and updating phonebook data residing on the SIM/SIM. Phonebook PDM Plug-in objects, events and requests are presented in FIG. 61, PDM Phonebook Requests and Results.

Note that all requests (except GetAvailablePhonebooks) have a phonebook parameter to specify which phonebook they operate on (Fixed Dialing, Emergency Numbers, SIM ADN etc). The Phonebook PDM Plug-in is responsible for selecting the specified phonebook, if it is not already the currently selected one.

Writing phonebook entries is only possible for a subset of the phonebooks. Emergency Numbers, Last Dialed, Recent Calls, Missed Calls and combined phonebooks are not writable. Updating the Fixed Dialing (FD) phonebook is only possible if the FD phonebook is unlocked and requires PIN2 authentication.

SMS/CBS PDM Plug-in

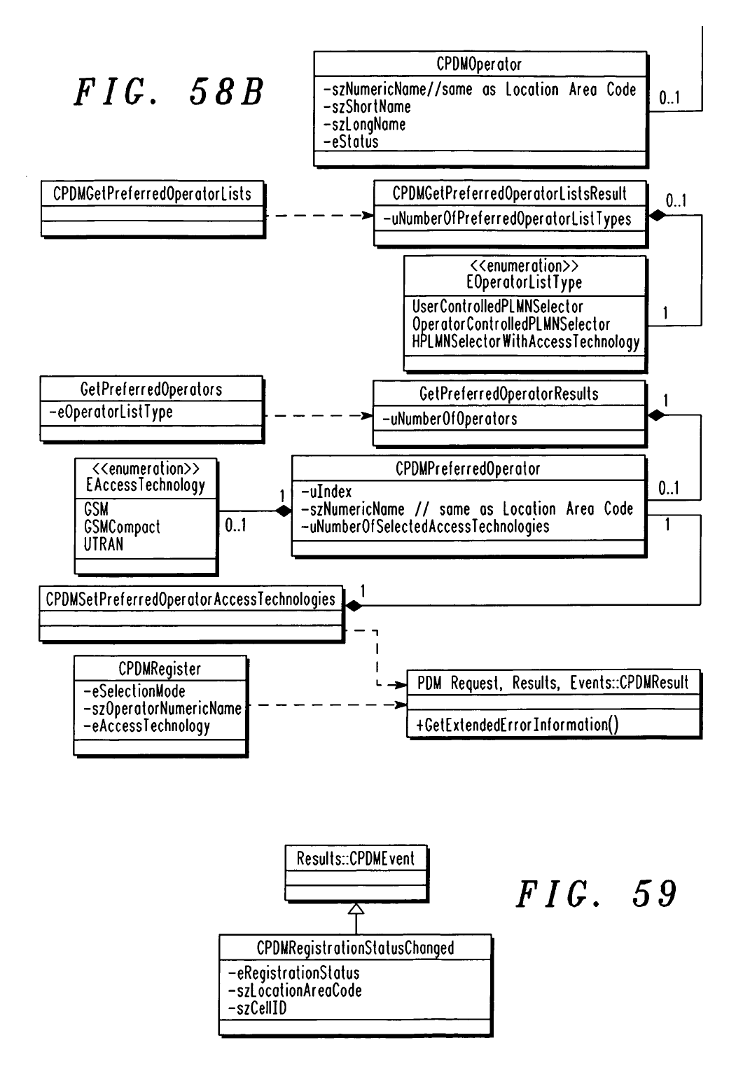

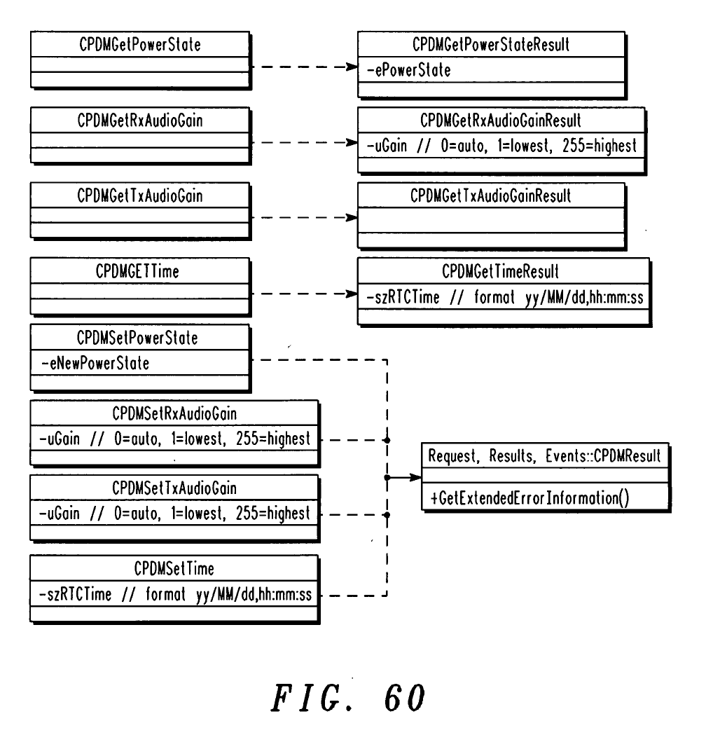

Referring to FIG. 2, the SMS/CBS PDM Plug-in 178 handles requests associated with Short Messaging Service and Cell Broadcast Messages. To simplify the PDM 160, the parsing of SMS message is assigned to the PAL 140. The PDM only needs to be able to get/send PDUs. SMS/CBS PDM Plug-in objects, events and requests are presented in FIG. 62, PDM SMS Requests and Results; and in FIG. 63, PDM SMS Events.

Service Plug-ins

Various service specific PDM plug-ins are provided within Supplementary Services 178 Plug-in shown on FIG. 2. There are associated Supplementary Service PDM level plug-ins including: Advice Of Charge; Call Forwarding; Call Waiting; Caller ID and Unstructured Supplementary Service Data (USSD); Call Deflection; Closed User Groups; Connected Line ID; Facilities; Voice Broadcast; eMLPP; etc. As mentioned previously, this list is not exhaustive, but rather representative of some of the PDM level plug-ins that may be provided. Some of the specific Supplementary Services PDM level plug-ins are discussed and described below.

Advice of Charge PDM Plug-in

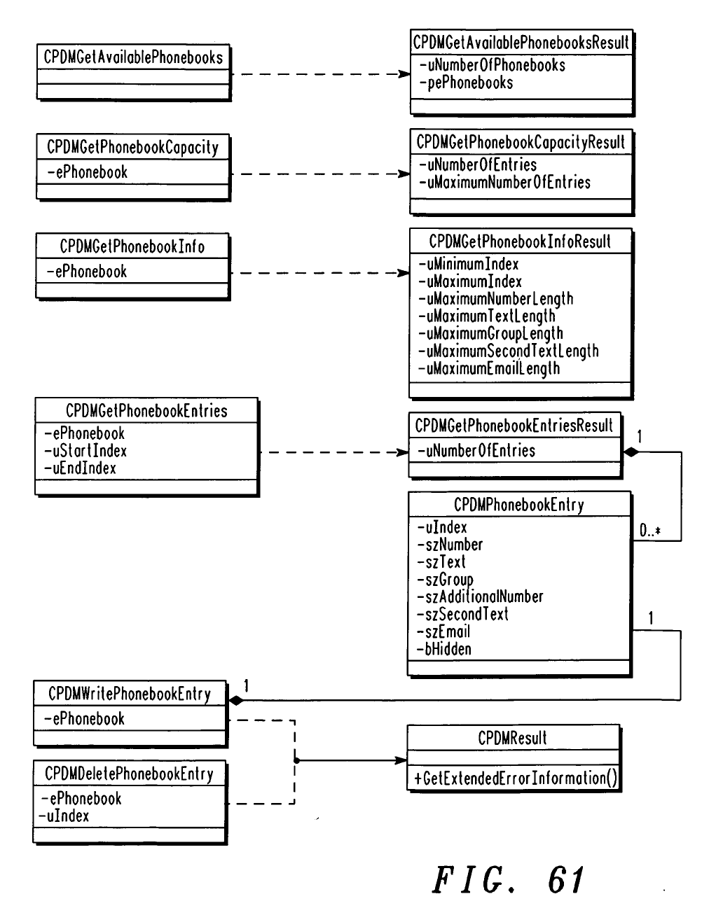

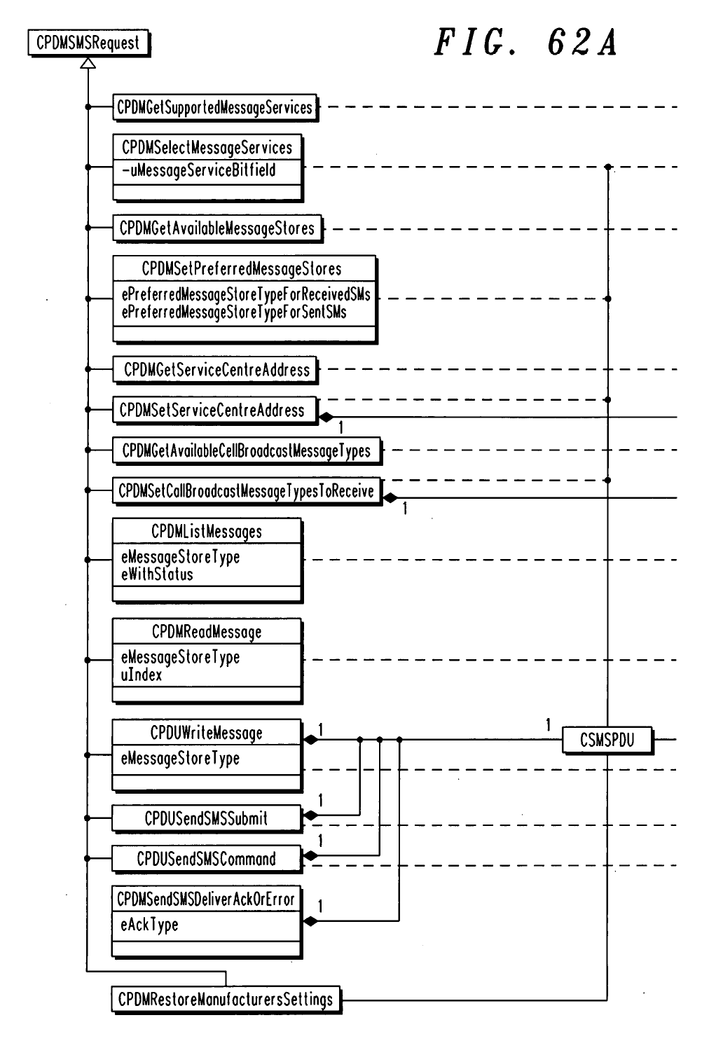

The Advice of Charge PDM Plug-in is responsible for handling requests associated with the accumulated call meter settings and generating events when the current call meter value changes. It is assumed that the PAL, rather than the PDM is responsible for generating an event when the Maximum Accumulated Charge is almost reached, based on the occurrence of PDM CurrentCallMeterChanged events and the Maximum Accumulated Charge setting. Advice of Charge PDM Plug-in objects, events and requests are presented in FIG. 64, PDM Advice of Charge Requests and Results, in FIG. 65, PDM Advice of Charge Events.

Call Forwarding PDM Plug-in

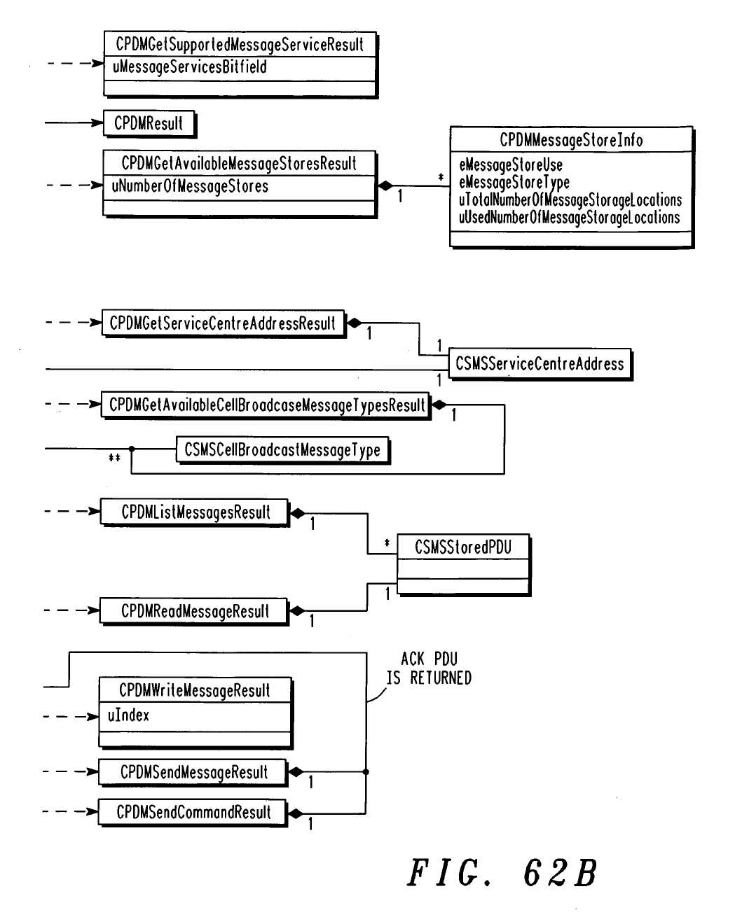

The Call Forwarding PDM Plug-in handles requests associated with call forwarding service settings. Call Forwarding PDM Plug-in objects, events and requests are presented in FIG. 66, PDM Call Forwarding Requests and Results.

Call Waiting PDM Plug-in

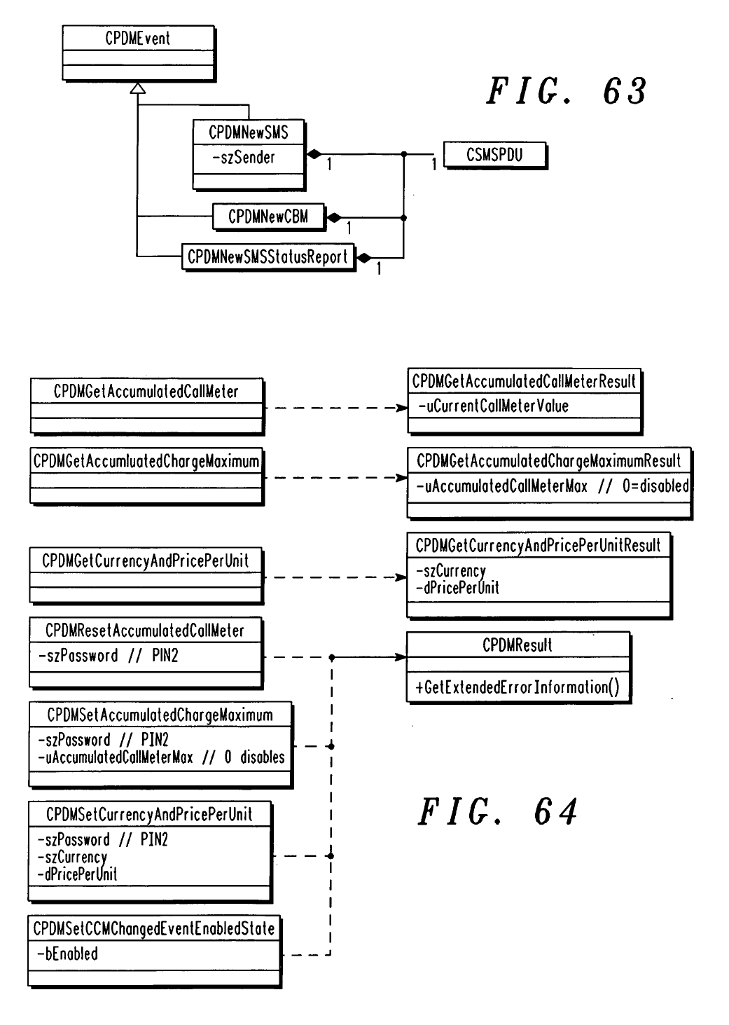

The Call Waiting PDM Plug-in handles requests associated with call waiting service settings. Call Waiting PDM Plug-in objects, events and requests are presented in FIG. 67, PDM Call Waiting Requests and Results.

Incoming Caller ID PDM Plug-in

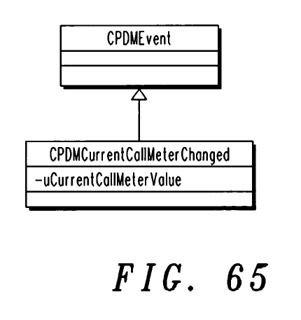

The Incoming Caller ID PDM Plug-in handles requests associated with enabling/disabling the presentation of the caller ID for incoming calls. Incoming Caller ID PDM Plug-in objects, events and requests are presented in FIG. 68, PDM Incoming Caller ID Requests and Results.

Outgoing Caller ID PDM Plug-in

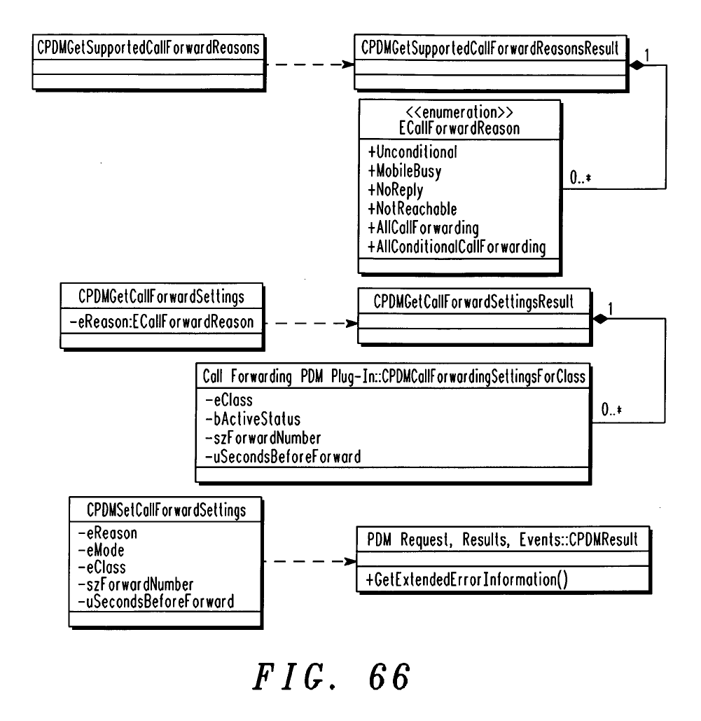

The Outgoing Caller ID PDM Plug-in handles requests associated with Calling Line Identification Restriction (CLIR) service to enable/disable the presentation of the mobile caller ID (phone number) to the called party for outgoing (MO) calls. Enabling CLIR suppresses the presentation of the mobile's caller ID to the called party. Outgoing Caller ID PDM Plug-in objects, events and requests are presented in FIG. 69, PDM Outgoing Caller ID Requests and Results.

USSD PDM Plug-in

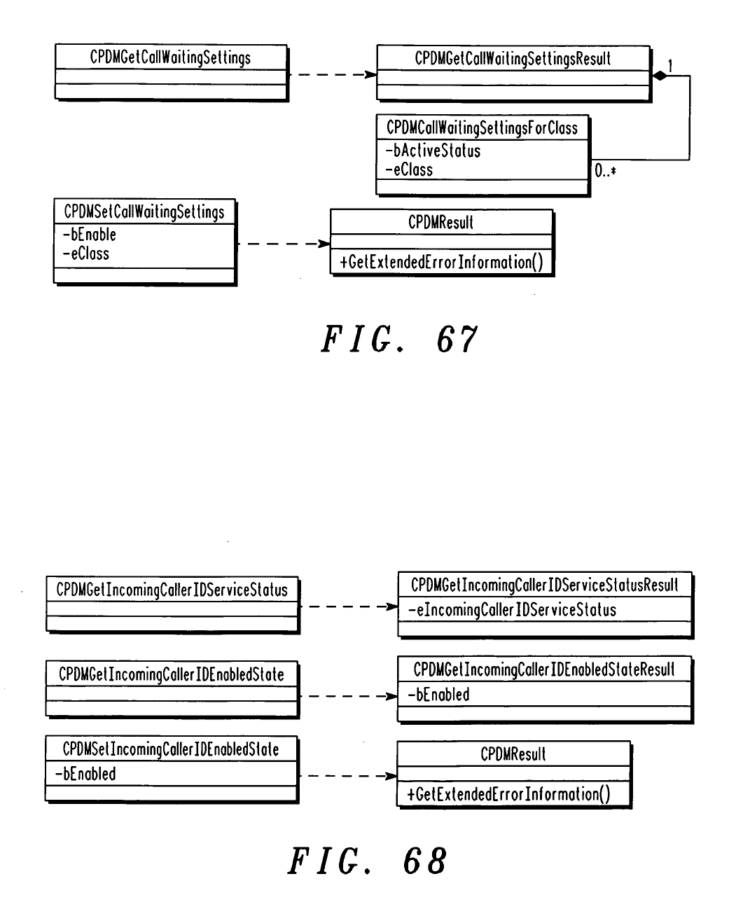

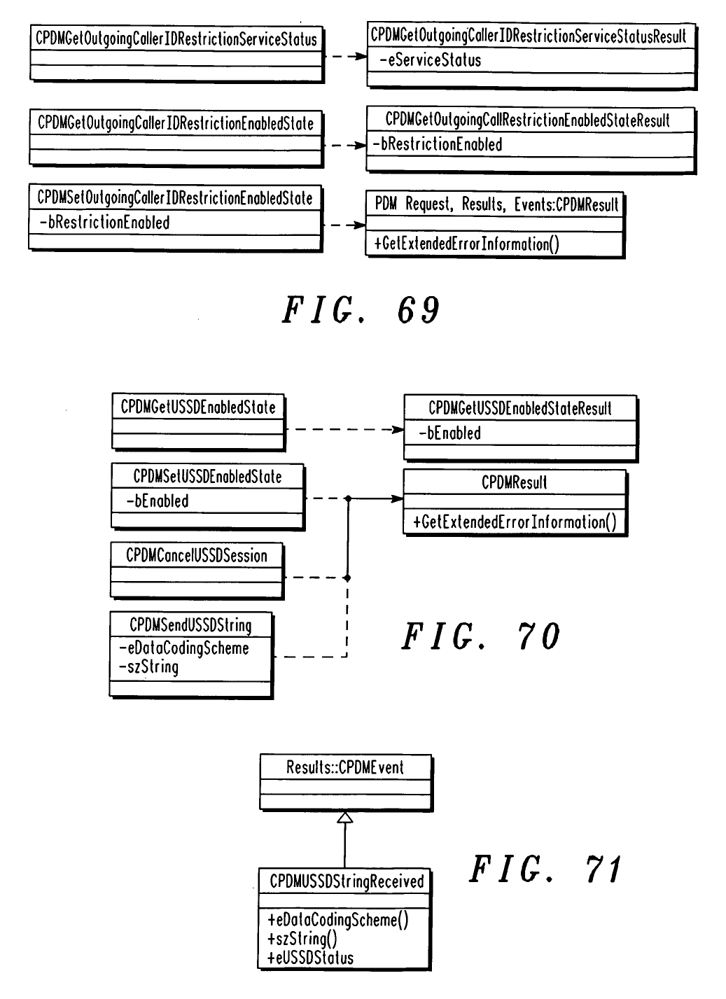

The USSD PDM plug-in handles requests associated with Unstructured Supplementary Service Data including sending USSD strings and the enabling/disabling of the presentation of unsolicited USSD events. The USSD PDM plug-in generates a USSD String Received event on reception of an unsolicited USSD string (USSD response from the network, or network initiated operation). USSD PDM Plug-in objects, events and requests are presented in FIG. 70, PDM USSD Requests and Results, and in FIG. 71, USSD Events.

### Operational Scenarios

Voice Call Scenarios

Mobile Originated Voice Call

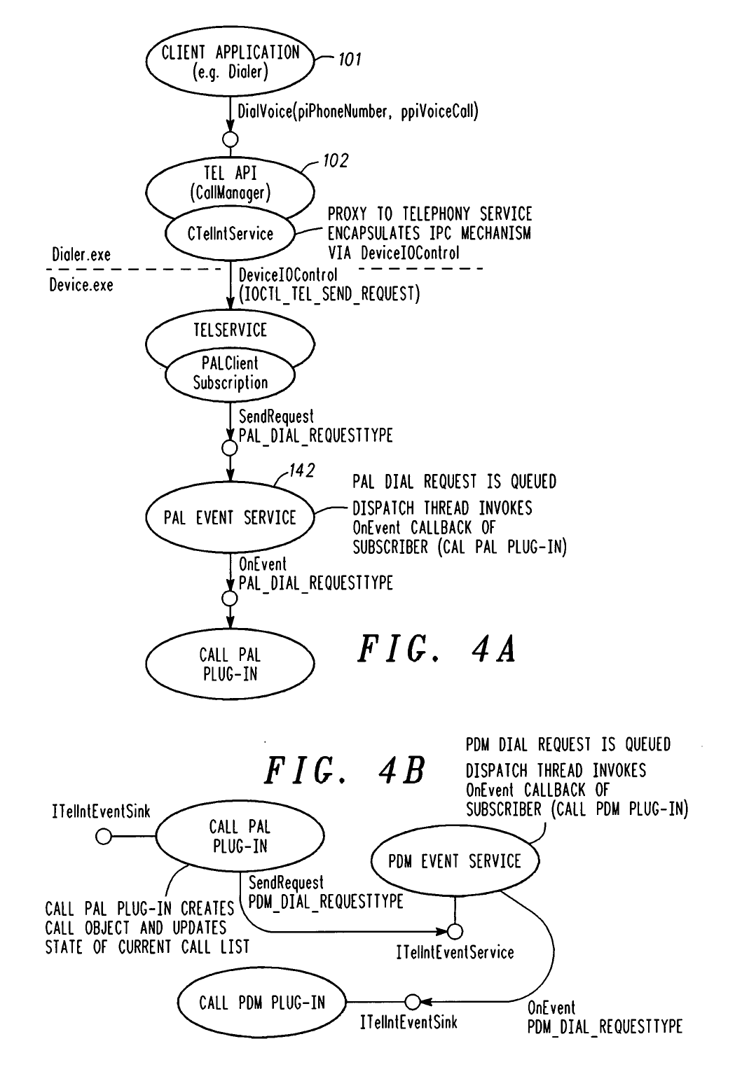

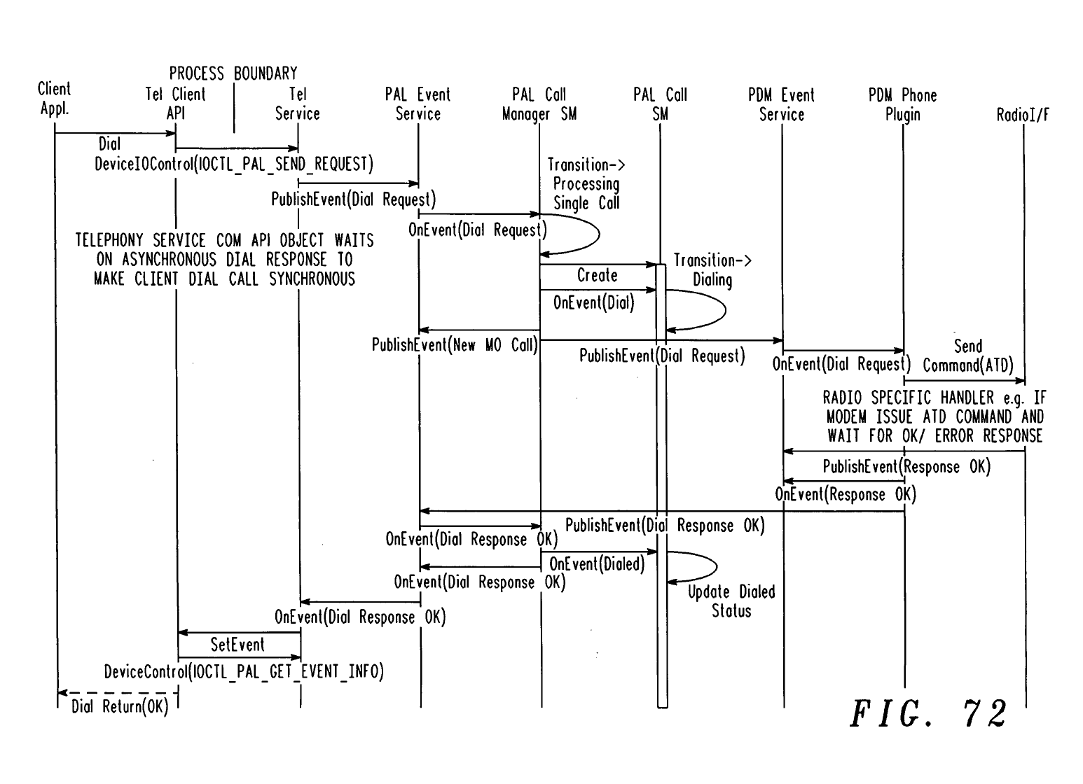

Referring to FIG. 2, FIG. 72, Dial Sequence Diagram, and FIG. 4A-FIG. 4D a Mobile Originated (MO) voice call scenario provides an example of the interactions which take place when a Client or client application 101 (e.g. a Dialer Application) invokes the Dial method of the Telephony Client 102 API to initiate a voice call.

The Telephony.ClientAPI of the Telephony Client 102 (call manager) creates a dial request object and invokes the Telephony Service's 199 DeviceIoControl function to publish the request, causing it to be added to the PAL Event Service 142 queue. The DeviceIoControl function returns at this point. In order to make the Dial API call appear synchronous, the Telephony.ClientAPI object must wait for receipt of the subsequent Dial Result message for which it has registered.

The dispatcher of the PAL Event Service 142 is signaled that a new event has been queued, de-queues the message and looks up the subscribers for the Dial event type. The Call Manager State Model object has subscribed for this event type (as described in the previous scenario) and the dispatcher invokes its callback sink method (OnEvent). This causes it to transition from the Idle to the Processing Single Call state (assuming that prior to this Dial command there were no other calls in progress). On entry to this state it invokes its handler for the dial command which creates a Call State Model object and invokes its OnEvent method. This causes the Call SM to transition to its Dialing state. The Call Manager publishes a New MO Call event and sends a PDM Dial request to the PDM Event Service 161. The PDM Event Service Dispatcher 170 is signaled that a new event has been queued, de-queues the event and looks up the subscribers for the Dial event type.

The appropriate radio equipment specific PDM plug-in (i.e. PDM Call Plug-in 177) has previously registered as a subscriber for the Dial command event type and its callback sink method (OnEvent) is invoked. The implementation of this method depends on the specific radio equipment. For example, for an AT command based modem, it involves issuing an ATD command to the radio interface using the dial string parameters contained in the Dial command event data and waiting for an OK, error response, etc. The response is added to the PDM event queue. The PDM Event Service Dispatcher invokes the OnEvent callback of the PDM Call plug-in (which has also subscribed for this event type). The PDM Call plug-in processes the response and sends the Dial Response event to the PAL Event Service queue. The Call Manager State Model is a registered subscriber, and its OnEvent callback is invoked. This causes it to update the dialed status of the call and send a Dial Response event for the original client Dial request to the PAL Event Service. The Telephony.ClientAPI object has previously registered for this response message and the Telephony Service 199 notifies it of the response event, which causes it to unblock, invoke DeviceIoControl to retrieve the data associated with the event and then return the dial result to the client application (e.g. either TSP 145 or Client 101).

The above mentioned scenario may also be further understood through reference to FIG. 4A-FIG. 4D, which provide additional detail on the interactions, etc. among components and objects. FIG. 4E-FIG. 4G detail a call busy scenario from the command handler to the PDM, PDM to PAL, and PAL to client, respectively.

Mobile Terminated Voice Call

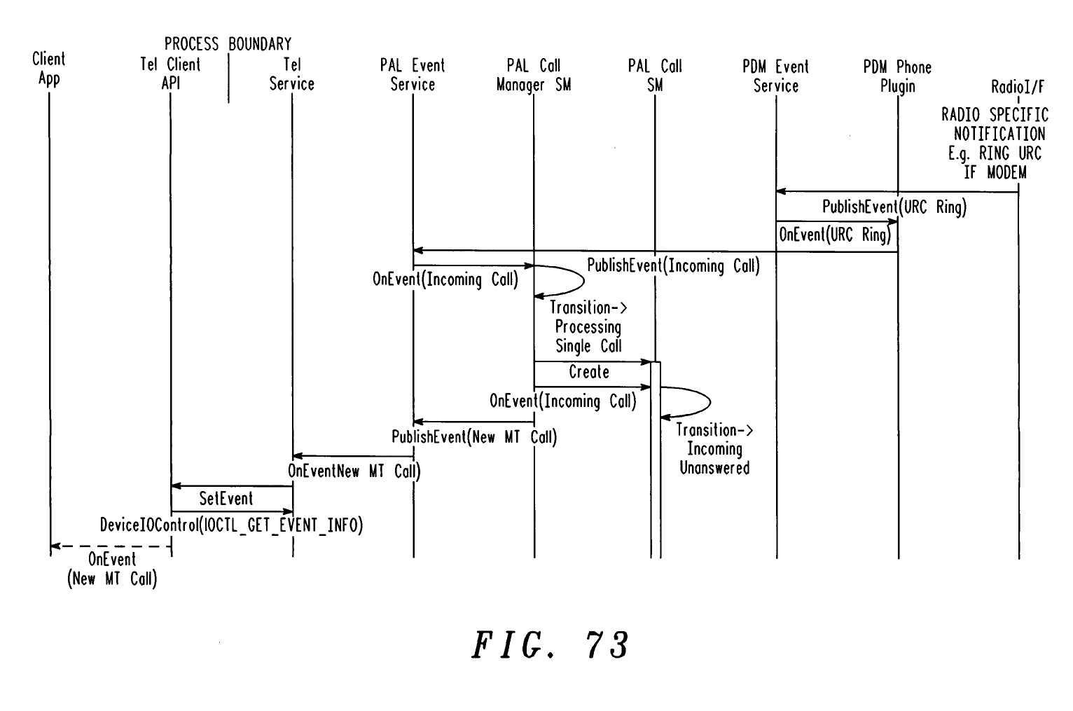

Referring to FIG. 2, and FIG. 73, Incoming Call Sequence Diagram, the scenario for an Incoming call provides an example of a message associated with an unsolicited event at the PDM 160 level being propagated up to a client application (e.g. TSP 145, or Client Application 101). Since the messaging service is asynchronous anyway, this is in essence the same as the sequence for the response portion of command handling. One difference is that in this case the client of the Telephony Service 199 (e.g., Dialer application) has explicitly subscribed for notification of New MT Call events. Whereas in the case of response messages, the Telephony Client API 102 object subscribes transparently for response messages on behalf of the Client 101.

Data Call Scenarios

Packet Data Call

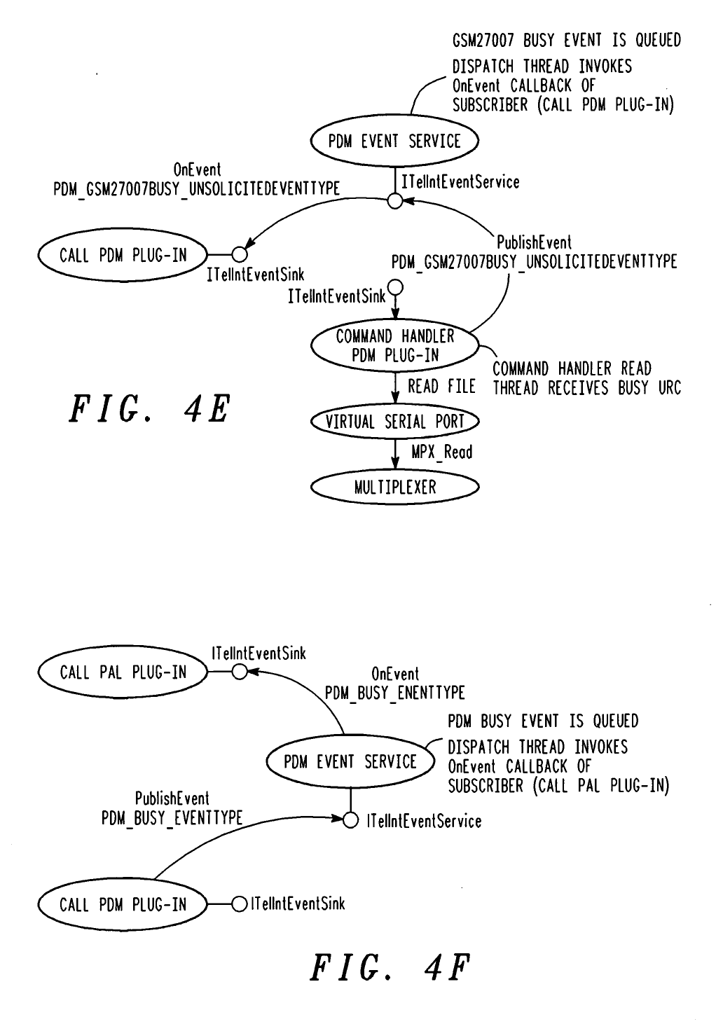

Referring to FIG. 1, and FIGS. 7A through 7C the objects, events and methods generally used to facilitate packet data calls are presented. In general, network data clients (e.g. E-mail applications, Internet browser) use industry standard network services such as WINSOCK, TCP/IP, RAS, PPP, NDIS and NDIS drivers to facilitate the service. The set of such network services is generally shown as component 105 of FIG. 1.

Within the context of the TIC 100, dial up networking is used to facilitate Packet Data 112 and Circuit Switched Data 114 calls. For both 112 and 114 calls, Network Services' AutoRAS/RAS, PPP (i.e. 105) and the TAPI Framework 107 is used to set up the call via the TSP 145. More specifically, the TSP 145 is a telephony client. It converts between TAPI 107 and Telephony Client API 102 requests/events. The TSP 145 provides the control plane for creating a RAS/PPP session and thus medium access control setting up the serial line for the data channel and providing this serial data channel to PPP for the data plane which allows packet data and circuit switched data to be used along with RNDIS. The TSP 145 manages the conversion between the TAPI framework 107 and the Telephony Client 102.

Referring to FIG. 7A through FIG. 7D, an example scenario of a data setup and tear down is presented. The procedure begins when an application (e.g. Browser) uses Winsock to open a socket. RaDial auto-dialer receives IDM_START_RASDIAL as a Windows message. The default RAS Phonebook information is read using RasGetEntryDialParams( ). Next, RasDial( ) is invoked, specifying the DevieName=TelTSP Line (Data), the line drive implemented and exposed by TSP 145. RAS/PPP/TAPI invokes TAPI TSPI_lineMakeCall( ) function. In order to set up the MAC layer for the pending PPP link establishing (the data plane), RAS/PPP/TAPI invokes Telephony Client API 102 ICallManager::Dial( ) method and forwards PAL Dial Request. Before it invokes the ICallManager::Dial( )Telephony Client API 102 fetches the APN, PDPType, and other context parameters from Configuration Registry 144 and then invokes IPacketDataSetting:SetContext( ) to define the PDP context in the radio modem; effectively configuring the packet data settings on the modem before dialing the packet data call. This is part of the control procedure to set up the Medium Access Control layer for PPP. Next, the PAL CALL plug-in 158 processes the Dial request to set up the call. The sequence of events from the Dial request to the PAL, to the PDM, and CommandHandler to the modem and back is similar to the plugin interactions for a MO Voice call scenario; however for this special PacketData call dial string, this dial request instructs the modem to enter DATA_ONLINE state and the CONNECT result is issued immediately; this CONNECT result is converted to a PDM Call event, which is propagated to the PAL Call event, which then publishes the CALLEVENT_CONNECT. The TSP receives this CONNECT event, maps this Call event to a TAPI “line connected” event and publishes it back to the TAPI client. The TAPI client which can be an AsyncMAC miniport which is waiting for the MAC layer will then proceed to request the TSP for the serial line port corresponding with this MAC data channel for communication to pass to PPP for communicating with the modem. With the PPP link established, the modem can move to an IP based session transferring WinSock application data traffic back and forth using, e.g., a GPRS bearer with external IP-based networks. Next, Indicator Service monitors data calls using RasEnumConnection and GetRasLinkStatistics. If it's been idle for a specific period (as defined within the PAL/PDM Configuration Registry 144) it posts WM_DESTROY message to RaDial causing it to use RasHangUp to release the data call. Finally, the PAL Plug-in receives NO CARRIER event and updates call state model to remove the data call object, and concludes the call.

PAL Scenarios

Telephony Service Initialization

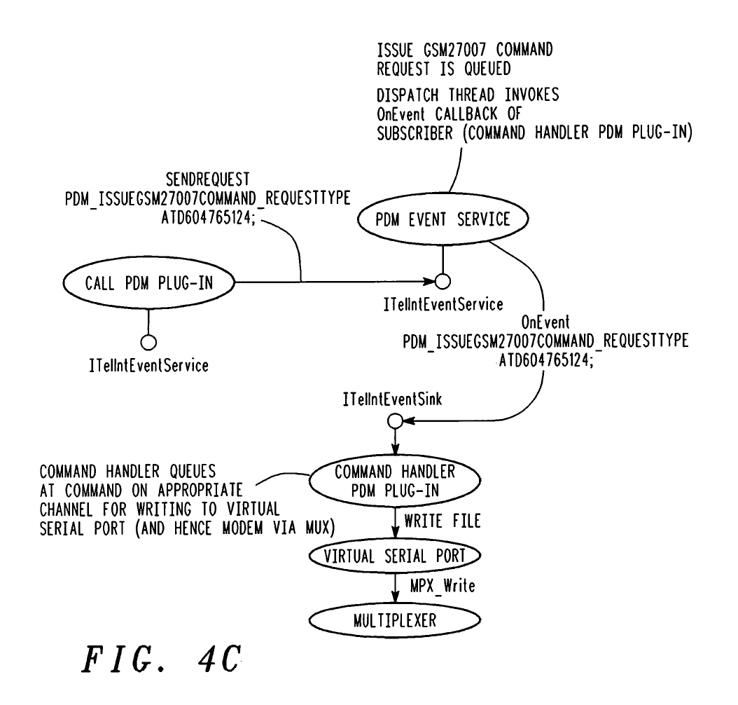

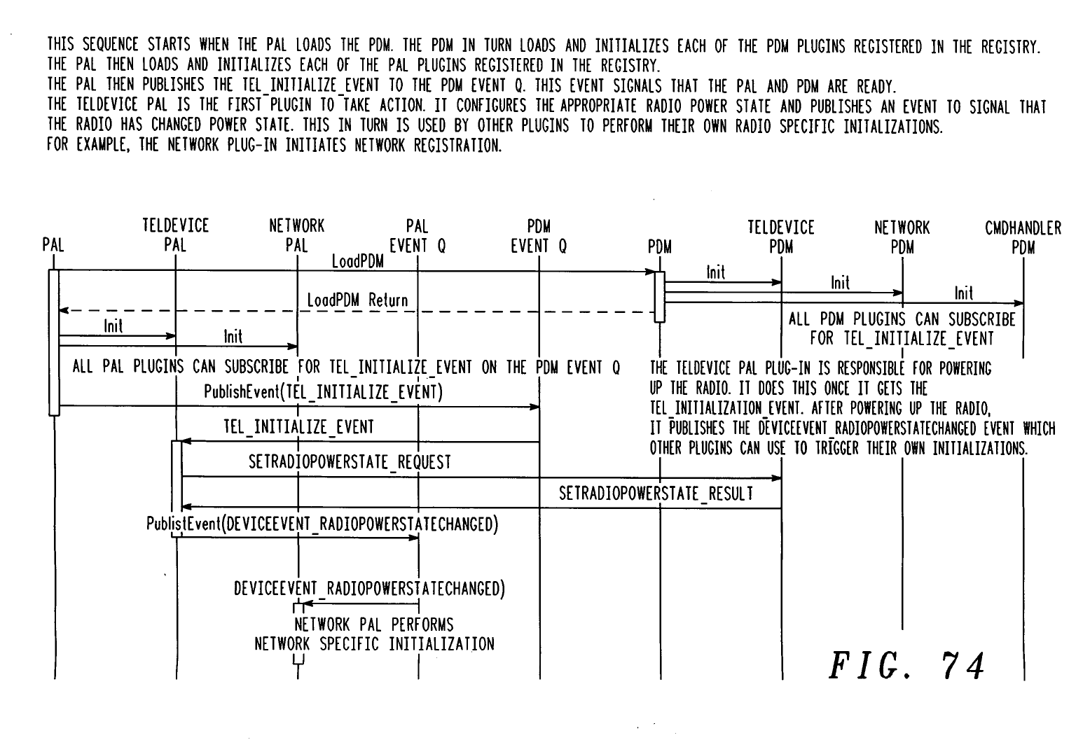

With reference to FIG. 74, PAL Initialization Sequence, and FIGS. 5A through 5G, the scenario for Telephony Service 199 initialization at system startup is illustrated. Step 1 of the Telephony Service initialization process begins in FIG. 5A when the operating system (e.g. Windows CE), loads the telephony service application and invokes the method TSV_Init( ). This causes the Telephony Service application to create a single container PAL object 501 which acts like a PAL plug-in manager.

Step 2 is shown in FIG. 5B. At this step the PAL object 501 creates the PAL Event Service 142 and looks into the PAL-PDM Configuration Registry 144 to obtain the ProgID of the PDM object 505 to create. Step 3 is shown in FIG. 5C. At this step the PDM object 505 creates the PDM Event Service 161, and looks in the registry 144 to obtain the ProgID of all the PDM plug-in components 507 to load.

At step 4, FIG. 5D, the PDM object invokes the Initialize( ) and SubscribeToEventTypes( ) methods of the PDM plug-ins 507. Each PDM plug-in subscribes with the PDM Event Service 161 for the requests and events it wishes to receive. The PDM Event Service 161 is then started. At step 5, FIG. 5E, the PAL object 501 looks in the registry 144 to obtain the ProgID of all the PAL plug-in components 509 to load. At step 6, FIG. 5F, the PAL object invokes the Initialize( ) and SubscribeToEventTypes( ) methods on each of the PAL plug-ins 509. Each PAL plug-in subscribes with the PAL Event Service 142 for the requests and events it wishes to receive. The PAL Event Service 142 is then started.

The procedure then moves to the final step 7, FIG. 5G, where the PAL object publishes the TEL_INITIALIZE_EVENTTYPE which notifies all plug-ins that initialization is complete. The PDM plug-ins then subscribe with the Command Handler 190 to receive URCs, and the PAL Tel Device Plug-in 151 powers up the radio modem (i.e. Radio Hardware 103) in accordance with its operational modes (as previously retrieved from the PAL-PDM Configuration Registry 144. At the conclusion of these steps, all interaction with Telephony Service 199 is event driven via requests from the Telephony Client API 102 or URCs from the Radio Hardware 103.

It will be appreciated that the above described architectures, components functions and structures may be practiced in varying forms including source and object code using conventional computing platforms as well as various devices, including mobile phones, etc. The processes, architectures, components, etc., discussed above, and the inventive principles thereof are intended to and can alleviate time and effort issues caused by prior art techniques for developing applications and operating systems for mobile phones and the like. Using these principles of independent plug-ins and phone or device abstraction a given application can readily be ported to and utilized on a wide variety of devices including phones and the like with relatively minimal cost, effort, and the like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An interface component operable to allow one or more application programs to interact with device functions, the interface component stored in computer readable medium and comprising:
a device client operable to provide a plurality of interfaces to the one or more application programs;
a device abstraction layer (DAL) operable to interact with the device client and to provide access to device functions, the device functions being device independent; and
a device driver module (DDM) operable to interact with the device abstraction layer and with hardware that is device dependent,
wherein at least one of the device client, the device abstraction layer, and the device driver module further comprises a plurality of components with each such component operable to support a corresponding grouping of the device functions.

2. The interface component of claim 1 wherein the device client is further configured with:
a first Application Programming Interface (API) to facilitate communication with the one or more application programs; and
a second API to facilitate communication with internal portions of the interface component.

3. The interface component of claim 1 wherein the device client is further configured with:
an event notification service for communications with the one or more application programs and with internal portions of the interface component.

4. The interface component of claim 1 wherein the device client is further configured with an event history service.

5. The interface component of claim 1 wherein:
the device client is further configured with a first client API associated with a first grouping of the device functions;
the DAL is further configured with a first DAL component associated with the first grouping of the device functions; and
the DDM is further configured with a first DDM component associated with the first grouping of the device functions, and
wherein the first client API, the first DAL component, and the first DDM component correspond one to one with each other and allow the one or more applications programs to interact with one or more device functions which are members of the first grouping of the device functions.

6. The interface component of claim 5 wherein the first client API, the first DAL component, and the first DDM component are first plug-in entities that are enabled in the interface component to allow the one or more applications programs to interact with the first grouping of the device functions.

7. The interface component of claim 6 further operable to allow the one or more applications programs to interact with a second grouping of the device functions by enabling, without changing the first client API, the first DAL component, and the first DDM component, a second client API, a second DAL component, and a second DDM component, which are second plug-in entities.

8. The interface component of claim 6 wherein the DAL and the DDM are further configured with a queue that is operable to queue events associated with communications between the device client, the DAL and the DDM.

9. The interface component of claim 1 further configured with a service provider interface to facilitate interactions between legacy applications and the interface component.

10. A telephony interface component operable to allow one or more application programs to interact with phone functions, the telephony interface component stored on computer readable medium and comprising:
a telephony client operable to provide a plurality of interfaces to the one or more application programs;
a phone abstraction layer (PAL) operable to interact with the telephony client and to provide access to phone functions, the phone functions being phone hardware independent; and
a phone driver module (PDM) operable to interact with the phone abstraction layer and with hardware that is device dependent,
wherein at least one of the telephony client, the phone abstraction layer, and the phone driver module further comprises a plurality of components with each such component operable to support a corresponding grouping of the phone functions.

11. The telephony interface component of claim 10 wherein the telephony client is further configured with:
a first Application Programming Interface (API) to facilitate communication with the one or more application programs; and
a second API to facilitate communication with internal portions of the telephony interface component.

12. The telephony interface component of claim 10 wherein the telephony client is further configured with:
an event notification service for communications with the one or more application programs and with internal portions of the telephony interface component.

13. The telephony interface component of claim 10 wherein the telephony client is further configured with an event history service.

14. The telephony interface component of claim 10 wherein:
the telephony client is further configured with a first client API associated with a first grouping of the device functions;
the PAL is further configured with a first PAL component associated with the first grouping of the device functions; and
the PDM is further configured with a first PDM component associated with the first grouping of the device functions, and
wherein the first client API, the first PAL component, and the first PDM component correspond one to one with each other and allow the one or more applications programs to interact with one or more device functions which are members of the first grouping of the device functions.

15. The telephony interface component of claim 14 wherein the first client API, the first PAL component, and the first PDM component are first plug-in entities that are enabled in the telephony interface component to allow the applications programs to interact with the first grouping of the device functions.

16. The telephony interface component of claim 15 further operable to allow the one or more applications programs to interact with a second grouping of the device functions by enabling, without changing the first client API, the first PAL component, and the first PDM component, a second client API, a second PAL component, and a second PDM component, which are second plug-in entities.

17. The telephony interface component of claim 15 wherein the PAL and the PDM are further configured with a queue that is operable to queue events associated with communications between the phone client, the PAL and the PDM.

18. The telephony interface component of claim 10 further configured with a service provider interface to facilitate interactions between legacy applications and the telephony interface component.

19. A telephony interface component operable to allow one or more application programs to interact with phone functions, the telephony interface component stored on computer readable medium and comprising:
a telephony client API operable to provide a plurality of interfaces to allow the one or more application programs to interact with the phone functions;
a phone abstraction layer (PAL) operable to interact with the telephony client and to provide access to phone functions, the phone functions being phone hardware independent; and
a phone driver module (PDM) operable to interact with the phone abstraction layer and with hardware that is device dependent,
wherein the telephony client API, the PAL, and the PDM further comprise a plurality of respective telephony client components, PAL components, and PDM components that are plug-in components organized in a corresponding plurality of one to one relationships to support a corresponding plurality of groupings of the phone functions.

20. The interface component of claim 19 wherein the telephony client API is further operable to handle any timing issues for commands and responses associated with interactions between the one or more application programs and the phone functions.

21. The interface component of claim 19 wherein the telephony client API is further operable to conceal details of communications with the PAL from the one or more application programs.

22. The interface component of claim 19 further comprising an Inter-process Communications (IPC) mechanism configured to support interaction between the telephony client API and the PAL.

23. The interface component of claim 19 further comprising an event notification service to propagate relevant events to the, respective, one or more application programs.

24. The interface component of claim 19 wherein the PAL further comprises a PAL plug-in framework and event service mechanism supporting sufficient plug-in PAL components to provide an implementation of all functionality that will be invoked by the telephony client API.

25. The interface component of claim 19 wherein the PAL further comprises PAL event services configured to queue requests, events and results for interaction between the PAL and the telephony client API.

25. The interface component of claim 19 wherein the PDM is configured to translate commands from the PAL to commands for the hardware that is device dependent and translate responses from the hardware to responses to the PAL.

26. The interface component of claim 19 wherein the PDM further comprises PDM event services configured to queue requests, events, and results for interaction between the PDM and PAL.

27. The interface component of claim 19 wherein the PDM further comprises a PDM plug-in framework and event service mechanism supporting sufficient plug-in PDM components to provide an implementation of all functionality that will be requested by the PAL.

28. The interface component of claim 19 wherein the PDM further comprises a command handler that facilitates interaction between the PDM and the phone functions.

29. The interface component of claim 19 wherein the command handler further comprises one or more queues for queuing commands and results for interaction with the phone functions.

30. The interface component of claim 29 further comprising a multiplexer for interfacing to the command handler and multiplexing commands to and results from the phone functions for the command handler.
